(19) United States
(12) Patent Application Publication
(10) Pub. No.: US 2026/0247308 A1
(43) Pub. Date: Aug. 20, 2026

(54) Access Procedures in Wireless Networks

(71) Applicant: Oswego Technologies LLC, Columbus, NJ (US)

(72) Inventor: Ali Esswie, Calgary (CA)

(21) Appl. No.: 19/418,932

(22) Filed: Dec. 13, 2025

Related U.S. Application Data
(60) Provisional application No. 63/759,388, filed on Feb. 17, 2025.
(60) Provisional application No. 63/776,887, filed on Mar. 24, 2025.
(60) Provisional application No. 63/785,553, filed on Apr. 8, 2025.
(60) Provisional application No. 63/795,594, filed on Apr. 27, 2025.

(51) Int. Cl. H04W 56/00; H04W 76/28

(52) U.S. Cl. CPC H04W 56/00; H04W 76/28

(57) ABSTRACT

A method performed by a user equipment (UE), the method comprising: detecting a first synchronization signal block (SSB); transmitting, based on detecting the SSB, identification information; receiving another SSB, subsequent to transmitting the identification information; receiving a system information block (SIB) subsequent to the another SSB; and decoding the SIB and determining satellite ephemeris information. The UE may be configured to receive the first SSB from a first non-terrestrial network node which has limited traffic. The UE may be configured to receive the first SSB from a second non-terrestrial network node which has more heavy traffic than the first non-terrestrial network node. The transmitted identification information may be transmitted in accordance with a propagation delay.

### CROSS REFERENCE TO RELATED APPLICATIONS

This application claims priority to U.S. Provisional Application No. 63/759,388 filed on Feb. 17, 2025, U.S. Provisional Application No. 63/776,887 filed on Mar. 24, 2025, U.S. Provisional Application No. 63/785,553 filed on Apr. 8, 2025 and U.S. Provisional Application No. 63/795,594 filed on Apr. 27, 2025.

### SUMMARY

A method performed by a user equipment (UE), the method comprising: detecting a first synchronization signal block (SSB); transmitting, based on detecting the SSB, identification information; receiving another SSB, subsequent to transmitting the identification information; receiving a system information block (SIB) subsequent to the another SSB; and decoding the SIB and determining satellite ephemeris information.

The UE may be configured to receive the first SSB from a first non-terrestrial network node which has limited traffic. The UE may be configured to receive the first SSB from a second non-terrestrial network node which has more heavy traffic than the first non-terrestrial network node. The transmitted identification information may be transmitted in accordance with a propagation delay.

### BRIEF DESCRIPTION OF THE DRAWINGS

FIG. 1 illustrates the NTN RAN node downlink signaling of propagation delay system information;

FIG. 2 illustrates an exemplary LEO satellite network with the proposed Propagation delay system information block (P-SIB) signaling;

FIG. 3 illustrates an exemplary GEO-LEO satellite network with time stamps of WTRU device actions;

FIG. 4 illustrates a timeline of the WTRU actions for determining a current NTN RAN node propagation delay;

FIG. 5 illustrates the adaptive selection of an active DRX profile based on determined propagation delay;

FIG. 6 illustrates a timeline of the WTRU actions determining and updating the NTN RAN node propagation delay;

FIG. 7 illustrates the exchange of satellite handover training configurations over ISL links;

FIG. 8 illustrates the procedural steps of device group LEO fast handover;

FIG. 9 illustrates dynamic segmentation and retransmission of active device's context information;

FIG. 10 illustrates the Fast session resumption request;

FIG. 11 illustrates a timeline of the RAN node actions;

FIG. 12 illustrates NTN RAN node negotiation exchange over ISLs for primary node selection;

FIG. 13 illustrates the delivery of common and differential SIB configuration sets;

FIG. 14 illustrates the NTN RAN node specific random-access resource allocation offsetting;

FIG. 15 illustrates an overall timeline of the primary NTN RAN node actions;

FIG. 16 illustrates NTN RAN node broadcasting SIB occasion validity periods and relative error thresholds;

FIG. 17 illustrates the dynamic WTRU behavior in detecting NTN SIBs based on available SIB error information;

FIG. 18 illustrates the overall NTN RAN node action sequence; and

FIG. 19 illustrates the overall WTRU action sequence.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications, and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

The advent of 5G New Radio (NR) technology has revolutionized cellular networks, offering unprecedented data rates, ultra-reliable low-latency communication (URLLC), and massive machine-type communication (mMTC) capabilities. These advancements enable a wide array of applications, including autonomous vehicles, remote surgery, and augmented reality. However, delivering seamless connectivity across diverse scenarios, such as high-speed vehicular environments and densely populated urban areas, remains a critical challenge. One key requirement for maintaining a high-quality user experience is ensuring seamless handovers between cells, which allows devices to transition between radio access network (RAN) nodes without service disruption. The high density of 5G base stations and the dynamic nature of modern networks further complicate this process, making efficient handover management a cornerstone of 5G performance.

Recent advancements in satellite technology and miniaturization have spurred the deployment of heterogeneous constellations, including low Earth orbit (LEO), medium Earth orbit (MEO), and geostationary orbit (GEO) satellites. LEO satellites, operating at altitudes of 500-2,000 km, provide low-latency links but require dense constellations for continuous coverage due to rapid orbital motion. MEO satellites (8,000-20,000 km) balance latency and coverage, while GEO satellites (~35,786 km) deliver persistent regional coverage at the cost of higher latency. Each orbital regime introduces distinct radio propagation challenges, such as dynamic Doppler shifts in LEO, elevated free-space path loss in GEO, and atmospheric attenuation variations across frequency bands (e.g., L-, S-, Ka-, or V-band). These factors complicate signal synchronization, beam management, and handover procedures, necessitating adaptive modulation, advanced beamforming, and latency-tolerant protocols to ensure seamless integration with terrestrial 5G/6G standards.

In one exemplary embodiment, a wireless transmit/receive unit (WTRU) operating in a non-terrestrial network (NTN) receives ephemeris information via broadcast System Information Block 1 (SIB1-NTN) or device-group-common Downlink Control Information (DCI), which includes the satellite's orbit type (LEO, MEO, or GEO), nominal propagation delay values, and unique beam identifiers. For GNSS-enabled WTRUs, e.g., non-reduced capability devices,, the device calculates geometric propagation delay using real-time GNSS-derived coordinates combined with satellite orbital parameters (e.g., semi-major axis, inclination) to dynamically override stored nominal delay values, ensuring precise synchronization. Reduced-capability WTRUs lacking GNSS utilize predefined nominal delays or velocity lookup tables—preconfigured per orbit type and beam identifier—to estimate delay via Doppler shift measurements. The WTRU then selects an optimal discontinuous reception (DRX) profile, adjusting its wake-up period to account for the calculated propagation delay, thereby maintaining alignment with the NTN node's transmission schedule despite latency variations inherent to satellite mobility.

In another exemplary embodiment, to address velocity differences across heterogeneous NTN constellations, the WTRU employs preloaded lookup tables that map beam identifiers and orbit types (LEO/MEO/GEO) to satellite velocity data. When GNSS is unavailable, the WTRU identifies its serving beam's velocity from one or more table(s), calculates propagation delay using Doppler shift measurements (via the formula: coarse propagation delay=(Doppler frequency× speed of light)/(carrier frequency× satellite velocity), and updates synchronization parameters. Continuous Doppler monitoring enables recalibration if deviations exceed predefined thresholds, ensuring accuracy even in dynamic LEO scenarios where rapid orbital motion causes frequent signal variations. This approach eliminates reliance on explicit NTN-provided delay values, enabling autonomous operation in resource-constrained environments.

In another exemplary embodiment, the WTRU dynamically adapts its discontinuous reception (DRX) cycle by selecting a DRX profile, from a predefined DRX profile codebook, whose wake-up period is extended by the calculated NTN propagation delay. For instance, after determining delay via GNSS coordinates or Doppler-based velocity tables, the WTRU evaluates available DRX profiles (each defining wake-up duration, sleep intervals, and cycle periodicity) to identify the profile with a wake-up window that aligns with the adjusted signal arrival time. This ensures the WTRU remains active during downlink transmissions despite latency fluctuations caused by satellite altitude (e.g., GEO's ~500 ms delay vs. LEO's ~5 ms), optimizing power efficiency while maintaining reliable connectivity.

In another exemplary embodiment, an NTN Radio Access Network (RAN) node broadcasts ephemeris data, including orbit type, beam-specific nominal propagation delay (calculated based on orbital altitude, beam footprint size, and worst-case signal path conditions), and velocity lookup tables. The node periodically updates this information to reflect orbital adjustments or beam reconfigurations, enabling WTRUs to synchronize using either real-time GNSS-derived geometric calculations or preconfigured reference data. For example, GEO satellites broadcast high nominal delays (~270 ms) due to fixed altitude, while LEO nodes provide velocity tables to accommodate rapid motion. This ensures WTRUs maintain connectivity across diverse orbital regimes without requiring continuous signaling overhead.

In another exemplary embodiment, in a heterogeneous Non-Terrestrial Network (NTN) comprising multiple satellite vendors, only a designated subset of NTN Radio Access Network (RAN) nodes per vendor broadcasts ephemeris data via SIB1-NTN or group-common DCI signaling. These vendor-specific reference nodes transmit comprehensive orbital parameters (e.g., orbit type, semi-major axis, inclination), beam identifiers, and nominal propagation delays not only for their own operations but also for neighboring NTN RAN nodes within the same vendor's constellation. For instance, a GEO reference node from Vendor A may broadcast ephemeris information for its own beams and those of adjacent Vendor A LEO/MEO satellites, enabling WTRUs to derive propagation delays for all Vendor A nodes—even those not explicitly broadcasting ephemeris—by extrapolating shared orbital characteristics (e.g., altitude ranges, velocity profiles). The WTRU leverages this vendor-specific subset data to calculate delays for non-broadcasting nodes, using preconfigured velocity lookup tables or beam-ID mappings tied to the vendor's operational standards. This selective broadcasting reduces signaling overhead while ensuring interoperability, as WTRUs dynamically apply vendor-specific ephemeris rules to maintain synchronization across hybrid constellations without requiring universal participation from all NTN RAN nodes.

In another exemplary embodiment, the selection of the reference NTN RAN nodes responsible for broadcasting ephemeris data (e.g., orbit type, beam identifiers, nominal propagation delays) is governed by a hybrid approach combining static configuration and dynamic real-time adaptation. Statically, the core network or NTN gateways preconfigure specific satellites or high-altitude platforms (e.g., GEO nodes, vendor-designated anchor LEO/MEO satellites) as permanent reference nodes for their respective vendor constellations. These nodes are tasked with broadcasting vendor-specific ephemeris via SIB1-NTN or group-common DCI signaling, including data not only for their own operations but also for neighboring nodes within the same vendor's constellation. Dynamically, the network enables real-time selection of reference nodes through broadcast indicators, such as an “EphemerisBroadcastAvailable” flag in the downlink master information block (MIB), allowing NTN RAN nodes to signal their ephemeris transmission capability. For instance, during temporary coverage gaps or node failures or reference node excessive energy consumption above a predefined threshold, nearby satellite nodes, upon failure to detect Ephemeris data broadcasts from the reference NTN RAN node over the inter-satellite links, may act a transient reference node, overriding static configurations to ensure continuity.

In another exemplary embodiment, reduced-capability WTRUs prioritize nominal propagation delay values broadcast by the NTN RAN node. If unavailable, the WTRU cross-references its serving beam identifier and orbit type (e.g., LEO with 500 km altitude) within preloaded velocity tables to extract satellite velocity, then calculates propagation delay via Doppler frequency measurements. This method compensates for the lack of GNSS by leveraging NTN-provided ephemeris and beam-specific data, enabling synchronization even in low-complexity devices. The WTRU further refines its delay estimate by periodically sampling Doppler shifts, ensuring adaptability to satellite movement without excessive computational overhead.

In a final exemplary embodiment, the WTRU leverages beam-specific ephemeris parameters, such as beam center coordinates and coverage boundaries, to refine propagation delay calculations. For GEO satellites, high path loss is mitigated using static nominal delays, while LEO/MEO scenarios employ dynamic adjustments via GNSS or Doppler-based velocity tables. DRX profiles are tailored to each orbit's latency profile: GEO uses longer sleep cycles due to predictable delays, whereas LEO requires shorter, adaptive cycles to handle rapid beam handovers. This optimization balances power efficiency with responsiveness, ensuring seamless operation across hybrid NTN architectures combining GEO, MEO, and LEO constellations.

Non-Terrestrial Network (NTN) Radio Access Network (RAN) deployments face significant challenges due to the coexistence of heterogeneous satellite constellations operating across diverse orbital regimes, such as Low Earth Orbit (LEO), Medium Earth Orbit (MEO), and Geostationary Earth Orbit (GEO). Each orbit type introduces distinct radio propagation characteristics, including variations in latency, Doppler shift dynamics, and path loss. For example, LEO satellites, which orbit at altitudes of 500-2,000 km, exhibit rapid motion relative to Earth, causing frequent NTN RAN node handovers and dynamic signal conditions at Wireless Transmit/Receive Units (WTRUs). These frequent switches demand that WTRUs rapidly adapt to abrupt changes in propagation delay, beam coverage, and synchronization parameters. In contrast, GEO satellites, positioned at ~35,786 km, introduce significantly larger static propagation delays (e.g., ~270 ms one-way latency) compared to LEO systems (~5-20 ms), necessitating prolonged wake-up periods for WTRUs to accommodate delayed downlink transmissions. This disparity creates inefficiencies in power management, particularly for WTRUs operating in discontinuous reception (DRX) modes, as devices connected to GEO satellites may remain active for extended durations to compensate for latency, while LEO-connected WTRUs face recurring re-synchronization overhead due to frequent beam transitions.

The coexistence of multi-orbit NTN RAN nodes, i.e., heterogeneous networks, therefore raises synchronization challenges for WTRUs, especially in hybrid deployments where a single WTRU may transition between GEO, MEO, and LEO coverage zones. For instance, a WTRU initially connected to a GEO satellite with a nominal propagation delay of 270 ms may experience a sudden handover to a LEO satellite with a 10 ms delay, requiring immediate recalibration of timing advance and DRX parameters to avoid misalignment with the new NTN RAN node's transmission schedule. Conversely, transitions from LEO to GEO introduce abrupt increases in latency, risking packet loss if the WTRU fails to extend its wake-up window dynamically.

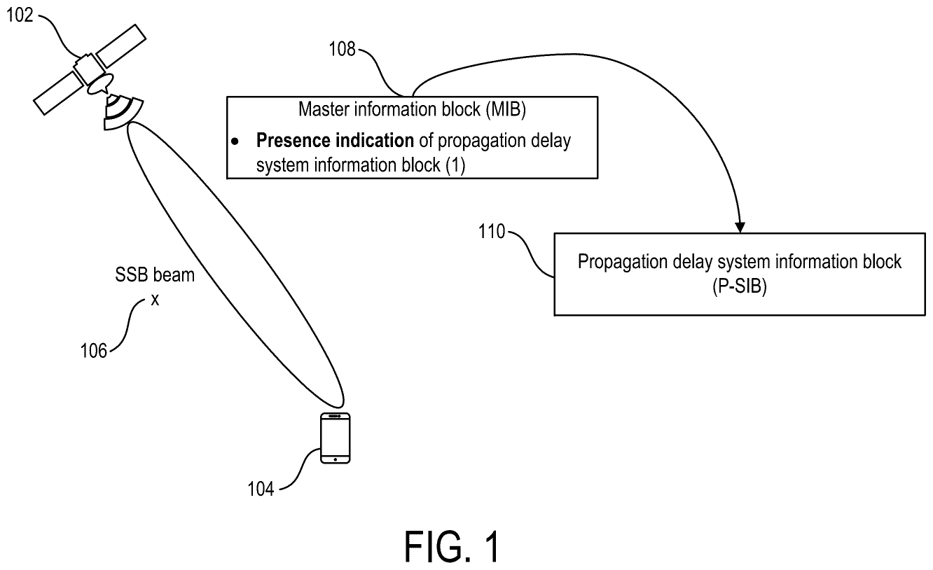

FIG. 1 shows an NTN-capable WTRU 104 receiving ephemeris information through a hierarchical broadcast signaling framework initiated by an NTN Radio Access Network (RAN) node 102 or a designated reference NTN RAN node. The process begins with the WTRU detecting an “EphemerisInformationAvailable” flag embedded within a Master Information Block (MIB) 108 transmitted by the NTN RAN node 102. When this flag is set to TRUE, the WTRU autonomously searches for and decodes a dedicated System Information Block (SIB) 110, termed for example “SIB-PropagationDelay-NTN,” which carries the propagation-specific ephemeris data for the current serving NTN RAN node and/or neighboring satellite nodes within the same orbital constellation. The RAN node 102 transmits SSBs on various beams, here the UE 104 receives SSB on beam x 106.

The SIB includes parameters such as the NTN RAN orbit type (LEO/MEO/GEO), beam identifier (BeamID), nominal propagation delay values, and optional velocity lookup tables mapped to beam identifiers. For instance, a GEO node's SIB may broadcast a nominal delay of 270 ms, while a LEO node's SIB provides velocity tables to account for rapid orbital motion. Reduced-capability WTRUs without GNSS leverage the nominal delay as a static reference, while other WTRUs with other capabilities may use GNSS coordinates and/or Doppler shift measurements to dynamically override nominal values. This hierarchical signaling mechanism reduces overhead by limiting ephemeris broadcasts to flagged SIBs, ensuring efficient adaptation to heterogeneous NTN deployments where satellites exhibit vastly different latency profiles (e.g., GEO vs. LEO) and dynamic beam-switching scenarios.

TABLE 1
Propagation Delay System Information Block (SIB)
Propagation delay system information block (P-SIB)

Satellite Orbit Type information (‘SatelliteOrbitType’)
Nominal Propagation Delay information (‘NominalPropagationDelay’)
Beam ID information (‘BeamID’)
DRX Profile Config information (‘DRXProfileConfig’)
Velocity preloaded lookup tables

Table 1 illustrates the hierarchical message content of a Propagation Delay System Information Block (SIB) transmitted by a Non-Terrestrial Network (NTN) Radio Access Network (RAN) node or reference node via broadcast signaling (e.g., SIB1-NTN or device-group-common DCI). The SIB is structured as a predefined data object containing multiple nested information elements and objects tailored to enable WTRU synchronization across heterogeneous NTN deployments. At the highest level, the SIB includes a SatelliteOrbitType information element specifying the orbital regime (e.g., LEO, MEO, GEO) of the serving NTN RAN node, which informs the WTRU of inherent latency and Doppler characteristics. A NominalPropagationDelay element provides a baseline one-way delay value (e.g., 270 ms for GEO, 10 ms for LEO), precomputed by the NTN RAN node based on worst-case orbital latency and beam footprint conditions. The BeamID element uniquely identifies the active beam covering the WTRU's geographic area, enabling cross-referencing with preconfigured beam-specific parameters such as coverage boundaries or velocity profiles.

Furthermore, embedded within the SIB is a DRXProfileConfig information object, which defines multiple discontinuous reception (DRX) profiles, each comprising configurable parameters such as wake-up duration, sleep period, and cycle periodicity. These profiles allow the WTRU to dynamically select a DRX configuration that aligns with the real-time propagation delay—for instance, extending wake-up periods for GEO-connected operation or shortening cycles for LEO handovers. Additionally, the SIB incorporates VelocityPreloadedLookup Tables as nested information objects, each mapped to a specific SatelliteOrbitType and BeamID. These tables contain preconfigured velocity data (e.g., orbital speed for LEO satellites at 500 km altitude) that the WTRU uses to calculate propagation delays via Doppler shift measurements when GNSS or nominal delay values are unavailable. The figure further depicts how the SIB's structured format reduces signaling overhead by consolidating critical synchronization parameters into a single broadcast message, ensuring efficient adaptation to multi-orbit NTN environments where latency, beam coverage, and node velocity vary significantly. This architecture enables WTRUs to maintain seamless connectivity despite frequent satellite handovers or transitions between orbital regimes with divergent radio characteristics.

Table 2 illustrates the classification of Non-Terrestrial Network (NTN) Radio Access Network (RAN) nodes based on their orbital characteristics, enabling a Wireless Transmit/Receive Unit (WTRU) to identify the exact orbit type and associated parameters for synchronization and propagation delay compensation. Each row corresponds to a distinct orbit type—Low Earth Orbit (LEO), Medium Earth Orbit (MEO), or Geostationary Earth Orbit (GEO)—and specifies respective altitude ranges. For example, LEO satellites are categorized with altitudes between 500-2,000 km, while GEO satellites are defined by a fixed altitude of 35,786 km. The table further may include MEO entries with intermediate altitudes (8,000-20,000 km), that are designated to offer cellular connectivity.

Thus, the WTRU cross-references the received SatelliteOrbitType information element (e.g., “LEO” or “GEO”) against this table to derive critical parameters for synchronization. For instance, upon receiving a LEO orbit type indication, the WTRU retrieves the corresponding altitude range and velocity to calculate dynamic propagation delays using GNSS coordinates or Doppler shift measurements. Similarly, a GEO indication triggers the use of static nominal delays and extended DRX wake-up periods. The table is either preconfigured in the WTRU's memory or dynamically updated via NTN broadcast signaling, ensuring adaptability to vendor-specific orbital deployments. This structured classification enables the WTRU to autonomously align its operations with the serving NTN RAN node's radio characteristics, mitigating latency mismatches and optimizing power efficiency in heterogeneous networks where satellites exhibit divergent orbital behaviors.

TABLE 2
Satellite Orbit Type information
Satellite Orbit Type information

| | |
|---|---|
| LEO_1000 KM | SatelliteOrbitType 1 |
| . | . |
| . | . |
| . | . |
| LEO_3500 KM | SatelliteOrbitType 3 |
| . | . |
| . | . |
| . | . |
| GEO_35000 KM | SatelliteOrbitType 5 |

Table 3 demonstrates a Beam ID information element, as part of the NTN RAN ephemeris data, which serves as a unique identifier for each NTN RAN node covering the same geographic area. This Beam ID allows a wireless transmit/receive unit (WTRU) to distinguish between beams transmitted by different non-terrestrial network (NTN) nodes, particularly in hybrid satellite deployments where multiple orbital layers coexist. For instance, in a hybrid Low Earth Orbit (LEO) and Geostationary Earth Orbit (GEO) network, a GEO satellite is assigned a distinct Beam ID that differs from the Beam IDs of overlapping LEO RAN nodes, ensuring unambiguous identification of the serving NTN node. Upon receiving the ephemeris data, the WTRU extracts the Beam ID and cross-references it with the velocity lookup table corresponding to the determined SatelliteOrbitType. This association enables the WTRU to retrieve accurate velocity information specific to the serving NTN RAN node and use it to calculate a precise propagation delay. By leveraging the unique Beam ID structure, the WTRU ensures accurate synchronization and timing compensation despite the differing motion dynamics of LEO and GEO satellites.

An NTN RAN reference node is configured to transmit and broadcast velocity lookup tables that include predefined velocity parameters corresponding to various beam ID configurations and satellite orbit types. These lookup tables are not only used by devices connected to the reference node but are also made available to devices served by other satellite nodes within the network, ensuring a consistent and standardized approach for calculating propagation delays and synchronizing communications.

In contrast, non-reference satellite nodes broadcast only essential information such as their specific beam identifiers and satellite type data. This streamlined broadcast approach minimizes signaling overhead for non-reference nodes while ensuring that all devices in the network have access to the detailed velocity information provided by the reference node. Consequently, wireless transmit/receive units (WTRUs) and other network devices can accurately determine the velocity of the serving NTN RAN node by cross-referencing the received beam and satellite type information with the comprehensive velocity lookup tables broadcast by the reference node, thereby enhancing overall network synchronization and performance.

TABLE 3
Beam ID information
Beam ID information

Propagation delay Beam ID {b}

Table 4 illustrates the Nominal Propagation Delay information, wherein the NTN RAN node broadcasts its corresponding worst-case, e.g., largest, calculated propagation delay value. The NTN RAN node computes these delay values based on its orbital configuration, beam footprint, and expected signal conditions, and subsequently broadcasts the calculated values as part of its system information. This table is transmitted to potential wireless transmit/receive units (WTRUs) operating within the coverage of the NTN RAN node, thereby enabling devices to reference predetermined delay metrics for synchronization purposes.

A WTRU processes the received Nominal Propagation Delay information selectively. The device considers this information only on condition of the indicated satellite orbit type, as indicated in the broadcast, corresponds to a geostationary (GEO) satellite-characterized by a reasonably static propagation delay- and if the device is of a reduced capability class. Under these conditions, the WTRU overrides its current propagation delay value with the nominal delay specified in the table and updates its discontinuous reception (DRX) cycle accordingly to ensure proper alignment with the downlink transmissions. If the broadcasted satellite orbit type does not indicate a GEO satellite, or if the device belongs to a non-reduced capability class, the WTRU disregards the nominal propagation delay information, relying instead on the on-device delay estimation methods to maintain synchronization accuracy.

TABLE 4
Nominal Propagation Delay information
Nominal Propagation Delay information

| | |
|---|---|
| Propagation delay Beam ID {b} | y ms and/or delay level y′ |

Table 5 shows a DRX Profile Configuration table that may be broadcast by the NTN RAN node to all wireless transmit/receive units (WTRUs). This table comprises one or more DRX profile identifiers, with each identifier corresponding to predefined parameters such as a wake-up period, a sleep-off period, and a DRX cycle periodicity. The table is structured to ensure that each DRX profile meets specific propagation delay restrictions expected by the NTN network, e.g., by performing geography surveying, thereby enabling the WTRU to select a DRX configuration that aligns with its measured propagation delay. By requiring the use of one of these standardized profiles, the system ensures uniformity and consistency across all devices operating within the NTN environment. After determining its current propagation delay, the WTRU searches the DRX Profile Configuration table to select an appropriate DRX profile. The selection is based on the requirement that the chosen profile's wake-up period is sufficiently extended beyond the addition of the current wake up period and the propagation delay calculated or determined by the WTRU.

TABLE 5
DRX Profile Config information
DRX Profile Config information

| | |
|---|---|
| DRX profile 1 | Wake up period 1, sleep period 1, periodicity 1 |
| DRX profile 2 | Wake up period 2, sleep period 2, periodicity 2 |
| . | . |
| . | . |
| . | . |

Table 6 shows that a WTRU receives and stores one or more NTN RAN velocity preloaded lookup tables. Each table is associated with an NTN RAN orbit type identifier and maps unique NTN RAN beam identifiers to corresponding node velocity information. Since the Beam ID information is globally unique across all satellites-whether in GEO or LEO-operating within the same geographic area, the WTRU can accurately correlate the specific velocity data to the satellite it is currently connected to.

When the WTRU establishes a connection with a new satellite, it dynamically references the stored lookup table corresponding to the satellite's orbit type. This enables the device to retrieve the associated velocity information using the unique Beam ID without the need to re-receive additional ephemeris data. Utilizing this velocity information, the WTRU promptly determines and updates the propagation delay for the current satellite, ensuring precise synchronization and reliable communication performance in a heterogeneous non-terrestrial network environment.

TABLE 6
Velocity preloaded lookup table
Velocity preloaded lookup table

| | |
|---|---|
| Beam ID b₁ | Satellite velocity v_{b}_{₁} |
| Beam ID b₂ | Satellite velocity v_{b}_{₂} |
| . | . |
| . | . |
| . | . |

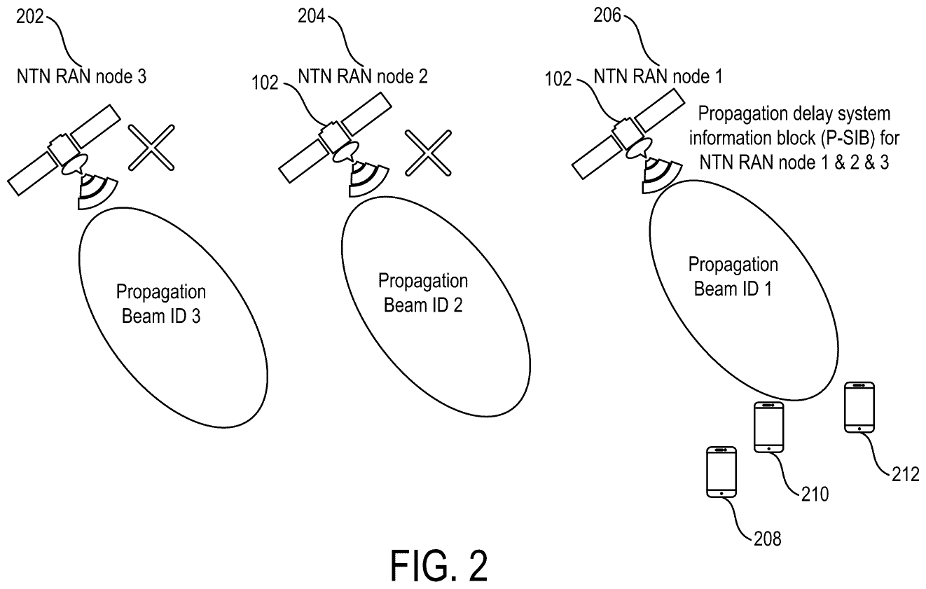

FIG. 2 illustrates an NTN network comprised of RAN nodes 202-206 in which a designated reference NTN RAN node 206 broadcasts ephemeris information that includes both the propagation delay and detailed NTN RAN node information for itself and for other non-reference satellites. This centralized broadcast mechanism is designed to reduce signaling overhead by consolidating multi-node ephemeris data into a single transmission stream, thereby simplifying the information dissemination process to the connected wireless transmit/receive units (WTRUs) 208-212 and other network elements.

The selection of the reference node can be determined either statically by the core network or an NTN gateway, or dynamically through an initial reference node selection process managed by the core network and consequently adapting its state to real time conditions. In a static configuration, the core network assigns a reference node based on predetermined criteria such as geographic location or satellite capability, while a dynamic selection process allows for the initial reference node to be chosen and changed according to real-time network conditions. Once selected, the reference node continuously transmits the aggregated ephemeris information over inter-satellite links, ensuring that all devices within the network have access to accurate propagation delay and node data.

In the event that the reference node experiences a radio failure or its energy consumption exceeds a predetermined threshold, the node may cease broadcasting the multi-node ephemeris information. When nearby satellites detect the absence of the reference node's broadcast through inter-satellite links, they autonomously assume the role of the reference node. These satellites then initiate the broadcasting of the required ephemeris information, thereby ensuring uninterrupted network operation and continuous synchronization across the NTN environment.

The WTRU determines the appropriate NTN Radio Access Network (RAN) velocity preloaded lookup table by cross-referencing the received ‘SatelliteOrbitType’ indication (e.g., LEO, MEO, GEO) with the currently serving ‘BeamID’ broadcast by the NTN RAN node. Reference NTN RAN nodes, designated as primary ephemeris sources, transmit full velocity lookup tables containing orbital velocity data mapped to specific beam identifiers (BeamIDs) and orbit types. These tables enable the WTRU to correlate beam-specific velocity parameters (e.g., 7.8 km/s for LEO, 3.07 km/s for GEO) with the serving satellite's BeamID. Non-reference NTN RAN nodes, however, transmit only their BeamID and orbit type, omitting velocity data to reduce signaling overhead. Upon receiving a BeamID from a non-reference node, the WTRU retrieves the pre-stored velocity lookup table corresponding to the indicated ‘SatelliteOrbitType’ (e.g., LEO) and extracts the velocity value associated with the received BeamID. For example, if a WTRU detects a BeamID of “LEO-Beam-123” under a LEO orbit type, it accesses the LEO-specific velocity table to identify the precise orbital speed linked to that beam. This method ensures accurate velocity selection even when the serving NTN RAN node does not explicitly transmit velocity data, leveraging preconfigured vendor-specific tables to maintain synchronization.

By relying on reference nodes to broadcast comprehensive velocity tables and non-reference nodes to transmit minimal BeamID data, the system optimizes resource utilization. The WTRU dynamically adapts to heterogeneous constellations, such as frequently transitioning from a reference GEO node (providing full velocity tables) to a non-reference LEO node (transmitting only BeamID and orbit type). In the latter case, the WTRU cross-references the LEO BeamID within its stored LEO velocity table to derive the node's velocity, enabling precise Doppler-based propagation delay calculations. This approach minimizes redundant signaling while ensuring continuity in delay estimation, critical for maintaining alignment with rapidly moving LEO satellites or static GEO nodes.

A WTRU of a non-reduced capability device class equipped with Global Navigation Satellite System (GNSS) detection capability determines its current geographic coordinates using the onboard GNSS receiver. The device then obtains the serving NTN RAN node's ephemeris data, which includes critical orbital parameters such as the semi-major axis and inclination. By combining the precise GNSS-derived coordinates with this ephemeris data, the WTRU calculates a geometric propagation delay as per the following formula, that accurately represents the signal travel time between the satellite and the device.

$$τ = \frac{\sqrt{{( {x}_{sat} - {x}_{UE} )}^{2} + {( {y}_{sat} - {y}_{UE} )}^{2} + {( {z}_{sat} - {z}_{UE} )}^{2}}}{C}$$

$${x}_{sat} , {y}_{sat} , {z}_{sat} : Satellite coordinates from ephemeris data .$$

$${x}_{UE} , {y}_{UE} , {z}_{UE} : UE coordinates from GNSS .$$

$$C : speed of light$$

Subsequently, the WTRU overrides its previously stored propagation delay value with the calculated geometric propagation delay. This updated delay measurement, derived from the exact relative position of the device with respect to the satellite, ensures highly accurate synchronization with the serving NTN RAN node. The accuracy of this approach is attributed to the elimination of uncertainties that typically arise when relying on nominal or approximated delay estimations, thereby significantly enhancing the reliability of timing and synchronization in the network.

Furthermore, the geometric propagation delay is computed by determining the precise distance between the WTRU and the NTN RAN node and then dividing this distance by the speed of light. This method provides a real-time estimation of the propagation delay that adapts to the dynamic conditions of non-terrestrial network operations, ensuring that the communication link remains optimally synchronized even as the relative positions of the satellite and the device change.

By leveraging the exact location information from GNSS and the detailed orbital parameters provided in the ephemeris data, this method represents a robust solution for improving synchronization accuracy in non-terrestrial networks. The ability to dynamically update the propagation delay based on real-time geometric calculations not only optimizes the performance of the WTRU but also contributes to a more resilient and efficient network architecture capable of handling the inherent variability of satellite-based communication systems.

When a WTRU operates as a reduced capability device without GNSS detection capability, and nominal propagation delay information is not present, the WTRU determines the appropriate NTN RAN velocity preloaded lookup table based on the received NTN RAN orbit type indication. The device accesses the lookup table corresponding to the specific orbit type of the serving NTN RAN node, thereby obtaining the necessary velocity parameters that are mapped to the unique beam identifiers.

Following this selection, the WTRU extracts the NTN RAN node velocity information that corresponds to the serving NTN RAN beam identifier from the determined lookup table. This extraction process refines the velocity estimation by ensuring that the velocity information is specific to the active beam covering the WTRU's geographic location, which is essential for accurately calculating the propagation delay.

Subsequently, the WTRU calculates a one-way NTN RAN propagation delay by combining the extracted velocity information with real-time Doppler shift measurements. In one implementation, the device multiplies the determined Doppler frequency shift by the speed of light and divides the resulting product by the product of the carrier frequency and the determined NTN RAN node velocity. This computation enables the WTRU to accurately estimate the signal propagation time even in the absence of explicitly provided nominal propagation delay information.

$$τ = \frac{{f}_{Doppler} \cdot C}{{f}_{Carrier} \cdot {V}_{satellite}}$$

$${f}_{Doppler} : Satellite coordinates from ephemeris data .$$

$$C : speed of light$$

$${f}_{Carrier} : Downlink carrier frequency$$

$${V}_{satellite} : Satellite velodity retrieved from the preloaded lookup table$$

Finally, the WTRU overrides and updates its current NTN propagation delay value with the newly calculated propagation delay. This update ensures synchronization accuracy with the serving NTN RAN node, allowing the device to maintain reliable and efficient communication despite the lack of directly provided nominal delay values.

The WTRU continuously monitors Doppler shift variations in the received signal to ensure that its propagation delay estimations remain accurate over time. As Doppler shift is inherently a time-variant measurement influenced by factors such as satellite motion, atmospheric conditions, and relative velocity changes, the WTRU compares the real-time Doppler measurements to the expected values derived from its initial velocity-based delay estimation. When a significant deviation, that fulfils a maximum standard deviation threshold, from the expected value is detected, the device triggers a dynamic recalculation of the propagation delay using updated velocity information obtained from the preloaded lookup tables.

This dynamic recalibration process involves retrieving the most recent velocity parameters corresponding to the serving NTN RAN node's beam identifier and orbit type from the lookup tables, which may have been updated based on new network information. By recalculating the propagation delay with the updated velocity data and incorporating the current Doppler shift measurements, the WTRU ensures that any discrepancies due to time-varying conditions are minimized.

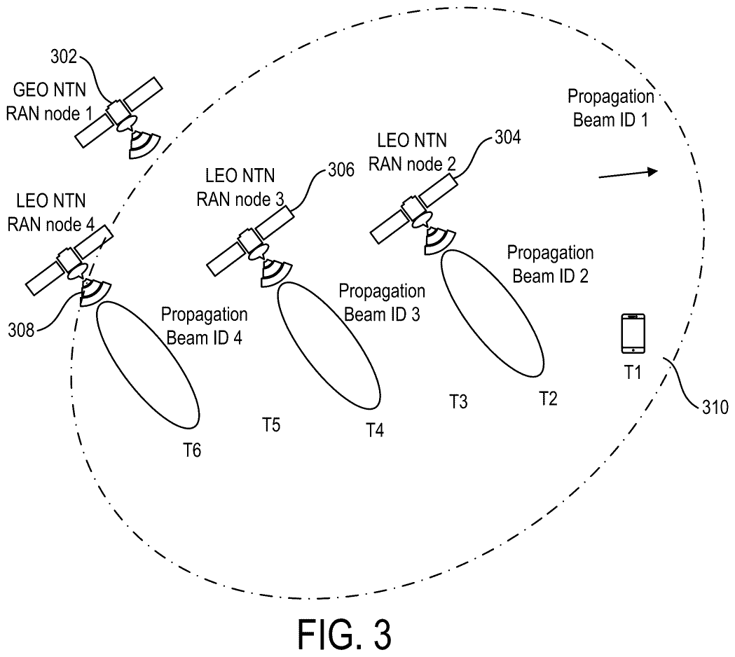

FIG. 3 illustrates a hybrid non-terrestrial network radio access network (NTN RAN) deployment where four satellite nodes 302-308 provide coverage over a given geographical area. In this embodiment, the figure depicts one geostationary (GEO) NTN RAN node, labeled as Node 1 302, and three low Earth orbit (LEO) NTN RAN nodes, labeled as Nodes 2 304, 3 306, and 4 308. The illustration highlights the dynamic operation of a wireless transmit/receive unit (WTRU) that performs propagation delay calibrations while undergoing multiple satellite switch events, with precise timestamps indicating when these events occur. The GEO node 302 may be stationary, while LEO NTN RAN nodes 204-306 move in the direction towards UE 310.

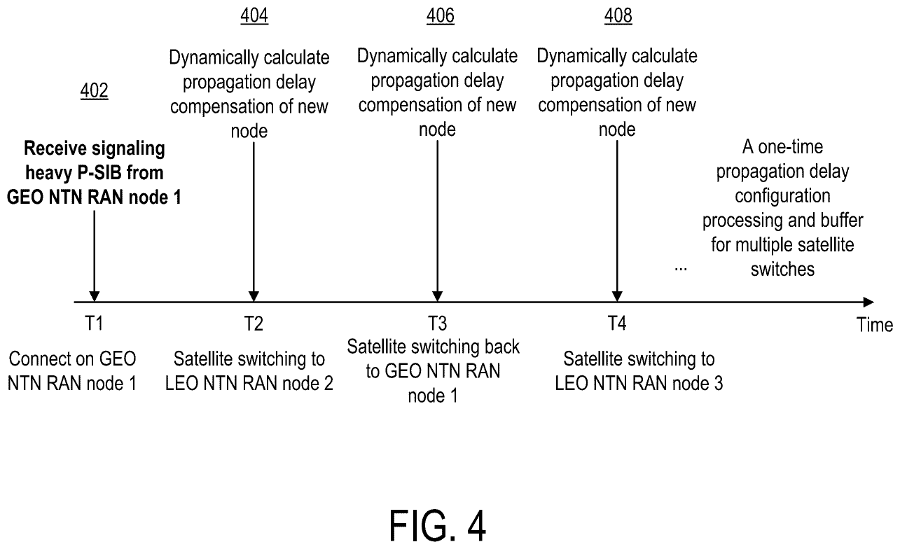

Initially, as depicted by FIG. 4, the WTRU establishes a connection 402 with the GEO node, receiving its broadcast ephemeris information, which includes nominal propagation delay values, beam identifiers, and associated orbital parameters. The device uses this information to calibrate its propagation delay and synchronize its communication timing accurately. As time progresses, the WTRU initiates a satellite switch from the GEO node to one of the LEO nodes. At the moment of transition, a timestamp is logged as T2, and the WTRU accesses 404 the relevant preloaded velocity lookup table corresponding to the new satellite's orbit type, along with real-time Doppler shift measurements, to recalculate the propagation delay. This recalibration ensures that the WTRU adapts to the differing propagation characteristics inherent in LEO communications.

Subsequently, the figure further illustrates additional satellite switch events, each marked with distinct timestamps. During each event, the WTRU dynamically determines the appropriate propagation delay by either extracting updated velocity information specific to the active beam or applying other delay estimation methods as required by the current satellite's orbital dynamics. This continuous monitoring and recalibration process guarantees that the WTRU maintains optimal synchronization with the serving NTN RAN node, effectively accommodating the variances in propagation delays between the GEO and LEO systems without actually the need to re-receive the NTN ephemeris data frequently. The figure underscores the critical role of dynamic calibration in hybrid NTN deployments, where rapid satellite switching necessitates agile and precise adjustments to maintain robust network performance.

At T3 the WTRU may switch back 406 to GEO NTN RAN node 1. At T4, the WTRU may calculate a propagation delay compensation 408 of a new node, e.g. RAN node 3.

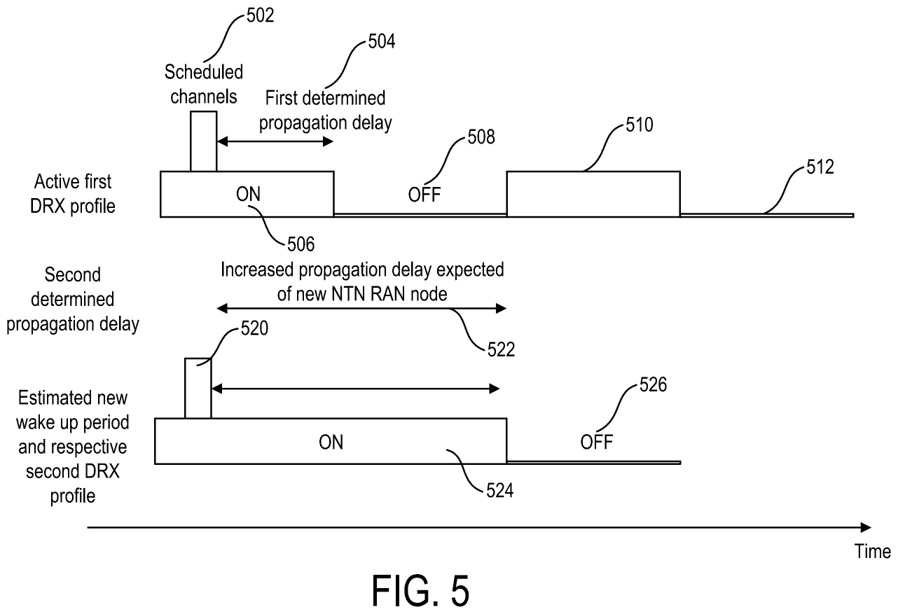

FIG. 5 illustrates an exemplary scenario in which a WTRU dynamically adjusts its discontinuous reception (DRX) profile in response to the calculated NTN RAN propagation delay. In the figure, the WTRU initially receives the necessary system information and computes the propagation delay associated with the serving NTN RAN node. This delay is depicted on a timeline, and the WTRU is shown as actively searching through a set of available DRX profiles. Each profile in the accompanying DRX configuration table specifies a wake-up period, sleep period, and periodicity. The figure highlights the selection process whereby the WTRU identifies a profile that provides a wake-up period sufficiently extended to account for the determined propagation delay, thereby ensuring that the device remains awake and ready to receive downlink transmissions at the correct moment.

For example, the WTRU may receive/transmit using scheduled channels 502 that are scheduled according to a first propagation delay corresponding to a first wake up period 506. The WTRU may have no scheduled channels during sleep period 508, may then wake up for period 510 and may then sleep during period 512.

Further, the figure details the dynamic nature of the DRX profile adjustment process. Upon calculating the propagation delay, the WTRU is depicted as selecting and activating a second DRX profile from the available set. This second profile is chosen such that its wake-up period most closely aligns with, or minimizes the time difference relative to, the sum of the current first wake-up period and the determined NTN RAN propagation delay. By adjusting its DRX cycle in this manner, the WTRU compensates for the delayed signal receptions introduced by the propagation delay, thus maintaining optimal synchronization with the NTN RAN node. The diagram effectively demonstrates how the integration of real-time propagation delay measurements with adaptive DRX profile selection enables robust and reliable communication within the network. Scheduled channels 520 may occur during a wake up period 524 which coincides with an increased propagation delay 522 of a new NTN RAN node. The WTRU may sleep during period 526.

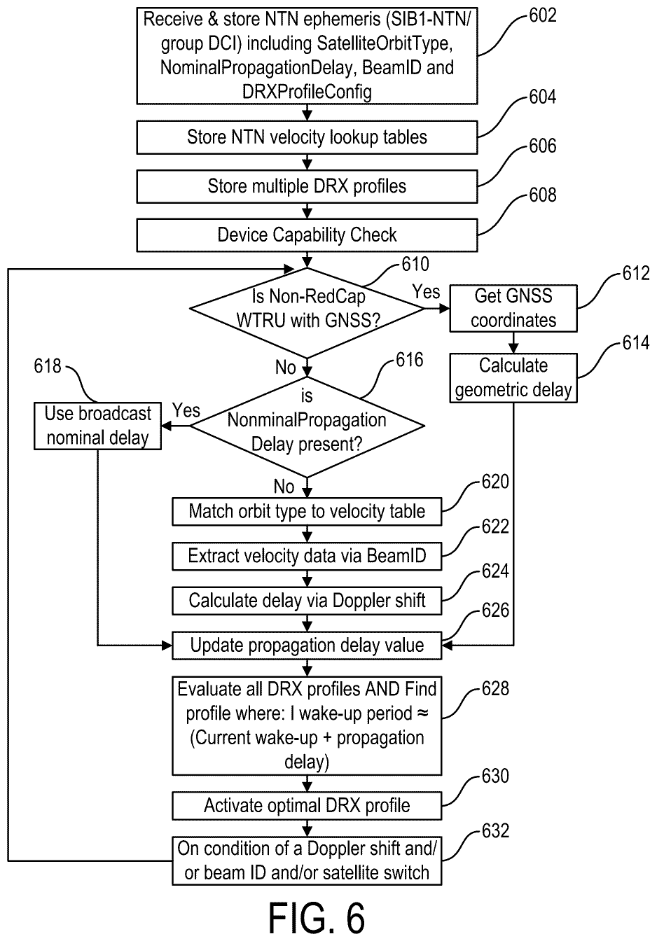

FIG. 6 presents an overall timeline depicting the sequential operations executed by a wireless transmit/receive unit (WTRU). At the start of the timeline, the WTRU receives broadcast ephemeris information 602 from the serving NTN RAN node. This information includes potentially essential parameters such as nominal propagation delay values, beam identifiers, and velocity lookup tables corresponding to various orbit types. NTN velocity tables 604 and DRX profiles 606 may be stored.

A capability check may be performed 608. For devices of non-reduced capability equipped 610 with GNSS, the timeline shows that the WTRU first determines its current geographic coordinates 612 using its GNSS receiver. It then calculates a geometric propagation delay 614 by integrating the GNSS-derived position with the ephemeris data-specifically, the semi-major axis and inclination parameters-thus obtaining an accurate one-way delay measurement.

Following initial calibration, the timeline illustrates an alternative branch for reduced capability devices without GNSS detection. The WTRU determines if NominalPropagationDelay is present 616. If it is, the WTRU uses a broadcast nominal delay 618. if NominalPropagationDelay is not present, the WTRU identifies 618 the appropriate velocity lookup table based on the received NTN RAN orbit type indication. It then extracts 620 the relevant velocity information using the unique beam identifier of the serving NTN RAN node and calculates 622 the propagation delay through real-time Doppler shift measurements. The figure emphasizes that the WTRU continuously monitors Doppler shift variations, dynamically recalculating and updating the propagation delay when significant deviations are detected, ensuring that any temporal variations are promptly compensated.

Subsequently, the timeline transitions to the DRX profile selection process. Once the accurate propagation delay has been established 624, the WTRU searches 626 the available DRX profile configuration table to identify a profile that extends the current wake-up period sufficiently to accommodate the measured delay. The timeline further details that upon calculating the dynamic propagation delay, the WTRU selects and activates 628 a second DRX profile whose wake-up period minimizes the timing difference between the expected and actual delay, thereby ensuring that the device remains awake during downlink transmissions. Additional markers on the timeline denote events such as satellite handovers, where the WTRU repeats 630 the propagation delay calibration process and DRX profile adjustments to adapt to the new satellite's characteristics.

A WTRU operating in a Non-Terrestrial Network (NTN) may also be configured to receive NTN ephemeris information, including orbit type, nominal propagation delay, beam identifiers, and velocity lookup tables, from a Terrestrial Network (TN) base station instead of an NTN Radio Access Network (RAN) node. This hybrid approach leverages the WTRU's dual connectivity capability, wherein the WTRU establishes a TN link (e.g., 5G/6G cellular) alongside its NTN connection. The TN base station acts as a relay, broadcasting NTN-specific ephemeris data to the WTRU via terrestrial signaling (e.g., System Information Blocks or dedicated RRC signaling), thereby offloading resource-intensive NTN broadcast overhead to the TN interface. For instance, when the WTRU is within TN coverage, it retrieves NTN ephemeris for its serving or neighboring satellites-such as LEO velocity tables or GEO nominal delays-directly from the TN base station, which aggregates this data from core network servers or NTN gateways.

Upon receiving the NTN ephemeris via the TN interface, the WTRU stores and processes the data identically to NTN-originated ephemeris, enabling seamless synchronization with NTN RAN nodes. This method is particularly advantageous for large payloads, such as large velocity lookup tables or beam-specific DRX profiles, which incur significant signaling overhead over satellite links. By utilizing the TN's higher bandwidth and lower latency, the WTRU efficiently preloads critical NTN parameters (e.g., beam-specific propagation delays) without congesting the NTN air interface. For example, a WTRU transitioning from TN to NTN coverage uses pre-received GEO nominal delays to immediately configure extended DRX wake-up periods, avoiding latency-induced misalignment. Conversely, in remote areas with intermittent TN connectivity, the WTRU reverts to NTN-originated ephemeris while retaining TN-delivered data as a fallback.

A wireless transmit/receive unit (WTRU) that operates in a non-terrestrial network (NTN), may comprise a transceiver, processor and memory that performs receiving and storing NTN ephemeris information via broadcast System Information Block 1 (SIB1-NTN) and/or device-group-common Downlink Control Information (DCI) signaling, including NTN RAN orbit type indication, NTN RAN nominal propagation delay information, and NTN RAN unique beam identifier; receiving and storing one or more NTN RAN velocity preloaded lookup tables, each table associated with an NTN ran orbit type identifier and mapping NTN RAN beams to NTN RAN node velocity information; receiving and storing one or more NTN RAN discontinuous reception (DRX) profiles or profile indications, each associated with a DRX wake up period, sleep period, and periodicity information; on condition of a WTRU of non-reduced capability device class with Global Navigation Satellite System (GNSS) detection capability: Determining GNSS-derived WTRU coordinates; calculating a geometric NTN RAN propagation delay based on the GNSS-derived WTRU coordinates and determined ephemeris data of the NTN RAN node, including the semi-major axis and inclination parameters of the serving NTN RAN node, overriding and updating the current NTN propagation delay value with the determined NTN RAN propagation delay information; on condition of a WTRU of a reduced capability device without GNSS detection capability: on condition of a detected present Nominal Propagation Delay information as part of the received NTN ephemeris information, overriding and updating the current NTN propagation delay value with the Nominal Propagation Delay; on condition of non-present Nominal Propagation Delay information, and available one or more NTN RAN velocity preloaded lookup tables: determining the NTN RAN velocity preloaded lookup table that is associated with the determined NTN RAN orbit type indication; extracting the NTN RAN node velocity information from the determined NTN RAN velocity preloaded lookup table that is associated with the serving NTN RAN beam identifier; calculating the one-way NTN RAN propagation delay via Doppler shift measurements, overriding and updating the current NTN propagation delay value with the determined NTN RAN propagation delay information; selecting and activating a second DRX profile, from the received one or more DRX profiles, that is associated with a second wake-up period closest possible to, or minimizes a time difference between, the addition of the current first wake up period and calculated NTN propagation delay value.

The NTN ephemeris information includes a ‘SatelliteOrbitType’ indication specifying whether the serving NTN RAN node operates in a Low Earth Orbit (LEO), Medium Earth Orbit (MEO), or Geostationary Earth Orbit (GEO), and wherein each orbit type is further categorized based on an orbit indication parameter that defines specific altitude ranges.

The NTN ephemeris information includes ‘NominalPropagationDelay’ information indicating a maximum one-way propagation delay in milliseconds (ms) associated with the NTN RAN node for each of its active downlink beams, wherein the NTN RAN node determines the maximum one-way delay for each beam based on its orbital parameters, beam footprint, and expected worst-case propagation conditions, and transmits this information as Nominal Propagation Delay information elements to the WTRUs via broadcast system signaling.

The NTN ephemeris information includes a ‘BeamID’ identifying a unique beam identifier of the NTN RAN node covering a geographic area, wherein each ‘BeamID’ is associated with specific beam footprint parameters, including coverage area, beam center coordinates, and beam edge boundaries.

The NTN ephemeris information includes ‘DRXProfileConfig’ information defining one or more discontinuous reception (DRX) profiles, each profile comprising a wake-up period, a sleep period, and a DRX cycle periodicity, wherein the WTRU selects and applies a DRX profile based on the real-time determined NTN propagation delay information.

The NTN ephemeris information includes receiving and storing one or more NTN RAN velocity preloaded lookup tables, each table associated with an NTN RAN orbit type identifier and mapping the one or more active NTN RAN beams to NTN RAN node velocity information, wherein the lookup tables enable the WTRU to distinguish between the velocity characteristics of multiple NTN RAN nodes operating in different orbits while covering the same geographic area.

The WTRU determines the appropriate NTN RAN velocity preloaded lookup table to use based on the determined ‘SatelliteOrbitType’ indication and the currently serving ‘BeamID’, ensuring accurate selection of velocity data corresponding to the serving NTN RAN node's orbital configuration.

The WTRU cross-references the received ‘BeamID’ with the determined applicable NTN RAN velocity preloaded lookup table to extract the specific velocity information of the serving NTN RAN node.

On condition of a WTRU of a non-reduced capability device class with Global Navigation Satellite System (GNSS) detection capability, the WTRU determines its GNSS coordinates and calculates a geometric NTN RAN propagation delay based on the GNSS-derived WTRU coordinates and the determined ephemeris data of the serving NTN RAN node, including the semi-major axis and inclination parameters, wherein the WTRU overrides and updates the current NTN propagation delay value with the calculated geometric propagation delay to ensure highly accurate synchronization with the NTN RAN node.

On condition of a WTRU of a reduced capability device class without GNSS detection capability, and on condition of a detected present Nominal Propagation Delay information as part of the received NTN ephemeris information, the WTRU overrides and updates the current NTN propagation delay value with the received Nominal Propagation Delay, prioritizing this information as the primary propagation delay reference due to its availability and accuracy from the NTN RAN node.

On condition of a WTRU of a reduced capability device class without GNSS detection capability, and on condition of non-present Nominal Propagation Delay information and availability of one or more NTN RAN velocity preloaded lookup tables, the WTRU determines the appropriate NTN RAN velocity preloaded lookup table based on the received NTN RAN orbit type indication.

The WTRU extracts the NTN RAN node velocity information that corresponds to the serving NTN RAN beam identifier from the determined NTN RAN velocity preloaded lookup table, refining the velocity estimation specific to the active beam covering the WTRU's geographic location.

The WTRU calculates a one-way NTN RAN propagation delay based on the extracted NTN RAN node velocity information and real-time Doppler shift measurements, enabling an accurate estimation of signal propagation time in the absence of explicitly provided Nominal Propagation Delay information.

The WTRU calculates the one-way NTN RAN propagation delay by multiplying the determined Doppler frequency shift by the speed of light, and dividing the result by the product of the carrier frequency and the determined NTN RAN node velocity, thereby enabling an accurate estimation of the signal propagation time in the absence of explicitly provided Nominal Propagation Delay information.

The WTRU overrides and updates the current NTN propagation delay value with the determined propagation delay information, ensuring synchronization accuracy with the NTN RAN node despite the absence of directly provided nominal delay values.

The WTRU continuously monitors Doppler shift variations and, upon detecting significant deviations from the expected velocity-based delay estimation, dynamically recalculates the propagation delay using updated lookup table data to maintain precision.

The WTRU, after calculating the NTN RAN propagation delay, searches the available DRX profiles to identify one that provides a wake-up period which extends the current wake-up period to account for the propagation delay, ensuring that the WTRU is awake and ready to receive downlink transmissions at the correct time, despite the delay introduced by the NTN RAN.

Upon calculating the dynamic NTN RAN propagation delay, the WTRU selects and activates a second DRX profile from the received one or more DRX profiles, wherein the second DRX profile is associated with a second wake-up period that is closest possible to, or minimizes the time difference between, the addition of the current first wake-up period and the determined NTN RAN propagation delay, such that the WTRU compensates for delayed signal receptions caused by the propagation delay by adjusting its wake-up period.

A Non-Terrestrial Network (NTN) Radio Access Network (RAN) node may comprise a transceiver configured to broadcast NTN ephemeris information to one or more wireless transmit/receive units (WTRUs) via broadcast System Information Block 1 (SIB1-NTN) and/or device-group-common Downlink Control Information (DCI) signaling, wherein the NTN ephemeris information includes an NTN RAN orbit type indication, NTN RAN nominal propagation delay information, and an NTN RAN unique beam identifier.

The NTN ephemeris information further includes one or more NTN RAN velocity preloaded lookup tables, each table associated with an NTN RAN orbit type identifier and mapping NTN RAN beams to NTN RAN node velocity information, enabling WTRUs to distinguish between multiple NTN RAN nodes operating in different orbits but covering overlapping geographic areas.

The NTN RAN node calculates and broadcasts the nominal propagation delay information for each active downlink beam by determining a worst-case propagation delay based on its orbital configuration, beam footprint geometry, and signal propagation conditions, and periodically updates said nominal propagation delay information for WTRU synchronization.

The NTN RAN node is a reference NTN RAN node selected via direct assignment configurations from a core network or NTN gateway, wherein the reference NTN RAN node is configured to broadcast the NTN ephemeris information periodically upon being designated as the reference node.

A non-reference NTN RAN node assumes the reference node role upon failing to detect transmissions of NTN ephemeris information from the reference NTN RAN node via inter-satellite links for a predefined time period, wherein the non-reference NTN RAN node broadcasts the NTN ephemeris information until the original reference NTN RAN node resumes transmission.

The reference NTN RAN node terminates transmission of the NTN ephemeris information upon detecting a radio failure or exceeding an energy consumption threshold, triggering a fallback mechanism wherein a secondary NTN RAN node assumes the reference node role.

A system comprising a group of WTRUs, wherein the group of WTRUs include a first WTRU having a first capability, a second WTRU having a second capability and a third WTRU having a third capability, wherein the first capability is lower than the second capability and the second capability is lower than the third capability.

Each WTRU has a transmitter, receiver, processor and memory.

The RAN node has a transmitter, receiver, processor and memory.

The present application addresses an issue of device compensation for timing differences between various types of satellites that the device may be connected to simultaneously or individually. A device may for example be connected on the Starlink network as a satcom device. A Starlink-supported IoT sensor may need to switch frequently between different types of satellites, for example, a LEO satellite, which is close to earth (offering reduced radio latencies), is moving quicker than earth to sustain the orbit and overcome drag, however a GEO satellite is far from earth and so, a standard GEO satellite moves with the earth speed. This leads to the device seeing different types of satellites on different orbits and different speeds during its active session and so, some dynamic timing adjustments may be needed.

In particular, issues exist in addressing how devices, in a consistent way across all device types and device capabilities, may perform such timing compensation. It may be that devices receive batch information about a satellite itself (e.g., satellite ephemeris info) and so, it a device implementation may be employed to handle the information, but this has some drawbacks. Since all NTN devices may need to read the information, including ephemeris information, potentially, from every single satellite they see, there may be much information to receive. Due to such large signaling overhead (e.g. if Starlink only has 10,000 satellites on orbits, quite a bit of signaling overhead would be needed. Also, device performance may be inconsistent.

Device-Capability-Aware Synchronization: Dual-mode operation for GNSS/non-GNSS devices may be employed, since NTN RAN node fundamentally serve low capable IoT sensors and normal Satcom devices. Such devices may not be treated the same way because of the vast difference in the capability to determine relative locations.

Velocity Lookup Tables: Preloaded, beam/orbit-specific data for Doppler-based delay estimation. It may be that only a small subset of STARLINK satellites will broadcast this info and it may be stored in devices to be used for determining timing compensation for other satellites on the same Starlink network, significantly reducing downlink signaling overhead per network. Each network vendor may assign unique beam IDs for all types satellites. For instance, a LEO and a GEO satellite, covering California, each of two beams, may be counted as 1, 2, 3, 4 and not the standard way of 1, 2 and 1, 2. This is due to preloaded tables, the devices extract velocity information based on beam information sent from another satellite in a past time, in embodiments, without needing to know anything additional from a new satellite other than the serving beam ID, which the device may already know.

Dynamic DRX Adaptation: Wake-up period adjustments tied to propagation delay. This may ensure consistent device behavior across all type of devices. For instance, whatever timing compensation a device has determined, it may need to still select one predefined DRX wake up cycle that fulfills its determined timing difference, even if it is larger slightly, and optionally report any selection changes of the active DRX profile. If aggregate radio performance is detected degrading withing a geography, the satellite may look at the common DRX profile used by most devices within the area and may change it such that it compensates for possible timing compensation errors at devices, specially those of a low capability. This further gives more control to RAN to enforce consistent device performance when needed.

Beam-Specific Ephemeris: Granular parameters for beam footprints and nominal delays. Having a unique beam structure across the entire network or at least over a geography allows for a significant signaling overhead reduction by the proposed design.

Real-Time Doppler Recalculation: Continuous refinement of delay estimates. This is a mathematical way for low/very low capable devices to mimic the one-way propagation delay using a mandatory measurement that any radio device may anyway perform, regardless of its capability, which is determining the doppler shift. This may not be entirely accurate, but in some cases it may mimic an exact propagation delay and proposed low capability estimation converge.

### Pt012

Low Earth Orbit (LEO) satellites have emerged as a pivotal component in modern communication systems due to their ability to offer reduced latency and global coverage. However, maintaining orbit in LEO necessitates higher orbital velocities, which results in rapid satellite rotations around the Earth. Consequently, a static device within the coverage area of a LEO satellite experiences only a brief period of connectivity-typically just a few minutes-before the satellite moves out of range and a new satellite becomes available in the constellation network.

This intrinsic characteristic of LEO satellite deployments introduces the need for exceptionally frequent session handovers to maintain uninterrupted connectivity. Each handover involves multiple signaling steps, including the transfer of device context information, security credentials, and ongoing session data between satellites. The rapid transitions among satellites impose stringent requirements on the timing and coordination of these signaling procedures to ensure that handover processes are executed with minimal disruption to service.

In one exemplary embodiment, a method is provided for an NTN Radio Access Network (RAN) node to manage handovers between LEO satellites. The method comprises receiving configuration information that defines handover training periods, during which standard NTN handover procedures are activated. The NTN RAN node counts and stores the number of handover requests associated with different target nodes within each training period and determines handover sub-periods that correspond to time intervals exhibiting the highest density of requests for a single target node.

By transmitting device-group context information to the next available NTN RAN node via ultra-high bandwidth inter-satellite links (ISLs) at precisely calculated times, the method ensures that handovers are executed with minimal delay. This approach effectively minimizes the signaling overhead by aggregating context information and synchronizing the handover process with the satellites' orbital dynamics.

In another exemplary embodiment, a Wireless Transmit/Receive Unit (WTRU) is configured to operate in a Non-Terrestrial Network environment with LEO satellite constellations. The WTRU determines if the current time coincides with a configured handover sub-period, during which the device receives handover instructions from an NTN RAN node. When the received signal power from the current satellite falls below a predetermined threshold, the WTRU initiates a search for the synchronization signal block (SSB) from a designated next available satellite. Upon detecting the SSB, the WTRU transmits a combined uplink preamble and device and/or session identifier using a timing advance value that accounts for propagation delays inherent to the varying orbital altitudes. This method ensures a seamless transition between satellites by preserving handover sub-period configurations and dynamically adapting to the fast-moving satellite environment.

A further exemplary embodiment combines aspects of both network-side and device-side processes to optimize handover efficiency in LEO satellite deployments. In this embodiment, the NTN RAN node not only defines handover training periods and sub-periods based on real-time handover request density but also adjusts these periods dynamically to align with the orbital trajectories of both the current and target satellites. The network node transmits handover sub-period configurations along with encrypted context information to both active devices and/or next available LEO satellite nodes in the constellation network, ensuring secure and timely delivery across the ultra-high bandwidth ISLs. Simultaneously, the WTRU validates the synchronization between the current and next available satellites using orbital parameter information embedded in their respective synchronization signals. If synchronization is confirmed within a predefined tolerance, the WTRU retains the handover sub-period configurations, thereby streamlining the handover process and reducing the likelihood of service interruption.

LEO satellite constellations comprise a network of satellites operating at relatively low altitudes, typically ranging from several hundred to a couple of thousand kilometers above the Earth's surface. The reduced altitude allows these satellites to maintain a lower propagation delay and enhanced link quality compared to satellites in higher orbits. However, the low orbital altitude necessitates that satellites travel at considerably higher velocities to counteract gravitational forces and sustain their orbits, which inherently results in rapid movement across the sky.

Due to the high speed of LEO satellites, a fixed device on the ground is served by a particular satellite for only a brief period, often limited to a few minutes. As each satellite quickly traverses the visible sky, connectivity is transferred from one satellite to another within the constellation. This continuous transition is an intrinsic characteristic of LEO satellite systems, ensuring that ground-based devices are regularly handed over to a new serving satellite, thereby maintaining uninterrupted communication despite the transient nature of the satellite's visibility.

The rapid succession of serving satellites necessitates robust and efficient handover mechanisms within the network. Each handover process must account for the satellites' mobility, the dynamic changes in the communication link, and the need to securely and reliably transfer device context information. This environment requires specialized signaling procedures to ensure that a device seamlessly connects to the next available LEO satellite, thereby sustaining ongoing communication sessions despite the inherently fleeting connection with any single satellite.

Standard handover procedures defined by current cellular standards involve a sequence of complex signaling steps. Initially, a device performs a first random access attempt, which may be followed by the reception of a random-access response from the network. This step establishes the initial communication link required for the subsequent handover procedures.

Following the random-access phase, the device transmits an RRC setup request to the network. In response, the network provides an RRC setup message that includes all necessary security and encryption keys along with a new device identifier. This exchange ensures that the device can securely continue its communication under the parameters of the new serving cell. Moreover, in scenarios where multiple devices attempt random access simultaneously, a contention resolution process is required to resolve any potential collisions among these devices.

The multi-step nature of the standard handover process contributes to increased handover delay. Each random access and contention resolution procedure introduces additional signaling overhead, which becomes particularly burdensome in environments where handovers occur frequently, such as in Low Earth Orbit (LEO) satellite constellations. This elevated signaling load can significantly impact the overall efficiency of the handover process, leading to potential disruptions in service continuity for devices that must transition between serving nodes on a frequent basis.

As depicted by Table 7, An NTN Radio Access Network (RAN) node is configured to receive, via a backhaul interface, one or more handover training periods. These training periods are communicated from at least one of an NTN ground gateway or a terrestrial network (TN) RAN node. Each handover training period is characterized by a defined start time instant and an end time instant, which demarcate the precise interval during which standard NTN handover procedures are activated. Additionally, in certain embodiments, the training period may include a periodicity parameter, thereby establishing a recurring schedule for handover operations.

The reception of these handover training periods via the backhaul interface provides the NTN RAN node with a structured temporal framework for managing handovers. By obtaining explicit timing information from reliable network entities such as an NTN ground gateway or a TN RAN node, the network element can effectively synchronize its handover activities with broader network operations. This synchronization helps ensure that the handover procedures occur within the designated training periods, optimizing the overall performance and reliability of the handover process.

Furthermore, the inclusion of periodicity within the handover training period definition enables the network to implement recurring handover operations at regular intervals. This recurring scheduling is particularly beneficial in dynamic non-terrestrial environments, where frequent handovers are required due to the rapid movement of satellites. By adhering to these predefined training periods, the network is better equipped to manage the signaling overhead and maintain service continuity, even in scenarios involving high-frequency handover events.

TABLE 7
Handover training timing configurations
Handover training timing configurations

| | |
|---|---|
| Start time | Rotation/Orbit index per day and/or absolute slot/frame or |
| | super-frame indication |
| End time | Rotation/Orbit index per day and/or absolute slot/frame or |
| | super-frame indication |
| Periodicity | ‘DAILY’, ‘WEEKLY’ etc |

In one embodiment, the determination of one or more handover training periods is performed autonomously by the satellite itself, without direct involvement from the core network. In this approach, each satellite utilizes locally available information, such as orbital parameters and link conditions, to independently configure the timing for activating standard NTN handover procedures. This autonomous determination enables the satellite to rapidly respond to dynamic operational conditions, thereby potentially reducing latency in the handover process and alleviating signaling burdens on the core network.

However, this self-determined approach introduces the possibility of inconsistency among satellites within the same network constellation. Since each satellite makes independent decisions regarding the start and end instants, or periodicity of the training periods, variations may arise that lead to misaligned handover intervals across different satellites. Such discrepancies could result in overlapping or missed handover opportunities, thereby impacting the seamless transition of connected devices between satellites.

In this case, potential timing conflicts may arise when the handover sub-periods are not synchronized across different satellites in the same network. Specifically, when a first satellite determines a handover sub-period during which a group handover is activated, and standard handover is deactivated, the devices connected to this satellite will expect the group handover process to be followed seamlessly. However, if the next available target LEO satellite node is not synchronized with the first satellite's timing, it may activate its own handover training period in which only the standard handover procedure is in effect. This misalignment creates a significant handover performance drop, as devices transitioning between satellites will attempt to perform a group handover to the target RAN node, but the target node will reject the group handover request due to its activation of standard handover procedures. As a result, devices may experience service disruptions or dropped connections, degrading the overall quality of service.

One possible solution to mitigate such timing conflicts is to assign a higher priority to certain satellite nodes, such as a master node. When the master node shares information regarding group handover sub-periods with other satellite nodes, it could take precedence and override any conflicting or outdated handover training and sub-period configurations on the receiving satellite nodes, referred to as slave nodes. By ensuring that the master node's timing and configurations are followed across the network, this approach prevents inconsistencies in handover procedures and ensures that all satellites are synchronized in their operations. The result is a more reliable handover process that maintains service continuity for devices transitioning between satellites within the LEO constellation.

Further, the backhaul configuration is designed to provide handover training periods on a periodic basis, with updates occurring daily. This daily periodicity ensures that the network maintains an up-to-date schedule for handover procedures, aligning the activation of standard NTN handover processes with predictable temporal intervals. The regular update mechanism also allows the network to adapt dynamically to the operational environment, thereby ensuring that handover parameters remain optimized for current conditions.

For example, each handover training period is can be mapped to a predefined number of orbital rotations of the NTN RAN node around the Earth. By linking the training period to orbital rotations, the method leverages the inherent periodicity and predictability of satellite movement, ensuring that the timing of handover operations is synchronized with the satellite's trajectory. This synchronization minimizes the likelihood of disruptions during the handover process, as the training period is tailored to the natural dynamics of the satellite's orbit.

The method further comprises deactivating device-group periodic handover during the configured and/or determined handover training periods. By suspending these periodic handover processes, the system is able to focus exclusively on executing the standard NTN handover procedures within the designated intervals. This dedicated approach ensures that resources are concentrated on optimizing the handover process during the training periods, thereby reducing the potential for signaling conflicts and timing discrepancies.

Moreover, the method comprises counting and storing the number of inter-NTN-RAN-node handover requests that occur during each designated handover training period. Within these periods, the system monitors incoming handover requests from connected devices that are directed toward one or more target NTN RAN nodes. This counting process provides a quantitative measure of the handover demand, allowing the network node to gauge the volume of handover activity in real time.

The handover requests are associated with specific target NTN RAN nodes, and the counting mechanism categorizes these requests accordingly. By storing this information in a dedicated database or memory, either locally on board of the satellite RAN node or externally on NTN gateways of backhaul data centers, the system is able to maintain an organized record of handover events per training period. This record forms the basis for further analysis, such as identifying the peak intervals where the density of requests is highest, and subsequently defining optimal sub-periods for executing handover procedures.

Moreover, the accumulated data not only enables efficient scheduling of handover processes but also facilitates dynamic adaptation to varying network conditions. The stored counts serve as an input for subsequent processing steps, such as clustering handover requests based on their associated target nodes and real-time timestamps. This structured approach to managing handover requests enhances the overall coordination between NTN RAN nodes, ensuring that device context transfers and subsequent handover operations are performed with minimal disruption to service continuity.

The counting mechanism is designed to associate each handover request with a target NTN RAN node, thereby ensuring that only those requests relevant to the immediate handover process are considered during a training period. This targeted counting strategy is intended to prevent erroneous or “ping-pong” handovers, which may otherwise occur if requests directed toward nodes that are significantly distant from the source RAN node were treated equally. By discriminating based on the proximity and intended target node, the system can focus on handover requests that are most relevant for the current operational context.

For example, consider a scenario in which a source NTN RAN node receives 1000 handover requests all directed toward the next available NTN RAN node within the LEO constellation network, while simultaneously receiving additional 5 handover requests toward nodes that are considerably farther away. In this embodiment, the counting process is configured to recognize that the vast majority of requests are intended for the adjacent node and, consequently, only the 1000 requests are recorded as relevant to the current handover training period. The remaining requests are filtered out, as their target nodes do not align with the optimal handover trajectory for a device located in the immediate coverage area.

This selective counting approach not only improves the accuracy of handover scheduling but also minimizes unnecessary signaling and processing overhead. By concentrating on the dominant set of handover requests, the NTN RAN node is better able to allocate resources efficiently and execute handover procedures that maintain service continuity. The method ensures that handovers are executed only when and where they are most beneficial, thereby reducing the likelihood of service disruptions caused by misdirected or extraneous handover attempts.

The NTN RAN node may further determine one or more handover sub-periods within each handover training period. This method involves analyzing the distribution of handover requests received during the training period and identifying the specific time interval where the number of requests associated with a single target NTN RAN node is maximized. The process defines each sub-period by a start time indication and an end time instant, encapsulating the window during which the highest concentration of handover requests is observed.

The signaling aspects of the handover sub-periods play a critical role in the efficient management of device transitions between NTN RAN nodes within a Non-Terrestrial Network (NTN). To ensure that all active devices within a given handover sub-period are properly informed of the upcoming handover event, the first step involves transmitting the sub-period information to the devices via a common downlink channel. Specifically, the information is transmitted over a group common Downlink Control Information (DCI) channel. This method allows the sub-period details-such as the start time, end time, and the associated target NTN RAN node identifier—to be broadcast to all active devices within the coverage area simultaneously. Each device is able to monitor the DCI channel and receive the sub-period information in a single transmission, which helps to minimize the overhead associated with the signaling process. By utilizing the common DCI channel, the devices are quickly informed of the timing of the handover sub-period, ensuring synchronized transitions and reducing signaling delays.

In dynamic non-terrestrial networks, particularly those utilizing LEO satellite constellations, determining the handover sub-period may be needed for capturing handover requests from devices served by various moving beams of a source NTN RAN node. As these devices transition from one beam to another, their handover requests are generated when moving from a current beam toward the appearing beams of the next available LEO node. The sub-period determination process is thus tailored to capture these requests accurately across all available beams, ensuring that the complete set of handover signals is aggregated within the designated time window.

This process involves continuously monitoring the handover requests from devices across the various moving beams of the source NTN RAN node. By aligning the sub-period with the time intervals during which the highest density of overlapping requests is observed, the system accounts for the dynamic beam coverage inherent to LEO satellite networks. This alignment allows for an effective aggregation of requests not only from a single beam but from all beams that are in transition, thereby reflecting the true scope of the handover demand in the network.

By capturing the total number of handover requests within the optimized sub-period, the method facilitates a more efficient handover process. The aggregation ensures that the signaling overhead is minimized by consolidating device transitions into a well-defined time interval, ultimately leading to improved network synchronization and more reliable handover performance. This integrated approach is especially important in rapidly changing satellite environments, where timely and precise handover execution is essential to maintain uninterrupted service continuity.

Thus, the determination of the handover sub-period begins with a comprehensive analysis of the incoming handover requests over the entire training period. The NTN RAN node aggregates or sums and examines the temporal data associated with each target NTN RAN node, pinpointing the interval that exhibits peak activity. Once this interval is identified, its beginning and end are marked by a start time and an end time, respectively, thus creating a sub-period that optimally represents the period of greatest handover demand for the specified target node.

By isolating these sub-periods, the method enables the network to concentrate handover procedures during the most active intervals, thereby reducing unnecessary signaling and minimizing potential delays. This targeted approach is particularly advantageous in dynamic non-terrestrial environments, where efficient handover execution is required to maintaining continuous service amidst rapidly changing satellite coverage.

Specifically, the method includes aggregating handover requests that are associated with a common target NTN RAN node identifier. By grouping these requests based on their target identifier and aligning them according to their real-time timestamps, the system creates a data set that reflects the temporal clustering of handover demands for that specific target node. This aggregation forms the basis for subsequent analysis aimed at determining optimal handover timing.

Building upon the aggregated data, the method defines each handover sub-period as a contiguous time interval during which there is a maximum density of overlapping requests directed to the same target node. By examining the real-time timestamps, the system identifies intervals where the handover request traffic is most concentrated. The start and end instants of each sub-period are then determined by the temporal boundaries of these overlapping requests, ensuring that the sub-period encapsulates the period of peak handover activity.

Alternatively, the method may further comprise clustering handover requests into sub-periods by first grouping together those requests that share a common target NTN RAN node identifier and that occur within a predefined time window. By establishing this temporal window, the system ensures that only requests occurring in close succession are considered for clustering, thereby isolating periods of intense handover activity that are likely to be operationally significant.

Following the grouping process, the method involves evaluating the size of each resulting cluster by counting the number of handover requests contained within each time-bound group. Only clusters that exceed a predetermined threshold count are selected as valid handover sub-periods. This selection criterion ensures that the system prioritizes sub-periods where a significant density of overlapping handover requests exists, thereby focusing network resources on the most relevant intervals for executing handovers.

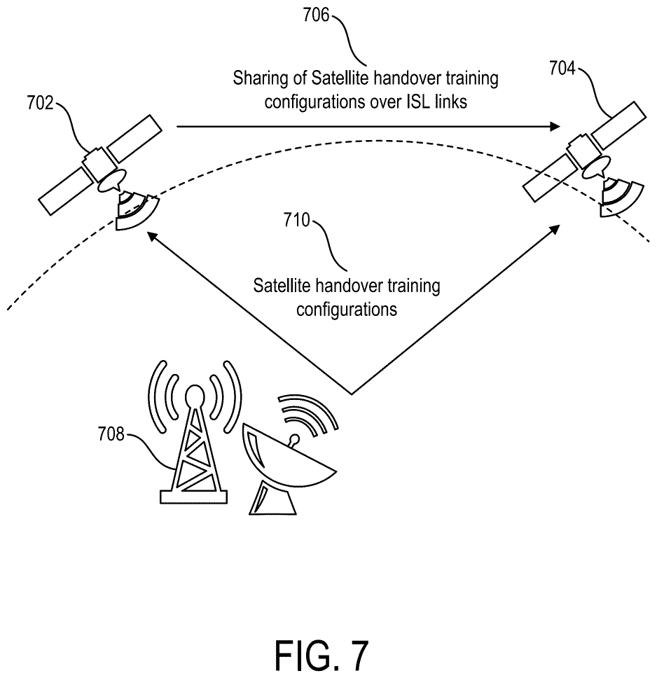

As shown by FIG. 7, the method includes transmitting information 706 including device-group context information from one RAN node 702 to the next available NTN RAN node 704 via ultra-high bandwidth inter-satellite links (ISLs). The device-group context information comprises needed data necessary for seamless handover execution, including device identifiers, security parameters, and session data. The transmission of this information is strategically timed based on the detection of a current time instant that matches the start time instant of any determined handover sub-period, adjusted by subtracting a predefined time offset. This ensures that the target NTN RAN node receives the required context information ahead of the actual handover event. Information 710 may be transmitted by a ground node 706 coupled to a satellite gateway.

The source NTN RAN node determines the next available target NTN RAN node for handover based on multiple possible mechanisms. One approach involves leveraging the reported cell list provided by connected devices. As devices maintain connectivity with the current NTN RAN node, they continuously scan for neighboring NTN RAN nodes and report detected signal measurements. These reports allow the source NTN RAN node to identify the next available target NTN RAN node by selecting the strongest candidate from the reported measurements. Since LEO satellites exhibit rapid orbital movement, these reports are updated frequently, ensuring that the source NTN RAN node has up-to-date information on the optimal target for an impending handover event.

In another embodiment, the source NTN RAN node may determine the next available target NTN RAN node by consulting a predefined configuration list containing information about all LEO satellites in the entire constellation network, preconfigured from core network and/or NTN gateway. Each NTN RAN node is pre-configured with a network-wide topology, which includes identifiers and orbital parameters of all satellites within the constellation. Using this topology, each NTN RAN node can independently determine its neighboring nodes at any given time by applying orbital parameters. This method ensures deterministic selection of the next available target NTN RAN node without requiring device measurement reports or real-time scanning. The predefined list approach is particularly beneficial in cases where inter-satellite signaling is limited or when rapid handover decision-making is required.

The predefined time offset is selected to accommodate or match the processing and propagation delay associated with ISL transmissions, allowing the receiving NTN RAN node sufficient time to prepare for the upcoming handover. By proactively sending device-group context data before the handover sub-period begins, the target NTN RAN node can pre-establish necessary connections, validate security parameters, and allocate resources for the incoming devices. This reduces handover latency and ensures that devices transitioning between NTN RAN nodes experience minimal service disruption.

The device-group context information transmitted from the source NTN RAN node to the next available target NTN RAN node comprises multiple information elements that facilitate a seamless handover process. These elements ensure that the target NTN RAN node has sufficient information to authenticate, re-establish, and continue communication with the incoming devices without unnecessary delays or re-initialization procedures.

One component of the device-group context information includes encryption-related parameters such as encryption transmit and receive keys. These keys ensure that secure communication is maintained as devices transition from one NTN RAN node to another. By pre-sharing the encryption keys with the target NTN RAN node ahead of the handover event, devices can continue encrypted communication without requiring a full re-negotiation of security parameters, thus reducing the time required for re-authentication.

Additionally, the device-group context includes session identifiers (Session IDs) that uniquely associate a device with an ongoing communication session. Since a session may involve active data transfer, voice communication, or real-time application usage, the seamless transfer of session information ensures that devices do not experience interruptions or resets during handover. This is particularly important in NTN environments where frequent handovers occur due to satellite mobility.

Another information element of the device-group context information is the Quality of Service (QoS) profile identifier. The QoS profile ID is used to preserve the service quality settings associated with each device's connection. This ensures that the target NTN RAN node allocates appropriate resources in accordance with the service level agreements (SLAs) associated with different applications, such as low-latency video calls or high-throughput data transfers. Without the proper transmission of QoS parameters, a device might experience degraded service quality following the handover.

Furthermore, the device-group context may include temporary device identifiers such as the C-RNTI (Cell Radio Network Temporary Identifier), in case the C-RNTI will be retained over both the first and second NTN RAN nodes, which allows the target NTN RAN node to immediately recognize and establish communication with incoming devices. Alongside this, security tokens and integrity protection parameters are transmitted to ensure that devices are not vulnerable to security breaches during the transition from one NTN RAN node to another.

The use of ultra-high bandwidth ISLs enables rapid and efficient transfer of context information between satellites, ensuring that the next available NTN RAN node has up-to-date session details before device handovers commence. This approach optimizes network resource utilization by eliminating redundant signaling between the device and the new NTN RAN node. By coordinating the timing of context information transmission with the start of the handover sub-period, the system significantly improves handover reliability and minimizes the risk of dropped connections in a dynamic non-terrestrial environment.

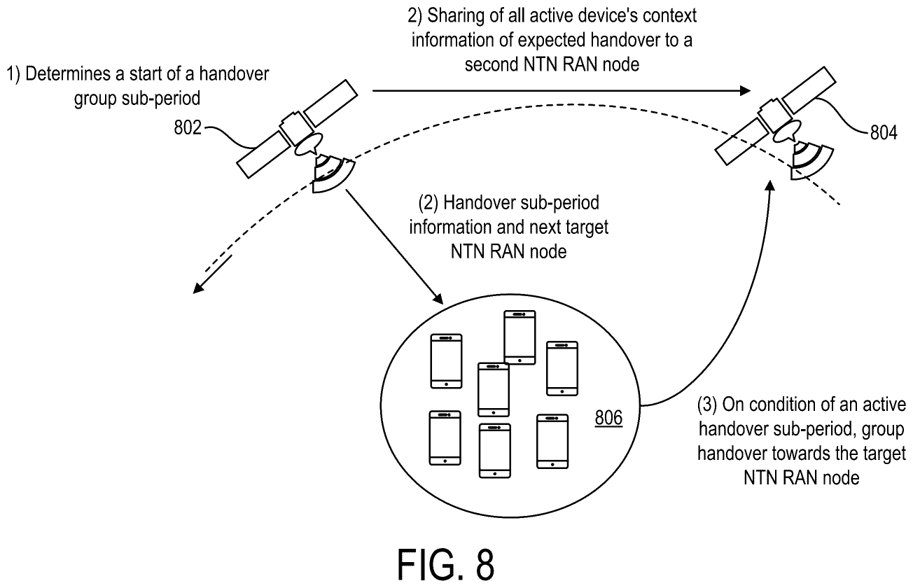

As depicted by FIG. 8, the method further includes RAN node 802 transmitting the determined handover sub-periods along with an identifier of the next available NTN RAN node 804 to active devices 806 that are associated with an expected group handover. This transmission ensures that each device is pre-configured with the necessary information to execute a seamless transition from the current NTN RAN node to the designated target node. By providing the devices with a specific handover sub-period, the method enables precise timing for handover execution, reducing unnecessary signaling and improving overall efficiency.

The identifier of the next available NTN RAN node allows the devices to prioritize their synchronization and initial access procedures toward the correct target node. This pre-configuration eliminates the need for devices to blindly search for a suitable NTN RAN node during the handover event, thereby reducing the handover delay and improving the probability of a successful connection. Additionally, by associating the handover sub-periods with the expected group handover, the method ensures that multiple devices can coordinate their transitions, reducing contention and interference during the process.

By transmitting this information in advance, the method enables devices to adjust their handover timing based on network-wide scheduling rather than relying solely on conventional signal strength measurements. This approach enhances handover predictability and minimizes service interruptions by allowing devices to anticipate their next connection point. The combination of pre-configured handover timing and targeted node identification significantly optimizes mobility management in non-terrestrial networks, ensuring that handovers are performed efficiently, even in rapidly changing satellite environments.

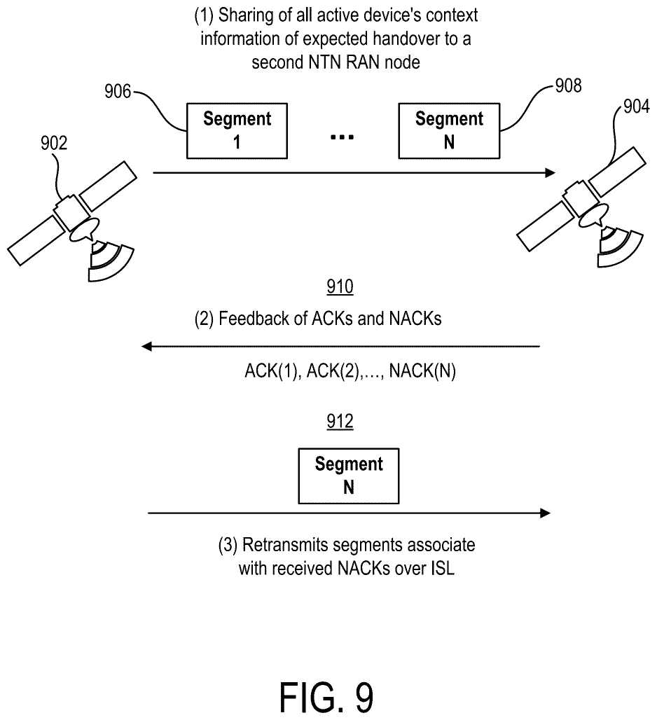

As shown by FIG. 9, an NTN RAN node 902 segments the device-group context information into blocks 906, 908 to facilitate efficient and reliable transmission over ultra-high bandwidth inter-satellite links (ISLs) to one or more RAN nodes including RAN node 904. Each block of context information is tagged with a target NTN RAN node identifier, ensuring that the receiving node can correctly associate the received data with the appropriate handover event. Additionally, each block is assigned a sequence number, allowing the next available NTN RAN node 904 to reconstruct the full context dataset in the correct order upon reception.

The segmentation of device-group context information into smaller blocks optimizes transmission efficiency, particularly in scenarios where large volumes of handover-related data must be transferred within a limited time window. By breaking down the context information into sequentially numbered units, the method minimizes the impact of potential transmission errors or packet loss, as missing or corrupted blocks can be identified and selectively retransmitted without requiring the resending of the entire dataset.

The method includes RAN node 902 receiving an acknowledgment 910 from the next available NTN RAN node 904 confirming the successful receipt of the device-group context information. This acknowledgment mechanism ensures that the receiving NTN RAN node has correctly obtained and reconstructed all necessary blocks of context information before the handover sub-period begins. The acknowledgment 910 may be transmitted over ultra-high bandwidth inter-satellite links (ISLs) to provide rapid confirmation of data reception and integrity verification. By implementing an acknowledgment system, the method enhances handover reliability and reduces the risk of data loss during the transmission process. Feedback may comprise an acknowledgement or negative acknowledgement. Feedback may be on a per segment basis or may acknowledge multiple segments simultaneously.

If any segments of the device-group context information remain unacknowledged or are determined to be missing due to transmission errors, the method includes retransmitting 912 these unacknowledged segments prior to the start time instant of the handover sub-period. This ensures that all essential handover-related data is fully received before devices initiate their connection to the next NTN RAN node. The retransmission process is performed selectively, resending only those segments that failed to be acknowledged, thereby optimizing bandwidth utilization and minimizing unnecessary data duplication over the ISLs.

By ensuring complete and accurate transmission of device-group context information through acknowledgment and selective retransmission, the method significantly improves the efficiency and reliability of NTN handovers. The receiving NTN RAN node is able to prepare for incoming handovers with full device context, including security parameters, session states, and device identifiers, reducing the likelihood of service disruptions. Additionally, by completing retransmissions before the start time instant of the handover sub-period, the method ensures that all devices undergoing the group handover can seamlessly transition to the next NTN RAN node without unnecessary delays or connection failures.

The security parameters included in the device-group context information may include encryption keys, integrity protection keys, authentication tokens, and access control credentials. The encryption keys typically consist or are comprised of both transmit and receive keys, allowing devices to maintain encrypted communication with the new NTN RAN node without requiring a full security re-negotiation. Integrity protection keys may ensure that all exchanged messages between the device and the target NTN RAN node remain untampered, preventing potential man-in-the-middle attacks or data corruption during handover. Authentication tokens, derived from prior security negotiations, enable the target NTN RAN node to quickly verify the legitimacy of the device without involving the core network, thereby reducing authentication overhead. Additionally, access control credentials specify the device's authorization level within the NTN network, determining whether the device is permitted to connect to specific beams, frequencies, or priority service classes.

Session states within the device-group context information ensure that ongoing communication sessions remain intact as the device transitions between NTN RAN nodes. This includes session identifiers (Session ID) that uniquely tag an active communication session for each device. By preserving the session ID, the target NTN RAN node can associate incoming device traffic with the correct ongoing session, avoiding service interruptions. Furthermore, bearer context information is included to define how data flows are structured for different services, such as separate bearers for voice, video, or best-effort data traffic. These bearer contexts also contain QoS parameters that dictate latency, throughput, and packet loss requirements, ensuring the new NTN RAN node maintains the same service level agreements (SLAs) post-handover.

Additionally, sequence numbers for packet data convergence protocol (PDCP) and radio link control (RLC) layers are transferred to ensure that data continuity is preserved. Without these sequence numbers, reordering issues may arise, leading to packet loss or retransmissions that degrade service quality. Timing advance values, which compensate for transmission delays due to varying satellite distances, are also transferred to optimize synchronization between the device and the new NTN RAN node.

In an embodiment, a Wireless Transmit/Receive Unit (WTRU) operating in a Non-Terrestrial Network (NTN) determines whether a current time instant coincides with a configured handover sub-period received from a first NTN RAN node. This determination allows the WTRU to align its handover procedures with network-optimized timing, reducing unnecessary handover attempts and ensuring a more efficient transition between NTN RAN nodes. The configured handover sub-period is received as part of the WTRU's network signaling and is based on pre-determined scheduling that accounts for satellite mobility patterns and predicted service continuity. By referencing this configured sub-period, the WTRU avoids initiating handovers outside of optimal time windows, thereby reducing signaling overhead and improving network stability.

Once the WTRU determines that the current time instant falls within the configured handover sub-period, it further evaluates whether a handover is necessary by measuring the received signal power from the first NTN RAN node. If the received signal power exceeds a minimum coverage threshold during the handover sub-period, the WTRU skips the initiation of a handover to a second NTN RAN node. This mechanism prevents premature or unnecessary handovers when the existing connection remains viable, avoiding disruptions to ongoing sessions and reducing redundant signaling exchanges. By incorporating a signal-based condition into the handover process, the method ensures that handovers are only triggered when necessary, optimizing resource utilization and minimizing interruptions in service.

The ability of the WTRU to conditionally defer a handover based on real-time signal strength measurements enhances network efficiency, particularly in NTN environments where satellite beam coverage can fluctuate due to orbital dynamics. By dynamically adjusting handover decisions based on both time and signal quality, the method provides a more intelligent approach to mobility management, reducing instances of unnecessary transitions while ensuring that handovers occur at the most optimal moments. This approach ultimately leads to improved user experience by maintaining stable connectivity while minimizing excessive signaling overhead associated with frequent handovers in rapidly moving satellite networks.

Furthermore, the Wireless Transmit/Receive Unit (WTRU) actively searches for a synchronization signal block (SSB) of a second NTN RAN node when the received signal power from the first NTN RAN node falls below a predefined minimum coverage threshold. This process ensures that the WTRU does not prematurely initiate a handover but instead transitions to the next available NTN RAN node only when necessary for maintaining service continuity. The received signal power threshold acts as a trigger for initiating the SSB search, preventing unnecessary handover attempts and optimizing network resource usage.

The search for the SSB of the second NTN RAN node is performed across frequency bands that are preconfigured by the first NTN RAN node, ensuring that the WTRU prioritizes detection in the most likely bands where the next NTN RAN node is expected to appear. Since the mobility of NTN RAN nodes in a Low Earth Orbit (LEO) constellation causes frequent transitions between coverage areas, the preconfigured frequency bands are determined based on predicted orbital positions and network-wide synchronization parameters. This targeted search method enhances the efficiency of the SSB detection process by reducing scanning latency and improving the likelihood of successful synchronization.

Upon detecting an SSB from the second NTN RAN node, the WTRU prepares for the handover process by extracting synchronization information, including time and frequency alignment, from the received SSB. This synchronization allows the WTRU to establish an initial link with the second NTN RAN node, facilitating a seamless transition while minimizing connection disruptions. By ensuring that the SSB search is triggered only when necessary and is performed within optimized frequency bands, the method significantly improves the reliability and efficiency of NTN handovers in satellite-based communication systems.

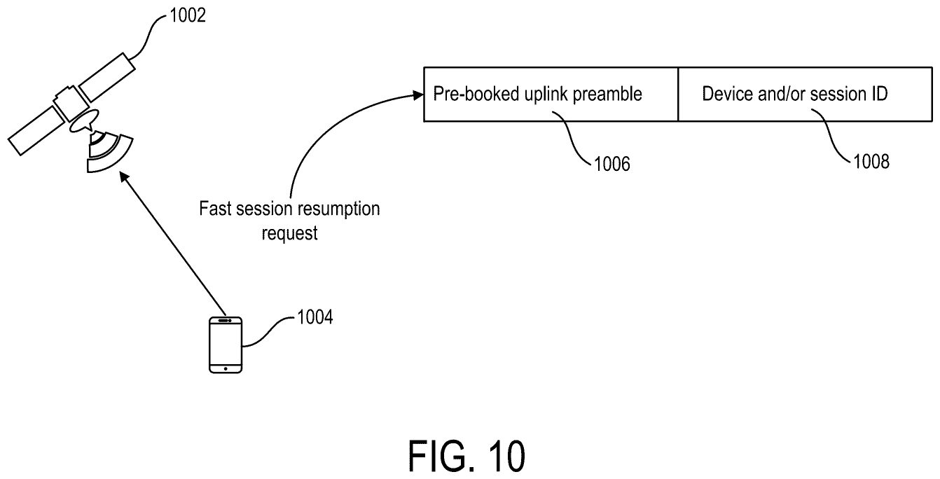

As shown by FIG. 10, upon detecting the second NTN RAN node 1002, the Wireless Transmit/Receive Unit (WTRU) 1004 transmits a fast session resumption request comprising a combined uplink preamble 1006 and device or session identifier 1008 to the second NTN RAN node 1002. This transmission is performed using a timing advance value that was previously associated with the first NTN RAN node, ensuring that the initial uplink access is synchronized with the expected transmission timing at the new node. By reusing the timing advance value from the first NTN RAN node, the WTRU can expedite the handover process, reducing the time required for synchronization and avoiding unnecessary delays caused by a full random-access procedure.

The combined uplink preamble serves as both an access request and an identifier for the WTRU, enabling the second NTN RAN node to recognize the device and establish a connection without requiring additional identity resolution steps. This optimization reduces the number of signaling exchanges traditionally required for handover, thereby minimizing handover latency and lowering the risk of service disruption. Since NTN RAN nodes in a Low Earth Orbit (LEO) constellation have limited connectivity windows with any given WTRU, the ability to quickly establish a new connection is important for maintaining seamless communication.

By leveraging the timing advance value associated with the first NTN RAN node, the WTRU ensures that its transmission is time-aligned with the frame structure of the second NTN RAN node (given that both first and second NTN LEO RAN nodes shall assume almost the relative position and distance to the device at the time of the handover due to the systematic NTN RAN node movement). This prevents collisions and retransmissions that could otherwise occur due to misaligned timing in the uplink access phase. The method further enhances efficiency by allowing the second NTN RAN node to immediately process the received preamble and device identifier, expediting the transition of network context and reducing contention in the handover process. Through these enhancements, the approach significantly improves the reliability and speed of handovers in NTN environments.

Transmitting the combined uplink preamble and device identifier towards a second NTN RAN node involves applying security measures to protect device identity and maintain data integrity. In this method, the device identifier is encrypted using a session-specific key that was previously shared with the first NTN RAN node. By leveraging a session-specific key, the encryption ensures that only authorized NTN RAN nodes within the network constellation can decrypt and authenticate the device identifier, preventing unauthorized access and potential interception of device information during handover. This security mechanism is particularly crucial in NTN environments where transmissions occur over vast geographical areas, increasing the risk of eavesdropping or unauthorized access.

In addition to encryption, a checksum is appended to the transmission, which is computed using the timing advance value associated with the first NTN RAN node. The checksum serves as an integrity verification mechanism, allowing the second NTN RAN node to confirm that the received data has not been altered or corrupted during transmission. Since timing advance values are unique to each device's connection with an NTN RAN node, incorporating this value in the checksum enhances security by ensuring that only devices with valid timing information can successfully establish a connection with the second NTN RAN node. This prevents potential replay attacks where an unauthorized entity attempts to reuse previously transmitted access information.

Given that the second NTN RAN node has already received the device context parameters from the first NTN RAN node, it is capable of blind decoding the encrypted combined preambles and device identifier signaling. This enables the second NTN RAN node to efficiently determine the intended device without requiring additional signaling exchanges for identity resolution. Since the encryption key used in the device's transmission is a session-specific key shared with the first NTN RAN node, the second NTN RAN node can utilize its pre-stored context information to attempt decryption and identify the associated device.

By leveraging the pre-known session-specific encryption keys, the second NTN RAN node can systematically attempt to decrypt incoming transmissions and correlate them with previously received context information. This eliminates the need for explicit device identity transmission in plaintext, thereby enhancing security and reducing handover-related signaling overhead. Instead of requiring the device to explicitly transmit an unencrypted identifier, which could be intercepted or misused, the second NTN RAN node relies on the cryptographic association established during the prior connection with the first NTN RAN node.

The process of blind decoding involves detecting and interpreting the encrypted combined uplink preamble and device identifier without requiring prior explicit signaling from the device. Since the encryption keys are unique to each device session, the second NTN RAN node can iterate through the stored keys to decrypt the received message and validate the authenticity of the transmission. Upon successful decryption, the second NTN RAN node immediately associates the received message with the corresponding device, enabling a seamless and secure handover process. This approach significantly reduces handover latency and minimizes unnecessary signaling exchanges, ensuring efficient mobility management within the NTN network.

Furthermore, the ability to blind decode encrypted signaling ensures that the second NTN RAN node can support large-scale device handovers efficiently. Given the high mobility of LEO satellite-based NTN networks, where frequent handovers occur within short time intervals, reducing the processing time required for identity validation is needed. By directly deriving the device association from the encrypted transmission, the second NTN RAN node can facilitate a more rapid and secure transition, maintaining uninterrupted service continuity as the device transitions from one satellite to another.

In case the core network policy manager enforces a session key expiration policy, the first NTN RAN node must ensure that the security context remains valid during the handover process. The expiration policy may dictate that a session key is only valid for a predefined duration, such as a fixed number of orbital rotations, a set number of handovers, or a maximum time limit since its initial generation. If a device's session key is nearing expiration, the first NTN RAN node must proactively generate and distribute a new session key before executing the handover.

To maintain secure communication, the first NTN RAN node updates the device with the new session key through an encrypted downlink control information. Simultaneously, it transmits the updated session key to the second NTN RAN node via the inter-satellite link (ISL), ensuring that the receiving node has the correct security credentials before the handover event occurs. This guarantees that the second NTN RAN node can successfully authenticate and decrypt the incoming handover signaling from the device without requiring additional round-trip signaling to the core network, which would introduce unnecessary delays.

The session key update process must be synchronized with the handover sub-period determination to prevent security mismatches. If a handover is scheduled within a short time window after a session key refresh, the first NTN RAN node must ensure that both the device and the second NTN RAN node receive the updated key before the start of the handover sub-period. This prevents a scenario where a device transmits an encrypted uplink preamble using a newly assigned session key that the second NTN RAN node has not yet received, which would result in authentication failure and potential service disruption.

The combined uplink preamble and device identifier are transmitted over a contention-based uplink resource that is pre-allocated by the first NTN RAN node specifically for the handover sub-period. This eliminates the need for standard scheduling request procedures, thereby reducing the signaling burden and accelerating the handover process. By using a contention-based mechanism, multiple devices can initiate their handover signaling simultaneously without waiting for individual grant allocations, ensuring a more efficient use of the available uplink resources during the handover event.

The first NTN RAN node designates specific contention-based uplink resources within the handover sub-period, ensuring that devices transitioning to the second NTN RAN node have a predetermined channel to transmit their combined uplink preamble and device identifier. This pre-allocation is communicated to the devices prior to the handover event, allowing them to synchronize their transmissions within the designated resource without additional coordination. This approach is particularly beneficial in NTN networks, where frequent handovers due to satellite mobility necessitate rapid and efficient signaling mechanisms.

By bypassing the standard scheduling request procedures (including transmitting scheduling request for RRC setup request transmission, receiving the uplink grant through DCI signaling, and transmitting the actual RRC setup request message), the contention-based approach enables a more scalable handover process, particularly in scenarios where multiple devices need to perform handovers within a short time frame. Instead of each device individually requesting uplink resources and awaiting an explicit grant from the first NTN RAN node, all devices utilize the pre-allocated contention-based resources to initiate their handover transmissions concurrently. This approach minimizes delays associated with resource request and grant procedures, allowing for a seamless transition to the second NTN RAN node.

Additionally, the contention-based uplink resource allocation accounts for the high-mobility nature of NTN networks by ensuring that devices can transmit their handover signaling without requiring precise scheduling coordination. This is particularly relevant for LEO satellite networks, where the short visibility window of a given NTN RAN node requires an expedited handover mechanism. The use of contention-based transmission further allows devices to rapidly establish their connection with the second NTN RAN node, ensuring continuity of service as they transition across different satellite beams.

To mitigate potential collisions that may arise from multiple devices utilizing the same contention-based resource, the NTN network can implement advanced collision resolution mechanisms such as backoff timers or random retransmission windows. These mechanisms ensure that, even in the event of simultaneous transmissions by multiple devices, eventual successful handover signaling is achieved without significant retransmission delays. By integrating these contention-based strategies, the NTN network optimizes its handover efficiency, ensuring minimal disruption to device connectivity during satellite transitions.

In the context of a device performing a handover from a first NTN RAN node to a second NTN RAN node, retaining the handover sub-period configurations is contingent on the synchronization of the two NTN RAN nodes in their respective orbital parameters. The synchronization ensures that the time intervals and orbital trajectories, which define the handover sub-periods, are consistent between the first and second nodes. If the nodes are synchronized, the device can continue using the configurations without recalculating or renegotiating timing parameters, enabling a seamless handover process.

To validate the synchronization between the first and second NTN RAN nodes, the system compares the orbital parameters embedded in the respective synchronization signal blocks (SSBs) transmitted by both nodes. These orbital parameters include information such as the relative positions, velocities, and orbital trajectories of the satellites within the network. The comparison of these parameters helps determine if the timing of the handover sub-periods from the first node is still valid for use by the second node. If the orbital parameters of the two NTN RAN nodes match within a predefined tolerance threshold, the device retains the handover sub-period configurations received from the first node, ensuring continuity and minimizing the need for additional signaling.

However, if the synchronization discrepancy between the first and second NTN RAN nodes exceeds the predefined tolerance threshold, it indicates a significant misalignment in their orbital trajectories. In such cases, the device may be required to adjust the handover sub-period configurations to align with the updated orbital parameters of the second NTN RAN node. This adjustment process ensures that the handover occurs within the correct timing window, based on the actual positions of the satellites involved. Failing to do so could result in improper timing of device context information transmission, potentially leading to delays or disruptions in the handover process.

The predefined tolerance threshold acts as a safeguard, ensuring that only small, negligible discrepancies are allowed to go uncorrected. If the synchronization mismatch is minor and within acceptable limits, the system allows for the retention of the existing handover sub-periods, ensuring efficient handovers without the need for recalibration. This reduces the computational and signaling overhead, streamlining the handover process and enhancing overall network performance. On the other hand, if the discrepancy is large enough to affect the timing integrity, the device will initiate adjustments to synchronize with the second node's orbital parameters, ensuring that the handover is performed within the correct time frame.

By validating the synchronization of orbital parameters and retaining handover sub-period configurations only when the discrepancy is within an acceptable range, the method significantly improves the efficiency of the handover process in NTN networks. This approach minimizes unnecessary signaling exchanges while ensuring that the device maintains a continuous and reliable connection as it moves between satellite beams in LEO-based NTN networks. The system's ability to validate synchronization and adjust accordingly ensures a robust handover mechanism, even in high-mobility, dynamic satellite environments.

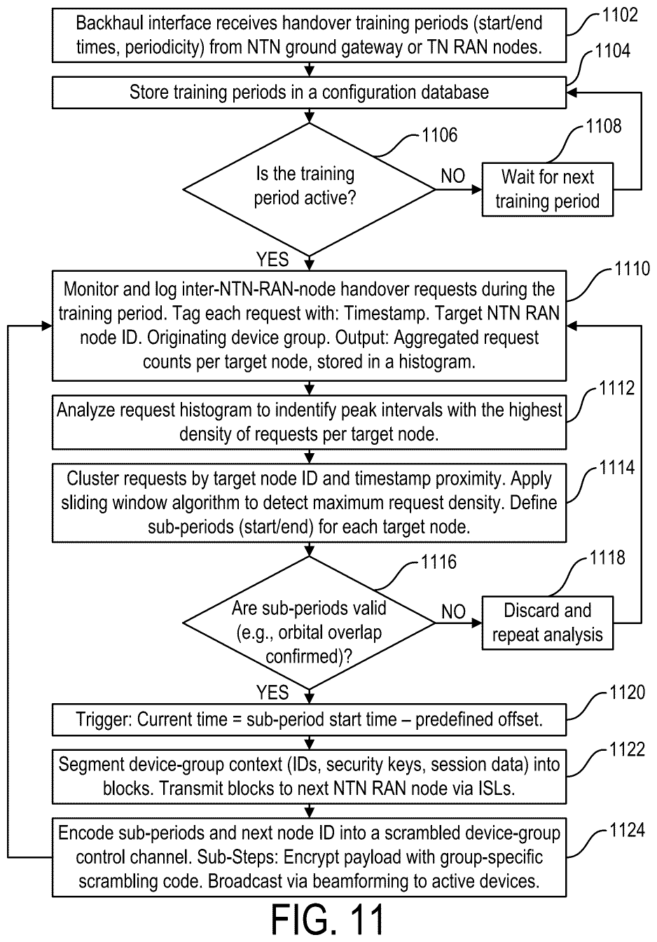

FIG. 11 illustrates example overall steps, showing a comprehensive flow of the processes involved in managing device handovers within a Non-Terrestrial Network (NTN) environment. The process begins with the receipt 1102 of handover training periods via the backhaul interface from either the NTN ground gateway or a terrestrial network (TN) RAN node. These handover training periods are defined by specific start and end times, and potentially periodic intervals, during which standard NTN handover procedures are activated. Training periods may be stored 1104. If a training period is not active 1106, a next training period 1108 may be waited for.

Once the handover training periods are established, the system counts and stores 1110 the number of inter-NTN-RAN-node handover requests that occur during each training period. These requests are associated with one or more target NTN RAN nodes, and the data is categorized based on the target node identifiers. This step ensures that only relevant handover requests are considered, avoiding erroneous requests from nodes that are far away from the source RAN node. A request histogram may be analyzed 1112. A sliding window may be utilized 1114.

The figure further illustrates the determination of handover sub-periods 1116, where the system identifies the time intervals with the highest density of overlapping handover requests for each target NTN RAN node. These sub-periods are defined based on real-time timestamps and help in predicting the optimal timing for device handovers. If sub-periods are not valid, a discard and repeat 1118 may be performed.

The next steps in the figure involves a trigger 1120 on current time=sup-period start time minus predetermined offset and involves transmitting 1122 device-group context information to the next available NTN RAN node. This context includes device identifiers, security parameters, and session data, which are sent via ultra-high bandwidth inter-satellite links (ISLs). The context information is segmented into blocks, each tagged with the corresponding target NTN RAN node identifier and sequence number to ensure ordered reassembly at the next node. The transmission is carefully timed to align with the determined handover sub-periods, taking into account a predefined time offset to ensure timely delivery.

Following the transmission 1122 of context information, the system proceeds with the coordination of handovers by transmitting 1124 the identified handover sub-periods and the next NTN RAN node identifier to the active devices that are expected to participate in the group handover. This communication ensures that the devices are prepared to transition seamlessly to the next available node in the satellite constellation. In parallel, the figure also demonstrates how the system handles acknowledgment of the received context information, ensuring reliable delivery and retransmitting any unacknowledged segments prior to the start of the handover sub-period.

On the device side, the WTRU may perform a handover to the next available NTN RAN node. The WTRU first determines whether the current time coincides with the configured handover sub-period. If the signal power from the current NTN RAN node exceeds a minimum threshold, the device skips the handover and continues to be served by the current node. If the signal power drops below the threshold, the device searches for the synchronization signal block (SSB) of the next available NTN RAN node and, upon detection, transmits a combined uplink preamble and device identifier using the timing advance value from the first node. This preamble transmission may be carried out in a contention-based uplink resource, bypassing standard scheduling request procedures.

In cases where the synchronization between the first and second NTN RAN nodes is validated, the device retains the handover sub-period configurations, ensuring a smooth transition from one node to the other. However, if the synchronization discrepancy exceeds the allowable threshold, the system adjusts the configurations accordingly to ensure proper handover. The figure concludes with a representation of how the method reduces handover delay and signaling overhead by optimizing the transmission of device context information and handover coordination based on orbital synchronization and timing parameters.

A method performed by a Non-Terrestrial Network (NTN) Radio Access Network (RAN) node, comprising: receiving, via a backhaul interface from at least one of an NTN ground gateway or a terrestrial network (TN) RAN node, one or more handover training periods, each defined by a start time instant, an end time instant, and/or periodicity, during which standard NTN handover are activated; counting and storing a number of inter-NTN-RAN-node handover requests during each handover training period which are associated with one or more target NTN RAN nodes; determining one or more handover sub-periods within each handover training period, wherein each sub-period corresponds to a time interval with a largest number of handover requests associated with a single target NTN RAN node and is defined by a start time indication and an end time instant; transmitting device-group context information, including device identifiers, security parameters, and session data, to a next available NTN RAN node via ultra-high bandwidth inter-satellite links (ISLs), upon detecting a current time instant matching a start time instant of any determined handover sub-period minus a predefined time offset; transmitting the determined handover sub-periods and an identifier of the next available NTN RAN node to active devices associated with an expected group handover.

The backhaul configuration may imply one or more handover training periods are received periodically with a daily periodicity, and wherein each handover training period corresponds to a predefined number of orbital rotations of the NTN RAN node around Earth.

Device-group periodic handover may be deactivated during the handover training periods, wherein the standard NTN handover procedures are exclusively applied during said periods.

Counting the number of inter-NTN-RAN-node handover requests includes categorizing the requests based on a target NTN RAN node identifier, and storing the counts in a database indexed by the target identifier and associated handover training period.

Determining the one or more handover sub-periods includes aggregating handover requests associated with a common target NTN RAN node identifier, and defining each sub-period as a contiguous time interval with the highest density of overlapping requests to the same target node, based on real-time timestamps of the requests.

Handover requests may be clustered into sub-periods by grouping requests with timestamps within a predefined time window and a shared target NTN RAN node identifier, and selecting sub-periods where the cluster size exceeds a threshold count.

A start time indication and end time instant of a sub-period may be dynamically adjusted to align with or equal to the orbital trajectory overlaps between the NTN RAN node and the target NTN RAN node, as derived from the timestamps and target identifiers of the handover requests.

Device-group context information may be segmented into blocks, each block tagged with a target NTN RAN node identifier and a sequence number, and transmitted sequentially over the ultra-high bandwidth ISLs to ensure ordered reassembly at the next available NTN RAN node.

A predefined time offset may be dynamically adjusted to match the measured latency of the ultra-high bandwidth ISLs between the NTN RAN node and the next available NTN RAN node, to ensure timely delivery of the device-group context information.

An acknowledgment may be received from the next available NTN RAN node confirming successful receipt of the device-group context information, and retransmitting unacknowledged segments prior to the start time instant of the handover sub-period.

A method performed by a Wireless Transmit/Receive Unit (WTRU) in a Non-Terrestrial Network (NTN), comprising: determining whether a current time instant coincides with a configured handover sub-period received from a first NTN RAN node; skipping initiation of a timed handover to a second NTN RAN node if a received signal power from the first NTN RAN node exceeds a minimum coverage threshold during the configured handover sub-period; searching for a synchronization signal block (SSB) of a second NTN RAN node, identified as the next available NTN RAN node, if the received signal power from a first NTN RAN node violates the minimum coverage threshold; transmitting, upon detecting the second NTN RAN node, a combined uplink preamble and device identifier to the second NTN RAN node using a timing advance value previously associated with the first NTN RAN node; retaining handover sub-period configurations received from the first NTN RAN node while connected to the second NTN RAN node, if the first and second NTN RAN nodes are synchronized in orbital parameters.

A method may comprise determining whether the current time instant coincides with the configured handover sub-period includes synchronizing a local timer of the WTRU to a network-wide time reference derived from orbital synchronization signals and/or the synchronization signal blocks (SSB) broadcast by the first NTN RAN node.

Searching for the SSB of the second NTN RAN node includes prioritizing SSB detection in frequency bands preconfigured by the first NTN RAN node during the handover sub-period, the frequency bands corresponding to predicted orbital positions of the second NTN RAN node.

Transmitting the combined uplink preamble and device identifier towards a second NTN RAN node includes encrypting the device identifier using a session-specific key shared with the first NTN RAN node, and appending a checksum computed from the timing advance value to ensure integrity.

Validating synchronization between the first and second NTN RAN nodes by comparing orbital parameters embedded in their respective SSBs and retaining the handover sub-period configurations only if a synchronization discrepancy is below a predefined tolerance threshold.

The combined uplink preamble and device identifier are transmitted using a contention-based uplink resource allocated by the first NTN RAN node during the handover sub-period, bypassing standard scheduling request procedures.

The timing advance value is adjusted by a propagation delay offset that equals to the timing difference due to the various orbital altitudes between the first and second NTN RAN nodes, prior to transmitting the combined uplink preamble.

Timing advance value is validated against a maximum allowable timing advance based on an orbital velocity of the first NTN RAN node, and wherein an invalid timing advance triggers a recalibration request to the second NTN RAN node.

Initiating a fallback to standard NTN handover procedures if the WTRU fails to detect the SSB of the second NTN RAN node within a timeout period derived from the retained handover sub-period configurations.

### Pt013

Low Earth Orbit (LEO) satellite constellations are increasingly deployed to deliver ubiquitous cellular connectivity, particularly in remote or underserved regions. However, LEO satellites face stringent energy constraints due to their reliance on finite on-board battery systems coupled with intermittent solar charging opportunities. Unlike terrestrial base stations, which operate with stable grid power, LEO satellites must judiciously manage energy consumption to prolong operational lifespans and maintain service continuity.

An energy burden arises from the need for each satellite to continuously broadcast system information, such as System Information Block 1 (SIB1), to ensure idle-mode wireless devices (e.g., IoT sensors, smartphones) may discover and camp on the network. SIB1 contains essential parameters for cell access, including random access configurations, scheduling information, and mobility parameters, which are traditionally transmitted redundantly by every satellite in a coverage area. This redundancy creates significant energy inefficiencies, particularly in dense constellations where overlapping coverage areas force multiple satellites to broadcast identical signaling content.

In one exemplary embodiment, the primary Non-Terrestrial Network (NTN) Radio Access Network (RAN) node, operating within a Low Earth Orbit (LEO) satellite constellation, initiates a leadership negotiation protocol via Inter-Satellite Links (ISLs) with neighboring nodes. During this negotiation, the primary node exchanges authenticated battery capacity level reports, including cryptographic signatures and orbital trajectory data, to establish its role as the configuration authority. Upon selection of the primary NTN RAN node of the largest available battery capacity, the primary node aggregates energy-efficient system parameters—such as group-wide uplink power limits, handover trigger thresholds, and reference random access resource definitions—into common System Information Block 1 (SIB1) and Radio Resource Control (RRC) configurations.

These configurations are timestamped with a validity period tied to orbital rotation cycles and assigned a Configuration Change Count (CCC) for version tracking. The primary node embeds a 3-bit common SIB/RRC presence indicator within the Master Information Block (MIB), dynamically updating it based on battery status or configuration updates, and broadcasts the MIB alongside cryptographically signed common configurations via downlink channels and ISLs. To maintain energy-aware leadership, the primary node continuously monitors its battery capacity relative to neighboring nodes, triggering a renegotiation process via a hop-limited ISL flooding if its capacity drops below a predefined threshold or if a new satellite with superior energy reserves joins the constellation.

In an embodiment, a secondary NTN RAN node receives the primary node's declaration via ISLs, verifying the authenticity of the embedded cryptographic tags and orbital synchronization data before adopting the common SIB1/RRC configurations, which are shared over ISL interface in a hop limited fashion. The secondary node generates differential cell-specific system information by omitting parameters already defined in the primary node's broadcast and/or parameters that are real-time changed by the secondary RAN node, such as a changed per beam transmit power level, compared to the level indicated in the formerly transmitted common SIB sets by the primary cell. The secondary node appends a version compatibility hash to its differential SIB1, enabling Wireless Transmit/Receive Units (WTRUs) to validate parameter aggregation (e.g., to which stored SIB version the received differential SIB should be combined with). During sharing of common SIB configurations, the secondary node forwards the primary node's configurations via ISLs using a hop-count-limited flooding protocol, ensuring propagation within a predefined orbital segment (e.g., NTN RAN node grouping).

In an embodiment, a WTRU operating in the NTN detects the common SIB/RRC presence indication by decoding a reserved 3-bit field in the primary node's MIB. Upon identifying a new configuration version via the CCC value within the common SIB set, the WTRU decodes and stores the common SIB1/RRC parameters, initiating a validity timer synchronized to the primary node's orbital rotation count and/or preconfigured validity period. During cell reselection to a secondary node, the WTRU retains the stored configurations and combines them with the secondary node's differential SIB1, if detected, resolving parameter conflicts by prioritizing cell-specific values flagged as mandatory (i.e., to accommodates possible real-time updates of current RAN node in reference to stored common SIB configurations). The WTRU computes the secondary node's random-access occasion by applying the Cell ID-derived offset formula to the common reference resource, ensuring collision-free access attempts. If the validity timer expires or the WTRU detects a CCC mismatch during handover and/or cell reselection, it purges stale configurations, reacquires the updated MIB from the current primary node, and repeats the aggregation process. For energy-constrained operations, the WTRU skips redundant decoding of common configurations when the version identifier matches its cached copy, reducing processing overhead, implying that to be transmitted common SIB configuration set did not change from last version already received by the device.

Low Earth Orbit (LEO) satellites operate under stringent energy limitations due to finite on-board battery capacities and reliance on intermittent solar charging cycles, which are often disrupted during orbital eclipses. Unlike terrestrial base stations with stable grid power, LEO satellites must prioritize energy allocation between payload operations, propulsion, and communication subsystems. Among these, continuous broadcast of System Information Block 1 (SIB1) and Radio Resource Control (RRC) configurations constitutes a significant energy burden. SIB1, which includes cell access parameters, random access resource definitions, and mobility settings, must be transmitted at high periodicity to ensure idle-mode Wireless Transmit/Receive Units (WTRUs) may discover and camp on the network. However, the rapid orbital motion of LEO satellites-typically completing a full orbit in 90-120 minutes-forces frequent cell reselections and handovers for connected WTRUs, particularly in dense constellations with overlapping coverage areas. Each handover event triggers reconfiguration of RRC parameters and retransmission of updated SIB1 data to maintain service continuity, creating a multiplicative energy drain as thousands of devices simultaneously transition between satellites.

The inherent mobility of LEO satellites introduces unique challenges not present in terrestrial networks. As satellites traverse their orbits at velocities exceeding 7 km/s, their coverage cells sweep across the Earth's surface, necessitating near-constant handovers for ground-based WTRUs. For example, a single satellite serving urban IoT devices may orchestrate tens of thousands of handovers per orbital pass, each requiring RRC reconfiguration signaling and updated SIB1 delivery to ensure seamless connectivity. Traditional terrestrial network designs, which assume quasi-static cell boundaries, exacerbate energy inefficiencies in this context by mandating redundant SIB1 broadcasts from every satellite in a coverage zone. This redundancy forces multiple satellites to transmit identical system information parameters—such as uplink power limits or scheduling periodicity—even though WTRUs require only a single instance of this data. The cumulative energy cost of these transmissions grows exponentially in large constellations, where overlapping satellite footprints create contention regions with simultaneous SIB1 broadcasts from multiple nodes. Furthermore, the short visibility windows of LEO satellites (often 5-10 minutes per pass) compress the time available for signaling exchanges, requiring higher transmission power to maintain link budgets during brief contact periods, further depleting onboard energy reserves.

The energy expended on redundant SIB1/RRC broadcasts directly impacts the operational lifespan of LEO satellites. For instance, a satellite allocating 30% of its transmit power to persistent SIB1 delivery may exhaust its battery reserves weeks earlier than a system employing coordinated signaling strategies, necessitating costly early decommissioning or reduced service reliability during eclipse phases. This problem intensifies in polar or sun-synchronous orbits, where satellites experience prolonged eclipses with no solar recharge opportunities, leaving battery reserves as the sole power source. During these periods, unoptimized SIB1/RRC transmissions may force important subsystems—such as attitude control or thermal management—into low-power modes, risking orbital drift or hardware failures. Without hierarchical signaling architectures that offload common parameters to designated energy-rich nodes, LEO constellations face unsustainable energy consumption patterns, undermining their viability as scalable cellular connectivity platforms.

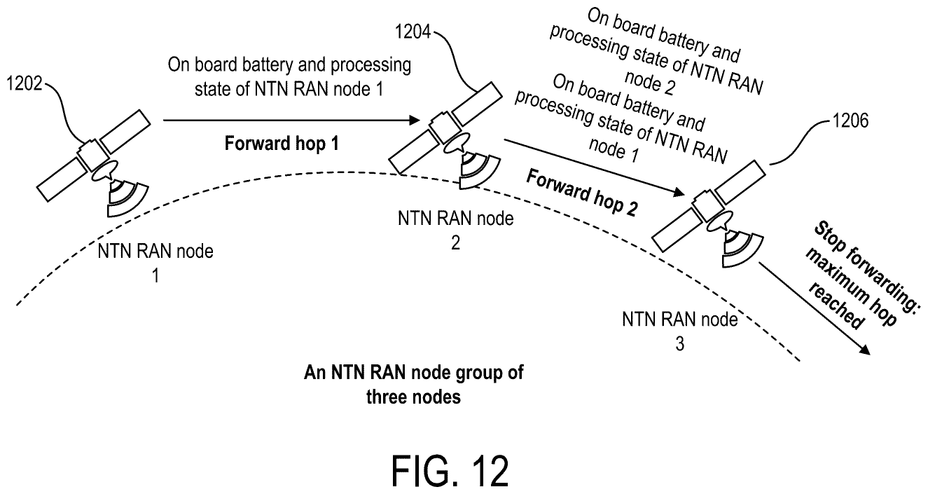

FIG. 12 shows first 1202, second 1204 and third 1206 NTN RAN nodes in a Low Earth Orbit (LEO) satellite constellation forming a Non-Terrestrial Network (NTN) Radio Access Network (RAN). Neighboring NTN RAN nodes dynamically negotiate the selection of a primary node through authenticated Inter-Satellite Links (ISLs). This negotiation protocol involves the exchange of real-time on-board battery capacity level indications, alongside standard cryptographic authentication tokens and orbital trajectory data, to establish a hierarchical leadership structure. Each satellite computes its available energy reserves, factoring in solar charging forecasts and projected payload demands, and broadcasts this information via ISLs using a low-latency flooding protocol constrained by a maximum preconfigured hop count. The node with the highest validated battery capacity, adjusted for anticipated energy consumption during its orbital trajectory, is designated as the primary NTN RAN node. This role entails responsibility for compiling and disseminating network-wide system configurations, ensuring energy-efficient coordination across the constellation.

Specifically, in the example, first NTN RAN node 1202 provides its on board battery and processing state to NTN RAN node 2. NTN RAN node 2 forwards information received from NTN RAN node 1 and its own on board battery and processing state to NTN RAN node 3. NTN RAN Node 3 does not forward such information due to a maximum hop reached.

The selection of a primary node within the NTN RAN constellation may adopt dynamic criteria beyond battery capacity, tailored to operational priorities or network conditions. For instance, in scenarios requiring high computational throughput, such as real-time edge processing of Earth observation data, the primary node may be selected based on available CPU/GPU resources. Satellites may broadcast their current computational load metrics, including idle processing cores, memory availability, or queued task volumes, alongside authenticated orbital trajectory data. The node with the highest validated computational capacity, adjusted for anticipated mission-specific workloads (e.g., AI inference tasks or sensor data fusion), is prioritized to ensure latency-critical operations are hosted on the most capable platform. Alternatively, ground control stations may directly configure primary node assignments via over-the-air updates, embedding priority flags or weighted scores into command signals to enforce hierarchical roles aligned with mission objectives, such as prioritizing satellites with direct visibility to high-demand geographic regions.

In an option, primary node selection may incorporate average device load metrics, such as the number of active user equipment (UE) connections, data throughput demands, or beam management complexity. Satellites periodically exchange load indicators via ISLs, enabling the constellation to dynamically nominate nodes with underutilized resources as primary coordinators during traffic spikes. For example, a satellite experiencing low UE traffic relative to its capacity may be assigned primary status to offload tasks from overloaded peers, optimizing resource distribution. These criteria may be combined with battery or computational metrics through weighted scoring algorithms, where the RAN or ground operators define adjustable coefficients to emphasize energy efficiency, computational power, or load balancing based on real-time network demands. The negotiation protocol remains authenticated and constrained by preconfigured hop counts, ensuring rapid convergence while maintaining security and scalability across the distributed NTN architecture.

The exchange of battery capacity levels occurs at predefined intervals synchronized with orbital positioning updates derived from onboard Global Navigation Satellite System (GNSS) receivers. These intervals are calibrated to coincide with important orbital milestones, such as entry into sunlit phases for solar recharge or passage over high-traffic terrestrial regions, ensuring alignment with dynamic network load conditions. For instance, satellites may transmit battery status updates every 30 seconds during peak connectivity windows or ahead of scheduled handover zones. Additionally, a reactive triggering mechanism is implemented where any node detecting a battery capacity drop below a predefined threshold—e.g., 20% of total capacity—initiates an unscheduled exchange via ISLs. This threshold accounts for remaining mission duration, eclipse phases, and redundancy requirements for fail-safe operations, ensuring proactive leadership reevaluation before energy scarcity impacts network stability.

To prevent spoofing and ensure integrity, battery capacity indications are encapsulated within cryptographically signed messages, incorporating standard timestamped nonces and orbital ephemeris data. The synchronization of periodic exchanges with orbital positioning updates enables topology-aware resource allocation, as satellites adjust their transmission power and beamforming parameters based on relative motion and proximity. For example, during polar orbit phases where satellite spacing contracts, the interval between exchanges may shorten to accommodate rapid topology shifts. The primary node declaration includes a validity period tied to its orbital position, ensuring seamless leadership transitions as satellites traverse coverage gaps or enter energy-intensive maneuvers, such as collision avoidance thruster firings.

When a primary node's battery capacity falls below the threshold, it broadcasts an emergency status update via ISLs, triggering an immediate re-negotiation cycle. Accordingly, receiving nodes submit and exchange updated battery metrics and compute a new primary node using a consensus algorithm prioritizing energy reserves, trajectory stability, and remaining service time. This process ensures uninterrupted network operations while distributing energy consumption equitably across the constellation, thereby extending the operational lifespan of individual satellites and maintaining robust cellular connectivity for ground-based devices.

The negotiated primary node leverages its energy advantage to assume high-power tasks, such as broadcasting System Information Blocks (SIBs), while secondary nodes conserve energy by transmitting only differential parameters on an on-demand basis.

The primary Non-Terrestrial Network (NTN) Radio Access Network (RAN) node declaration, propagated via Inter-Satellite Links (ISLs), incorporates a timestamped validity period defining the duration of its leadership role. This validity period may be algorithmically derived from the primary node's orbital trajectory, accounting for its remaining visibility window over high-demand terrestrial regions and projected battery consumption rates or based on a preconfigured validity configuration. For instance, a primary node in a sunlit orbit may declare a 15-minute validity period, synchronized with its anticipated exit from a coverage zone, ensuring leadership transitions align with operational continuity requirements. Embedded within the declaration are cryptographic authentication tokens, such as hash-based message authentication codes (HMACs) generated using shared constellation keys, to prevent spoofing or malicious node impersonation. The declaration further includes precise orbital trajectory data—including Keplerian elements and ephemeris updates—enabling neighboring nodes to synchronize their onboard clocks, beam steering angles, and handover schedules with the primary node's motion. This synchronization ensures coherent system information broadcasts, reducing timing conflicts during overlapping coverage phases.

High-demand terrestrial regions may be determined through a combination of preconfigured geospatial data, real-time user equipment (UE) connectivity metrics, and dynamic input from ground-based network operations centers (NOCs). Prior to deployment, satellites are preloaded with geofenced maps identifying regions with historically high traffic, such as urban centers, transportation hubs, or critical infrastructure zones (e.g., ports, industrial sites). These maps are periodically updated via over-the-air commands from ground stations to reflect evolving demand patterns, such as scheduled large-scale events (e.g., sports events, emergency response zones). During operations, satellites autonomously detect real-time demand spikes, such as UE density measurements, uplink request rates, or data throughput thresholds within specific beam coverage areas. For example, a sudden surge in connected UEs or latency-sensitive traffic (e.g., emergency communications during disasters) triggers the classification of the underlying geographic area as high-demand.

The primary NTN RAN node role is dynamically reassigned when the incumbent's battery capacity drops below a predefined threshold relative to neighboring nodes, such as falling into the lowest 10th percentile of available energy reserves within the constellation. This threshold is continuously recalculated based on real-time battery status reports exchanged via ISLs, factoring in variables like solar charging forecasts and pending payload tasks. Additionally, when a new LEO NTN RAN node joins the constellation—for example, after deployment from a launch vehicle or recovery from a standby state—it broadcasts its battery capacity level during an initial network entry handshake. If the new node's capacity exceeds the current primary's level by a configured margin (e.g., 15%), the constellation initiates an immediate re-negotiation cycle. This process employs a consensus algorithm where nodes submit digitally signed battery reports, orbital stability metrics, and mission-critical task lists, enabling a merit-based selection of the new primary node.

Scenarios exist where a satellite may withhold or suppress its battery status report to preserve network integrity or comply with operational protocols. For instance, if a satellite enters a safe mode due to critical system faults (e.g., radiation-induced hardware errors or thermal overloads), it may suspend participation in primary node negotiations and suppress battery reports until recovery is confirmed. Similarly, satellites undergoing ground-commanded maintenance or firmware updates may temporarily halt status broadcasts to avoid destabilizing the consensus algorithm with transient or unverified data.

To secure the primary node declaration, cryptographic authentication data is generated using a layered approach: a) a constellation-wide root key signs the declaring node's public certificate, b) a node-specific private key signs the declaration payload, and c) a one-time nonce derived from orbital position hashes prevents replay attacks. Secondary nodes validate these signatures through a distributed certificate authority hosted across geographically dispersed ground stations, ensuring compromised satellites cannot forge leadership claims. Additionally, the orbital trajectory information is encoded using error-correcting codes resilient to ISL signal degradation, guaranteeing reliable decoding even during high Doppler shift conditions inherent to LEO mobility.

Furthermore, the primary Non-Terrestrial Network (NTN) Radio Access Network (RAN) node disseminates its leadership declaration across the Low Earth Orbit (LEO) satellite constellation using a hop-limited flooding protocol over Inter-Satellite Links (ISLs). Upon generating the authenticated declaration payload—containing timestamped validity, cryptographic signatures, and orbital trajectory data—the primary node embeds a hop-count field initialized to zero and transmits the message to all adjacent satellites within ISL range. Each receiving node increments the hop-count value, validates the cryptographic authenticity of the declaration, and rebroadcasts it to its own neighbors, provided the hop count remains below a predefined maximum threshold (e.g., three hops). This constraint ensures bounded propagation latency and prevents network congestion caused by infinite message looping, particularly in densely populated orbital shells where satellites maintain multiple ISL connections.

The hop-count field is embedded within a dedicated section of the Inter-Satellite Link (ISL) message header, adjacent to routing and protocol control metadata such as message type and priority flags. This placement allows intermediate nodes to rapidly access and process the hop-count value without decrypting or parsing the full payload, minimizing latency and computational overhead. The leadership declaration payload—including cryptographic signatures, timestamped validity periods, and orbital trajectory data—resides in the authenticated message body. Segregating the hop-count in the header ensures efficient flood control while preserving the integrity and confidentiality of the payload through encryption.

Furthermore, neighbor discovery in the NTN RAN constellation is achieved through dynamic beacon transmissions over the Inter-Satellite Link (ISL) interface, analogous to sidelink discovery signaling procedures in terrestrial networks, but augmented with orbital-aware optimizations. Each satellite periodically broadcasts NTN RAN beacon messages containing its unique identifier, ephemeris-derived positional data (e.g., Keplerian elements, timestamped coordinates), and ISL capability parameters (e.g., supported frequency bands, modulation schemes). These beacons are transmitted at configurable intervals (e.g., every 5-10 seconds) to account for rapid orbital motion and dynamically changing line-of-sight conditions.

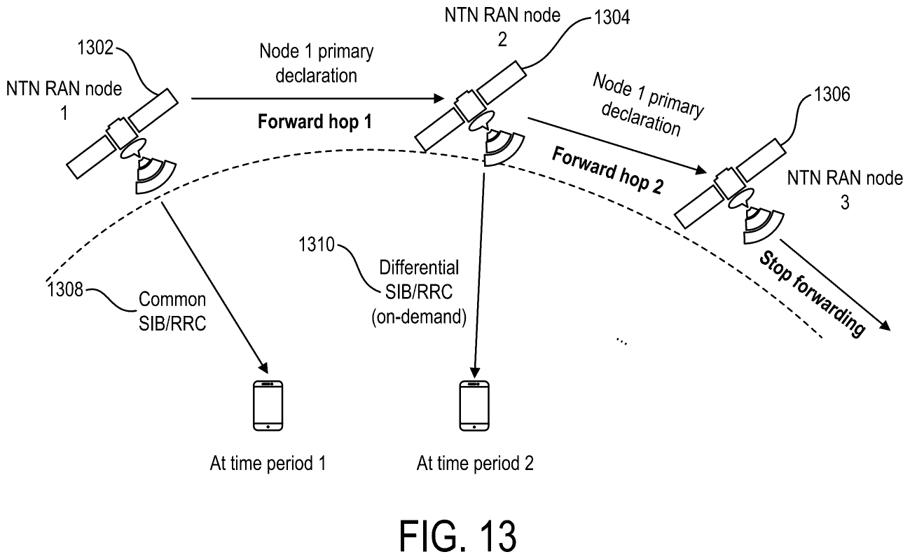

Accordingly, as depicted by FIG. 13, the determined primary Non-Terrestrial Network (NTN) Radio Access Network (RAN) node, e.g. NTN RAN node 1 1302 aggregates network-wide parameters into unified System Information Block 1 (SIB1) and Radio Resource Control (RRC) configurations 1308, harmonizing settings across all Low Earth Orbit (LEO) satellites in the constellation. This compilation process involves parameters such as group-wide uplink power ceilings, synchronized handover trigger thresholds (e.g., hysteresis time of 5 dB and offset of 2 dB), and standardized random-access channel (RACH) resource definitions. The primary node dynamically adjusts configurations based on real-time constellation telemetry—for instance, extending SIB1 periodicity during eclipse phases to conserve energy or tightening beam-specific scheduling parameters in high-traffic zones. A Configuration Change Count (CCC) is embedded within the compiled configurations as per US Patent Publication no. 20130176897 to Lei Wang et al. disclosed by reference herein in its entirety, incrementing with each update to enable version tracking. The configurations are timestamped with a validity period tied to orbital cycles (e.g., two full orbits) and encrypted using a constellation-shared symmetric key, ensuring tamper-proof dissemination.

Pursuant to Wang, a configuration instance may be identified by its version number, also referred to as a Configuration Change Count (CCC), or a Configuration Sequence Number (CSN). The CCC may be an integer variable whose value may change every time a configuration instance changes. The CCC may be changed based on a pre-defined function. One example may be that the CCC increments by 1 every time a configuration instance changes and wraps around to 0 once reaching its maximum value.

A configuration may be defined per satellite, per satellite group, per primary/secondary satellite, etc. An CCC may be used to identify an instance of a satellite configuration. Accordingly, a combination of satellite ID, configuration (e.g. type of satellite e.g. LEO/GEO), and/or CCC, for example, may be used to identify a configuration instance of the given group of devices, where the configuration type may indicate a specific configuration among the multiple configurations that may be defined and used, for example, configuration, network configuration, etc. An integer variable may be used to identify the version number of a configuration instance. Each one of the disclosed embodiments of Wang (reproduced herein by reference in its entirety) may be used herein to perform fast connection or other methods based on the CCC.

Specifically, the primary NTN RAN node encodes a 3-bit common SIB/RRC presence indication within reserved fields of the Master Information Block (MIB), signaling to NTN-capable Wireless Transmit/Receive Units (WTRUs) that unified configurations are available for aggregation. The compiled SIB1/RRC configurations are broadcasted via a multi-layered downlink strategy: 1) a high-power, wide-beam broadcast channel delivers the configurations to idle-mode WTRUs across expansive coverage areas, and 2) narrow-beam transmissions target active-mode devices with low-latency updates. To optimize energy use, the primary node employs time-division multiplexing, aligning broadcasts with solar charging phases and prioritizing parameters important for handover preparation (e.g., reference signal time difference offsets). Concurrently, the configurations are propagated to secondary NTN RAN nodes via Inter-Satellite Links (ISLs). In one alternative ISL signaling option, secondary nodes may receive, from a primary node, only SIB configuration changes from prior configurations (e.g., delta-encoded handover thresholds) to minimize ISL payload size, verified via hash comparisons against cached versions.

Furthermore, as shown by FIG. 13, secondary NTN RAN nodes, e.g. RAN Node 2 1304 and/or RAN Node 3 1306, strip redundant parameters from their cell-specific SIB1 broadcasts, retaining only localized settings such as node-specific Doppler pre-compensation values, thus, delivering solely differential SIB1 and RRC messages 1310, which are much smaller in size than the full-loaded SIB signaling, including those node-specific SIB and RRC changes to shared common SIB configurations. The secondary nodes embed a compatibility flag in their SIB1 headers, cross-referencing the primary's CCC version to enable WTRU-side validation. During handovers, secondary nodes append the primary's configurations to handover command messages, ensuring continuity without redundant broadcasts.

The primary node rebroadcasts the MIB and configurations upon CCC increments or validity period expiration, synchronizing updates with orbital positioning milestones (e.g., crossing the equator). WTRUs execute discarding stale versions when the validity timer expires or after, for instance, three orbital rotations as preconfigured. Secondary nodes monitor the primary's ISL periodic SIB/RRC update messages, purging outdated configurations if the CCC diverges beyond a tolerance threshold (e.g., two versions). This hierarchical signaling framework significantly reduces per-satellite energy consumption compared to independent SIB1 broadcasts, while maintaining seamless mobility support for ground devices.

The common SIB1/RRC configurations compiled by the primary NTN RAN node include a constellation-wide maximum uplink transmission power limit for all nodes within the group, ensuring energy efficiency and mitigating inter-satellite interference. This cap, dynamically adjusted based on real-time battery capacity reports and traffic load analytics, prevents individual satellites from exceeding sustainable power levels during high-demand phases, such as mMTC device bursts. For instance, a group limit of 40 dBm may be enforced during peak orbital passes over urban centers, while reduced to 35 dBm in eclipse phases to preserve energy. The configurations further standardize system information block (SIB) periodicity, synchronizing broadcast intervals across the constellation to 320 ms-a balance between idle-mode device discovery latency and energy conservation. Control channel detection parameters, including PDCCH aggregation levels and search space configurations, are harmonized to reduce WTRU processing overhead, enabling devices to decode important signaling with minimal retries, thereby shortening active reception windows and conserving device energy.

Handover trigger parameters within the common configurations define hysteresis time (e.g., 256 ms) and offset values (e.g., 3 dB) optimized for LEO mobility patterns, reducing ping-pong handovers caused by rapid signal fluctuation as satellites traverse their orbits.

Further, the common configurations enforce unified resource scheduling policies, including scheduler type (e.g., proportional fair), scheduling request periodicity (e.g., 20 ms), and code-block size (e.g., 256 QAM codeblocks limited to 8,192 bits), streamlining interference coordination across overlapping satellite coverage areas. Channel Quality Indicator (CQI) and Precoding Matrix Indicator (PMI) band configurations standardize feedback granularity, defining 4-bit CQI tables for SNR ranges of −5 dB to 30 dB and PMI codebooks supporting 2-layer MIMO across 10 MHz bands. These settings reduce signaling variance, enabling satellites to predictively allocate resources during high-Doppler handovers without renegotiating parameters.

The validity period for common configurations is defined as either an absolute timing duration (e.g., 30 minutes) or a count of LEO satellite rotations (e.g., 1.5 orbits), whichever occurs first. This dual-mode expiration ensures adaptability to both fixed mission timelines and dynamic orbital perturbations. The primary node computes validity using Keplerian orbital elements, aligning configuration updates with important trajectory milestones—such as apogee passage or inter-plane handover zones—to minimize service disruption. A Configuration Change Count (CCC) embedded in the MIB/common SIB increments with each update, enabling WTRUs and secondary nodes to discard stale configurations upon detecting version mismatches. Cryptographic hashes of the CCC and configuration payloads are distributed via ISLs, allowing secondary nodes to authenticate updates before adoption.

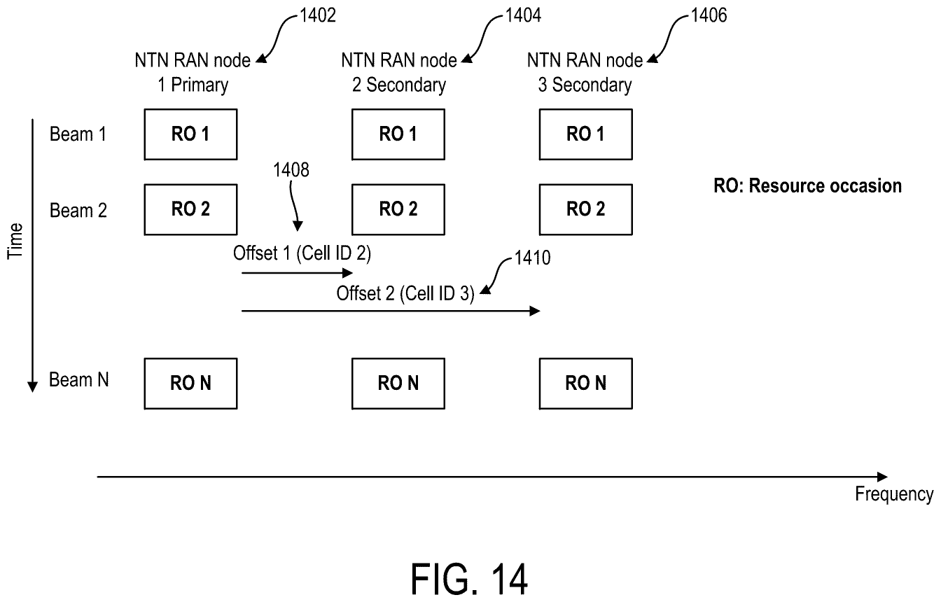

FIG. 14 shows common SIB configurations specifying reference random access (RA) resource occasions per beam, providing a baseline time-frequency grid (e.g., PRACH Configuration Index 16) from which secondary nodes derive cell-specific RA occasions via modular offsets. For example, a reference RA slot at frame number 5, subframe 2, and 1.08 MHz bandwidth is shared across the constellation, while secondary nodes apply (Cell ID % 8)×1 ms time offsets to prevent collision. Common transmission power control parameters, such as PO-Nominal values for PUSCH and PUCCH, ensure uniform uplink power ramping across beams, avoiding localized power races that could drain WTRU batteries or saturate satellite receivers.

NTN RAN node 1 1402 may schedule resource occasions (ROs) RO 1 to RO N on beams 1 to N. NTN RAN node 2 1404 may schedule its ROs having a first frequency offset 1408, e.g. RO 1 to RO N on beams 1 to N. NTN RAN node 3 1406 may schedule its ROs having a second frequency offset 1410, e.g. RO 1 to RO N on beams 1 to N. Resource occasions may be for random access or for other resource transmissions.

Specifically, the secondary Non-Terrestrial Network (NTN) Radio Access Network (RAN) node derives its cell-specific random access (RA) resource occasion by applying a deterministic offset to the reference timing and frequency resource set defined by the primary NTN RAN node in the common SIB1/RRC configurations. This offset is computed as a mathematical function of the secondary node's unique Cell ID, ensuring collision-free RA resource allocation across the Low Earth Orbit (LEO) constellation. As another example, if the primary node designates a reference RA slot at system frame number 1024, subframe 3, and 1.08 MHz bandwidth, the secondary node calculates its RA occasion by offsetting these coordinates using its Cell ID. The Cell ID, a globally unique identifier assigned during satellite commissioning, serves as an input to a hashing algorithm that distributes RA resources uniformly, avoiding overlaps even in dense orbital planes. This method eliminates redundant signaling of full RA parameters, as devices infer the secondary node's RA configuration using the Cell ID and the primary node's reference.

The predefined offset for RA resources is calculated using modular arithmetic, where the time or frequency offset is proportional to the remainder of the Cell ID divided by a predefined integer N, corresponding to the total available RA resource occasions in the network. For example, with N=64, RA occasions and a Cell ID of 189, the remainder 189% 64=61 dictates the offset index. This index is scaled by a factor K, defined in the common configurations (e.g., K=1 ms for time or K=15 kHz for frequency), yielding a final offset of 61×1 ms=61 ms in the time domain. The integer N is dynamically configured by the primary node based on orbital density and RA load forecasts, ensuring optimal resource utilization—e.g., increasing N to 128 during peak mMTC device activation phases. Modular arithmetic guarantees automatic load distribution, as new nodes joining the constellation inherently receive unique offsets without centralized coordination, important in high-mobility LEO environments.

The modular approach inherently prevents RA preamble collisions, as each secondary node's RA occasion is uniquely determined by its Cell ID within the bounds of N. During handovers, WTRUs precompute the target cell's RA occasion using the advertised Cell ID, enabling seamless transitions without additional signaling. If orbital maneuvers alter inter-satellite distances, the primary node adjusts K to compensate for Doppler-induced timing variances—e.g., scaling K from 1 ms to 1.2 ms during high-velocity equatorial passes. This dynamic adjustment, broadcast in the common SIB1, ensures RA resources remain orthogonal despite LEO-specific channel dynamics.

Secondary Non-Terrestrial Network (NTN) Radio Access Network (RAN) nodes determine parameters to omit from cell-specific System Information Block 1 (SIB1) and Radio Resource Control (RRC) configurations by cross-referencing a predefined exclusion list provided by the primary NTN RAN node with a cryptographic hash of the common SIB1/RRC configurations. The exclusion list, embedded within the common configurations, enumerates parameters standardized across the constellation—such as group-wide uplink power limits, handover hysteresis values, and reference random access resource definitions—that secondary nodes should safely exclude from their broadcasts. Upon receiving the common configurations via Inter-Satellite Links (ISLs), the secondary node parses the exclusion list, stripping redundant parameters from its cell-specific SIB1/RRC information. For example, if the common configurations define a maximum uplink power of 40 dBm, the secondary node omits this parameter from its SIB1, retaining only cell-unique settings like beam-specific Doppler pre-compensation coefficients.

The differential broadcasting mechanism ensures that secondary nodes transmit only parameters absent and/or different from the primary node's common configurations, such as beam-specific tracking area codes. To enforce consistency, the exclusion list categorizes parameters into mandatory and optional exclusions. Mandatory exclusions, such as system information periodicity or control channel aggregation levels, are universally removed, while optional exclusions—like CQI reporting intervals—are omitted only if the secondary node's local traffic load falls below thresholds defined in the common configurations.

By broadcasting only differential parameters, secondary nodes reduce SIB1 payload sizes by 60-75%, as measured in simulated LEO networks with 50 satellites. For example, a cell-specific SIB1 that originally required 200 bits for full parameterization is trimmed to 50 bits after applying exclusions, enabling energy-efficient narrow-beam transmissions. Wireless Transmit/Receive Units (WTRUs) aggregate the common and cell-specific parameters using a merge protocol that prioritizes the most recent version identifier, resolving duplicates through a “last write wins” rule. This hierarchical approach eliminates redundant decoding cycles at WTRUs, shortening idle-mode camping procedures by 40% and reducing device energy consumption.

If hash validation fails due to ISL packet corruption or malicious tampering, secondary nodes default to broadcasting full SIB1/RRC configurations for a limited duration, flagged with an integrity error indicator in the Master Information Block (MIB).

A Wireless Transmit/Receive Unit (WTRU) operating in a Non-Terrestrial Network (NTN) scans for Master Information Block (MIB) transmissions from Low Earth Orbit (LEO) satellite Radio Access Network (RAN) nodes, utilizing Doppler pre-compensation algorithms to mitigate frequency shifts caused by satellite mobility. Upon detecting a valid MIB, the WTRU extracts a 1-bit common SIB/RRC presence indication field, mapped to a predefined lookup table stored in the WTRU's memory. This table correlates presence indication values to configuration states—e.g., “001” denotes active common SIB1/RRC availability with version 3 compatibility. The WTRU initiates a common configuration acquisition protocol, tuning its receiver to the primary NTN RAN node's broadcast channel while compensating for propagation delays via timing advance values preconfigured for NTN operations.

The WTRU decodes the common SIB1 and RRC configurations broadcasted by the primary NTN RAN node. These configurations, including parameters such as constellation-wide uplink power limits and reference random access resource definitions, are stored in a non-volatile cache partitioned by a Configuration Change Count (CCC) identifier. The cache employs a least-recently-used (LRU) eviction policy, retaining configurations for up to a predefined number of orbital rotation cycles or until the broadcasted validity timer expires, whichever occurs first. The WTRU cross-references the CCC value in the MIB with its cached versions, bypassing redundant decoding if a match is detected.

During handover or cell reselection to a secondary NTN RAN node, the WTRU retains the cached common SIB1/RRC configurations while concurrently decoding the secondary node's differential SIB1. This dual-configuration state is maintained in a layered parameter database, where common configurations form a base layer and cell-specific parameters are overlaid as delta updates. The WTRU resolves conflicts using a priority hierarchy: cell-specific values flagged as “mandatory” in the secondary node's SIB1 override common parameters, while non-critical parameters (e.g., CQI reporting intervals) retain common values unless explicitly redefined.

The common SIB/RRC presence indication within the Master Information Block (MIB) includes a version identifier—e.g., a 3-bit field mapped to a Configuration Change Count (CCC) maintained by the primary NTN RAN node. This identifier enables the Wireless Transmit/Receive Unit (WTRU) to perform rapid version compatibility checks without decoding the full common configurations. Upon receiving the MIB, the WTRU extracts the version identifier and cross-references it against a cached version table stored in non-volatile memory. If the identifier matches an entry in the table (e.g., version “001” corresponding to CCC=1), the WTRU bypasses the energy-intensive decoding process, directly accessing the pre-stored common SIB1/RRC configurations linked to that version. This mechanism reduces processing latency by 40-60 ms per MIB acquisition cycle, important for latency-sensitive applications in LEO networks.

The secondary Non-Terrestrial Network (NTN) Radio Access Network (RAN) node computes its cell-specific random access (RA) occasion by applying a deterministic offset to the reference RA resource occasion defined in the primary node's common SIB1/RRC configurations. This offset is algorithmically derived from the secondary node's unique Cell ID, ensuring collision-free RA resource allocation across the Low Earth Orbit (LEO) constellation. For instance, if the primary node designates a reference RA slot at system frame number 2048, subframe 5, and carrier frequency 2.1 GHZ, the secondary node calculates its RA occasion by offsetting these coordinates using its Cell ID. The derivation employs modular arithmetic, where the offset in time or frequency domains is proportional to the remainder of the Cell ID divided by a predefined integer N, corresponding to the total number of RA resource occasions available in the network. The result is scaled by a factor K, broadcast in the common configurations, to align with NTN-specific timing and frequency granularity requirements.

When aggregating stored common SIB1/RRC configurations with cell-specific SIB1 information, the Wireless Transmit/Receive Unit (WTRU) resolves parameter conflicts by selectively overriding common parameters only when cell-specific values are explicitly flagged as mandatory in the secondary NTN RAN node's SIB1. Mandatory flags, encoded as a 1-bit field in the cell-specific SIB1 header, indicate parameters important for immediate cell access or mobility-such as beam-specific Doppler pre-compensation coefficients or time-sensitive handover thresholds. For example, if the common configurations define a handover hysteresis of 5 dB, but the secondary node's SIB1 specifies 8 dB with a mandatory flag, the WTRU prioritizes the cell-specific value. Non-mandatory parameters (e.g., CQI reporting intervals) retain common values unless explicitly redefined, minimizing reconfiguration overhead.

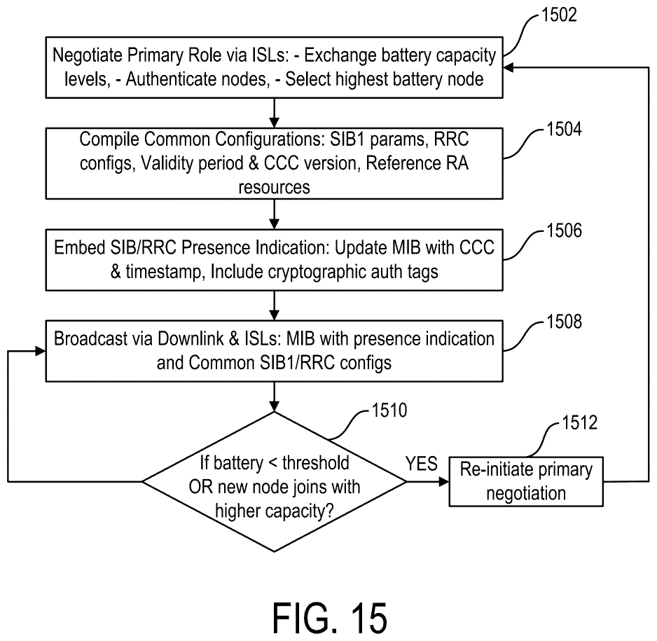

FIG. 15 depicts the overall RAN node action timeline, where the Primary RAN Node initiates its role by engaging in a leadership negotiation 1502 protocol with neighboring satellites via ISLs. During this phase, authenticated battery capacity reports and orbital trajectory data are exchanged, with the node exhibiting the highest validated energy reserves designated as the configuration authority. Once selected, the primary node compiles network-wide parameters 1504—such as uplink power limits, handover thresholds, and reference random access (RA) resources—into unified System Information Block 1 (SIB1) and Radio Resource Control (RRC) configurations 1506. These configurations are timestamped with a validity period tied to orbital cycles (e.g., two complete orbits) and secured using cryptographic hashes. The primary node embeds a 3-bit common SIB/RRC presence indication and a version identifier into the Master Information Block (MIB), broadcasting 1508 it alongside the configurations via high-power, wide-coverage beams. Continuous monitoring 1510 of its battery level triggers leadership renegotiation 1512 if reserves drop below a predefined threshold or if a new satellite joins the constellation with superior energy capacity.

Secondary RAN Nodes adopt the common configurations propagated by the primary node via ISLs, first verifying their integrity through cryptographic hash validation. Upon authentication, secondary nodes generate differential SIB1/RRC information by stripping redundant parameters (e.g., group-wide uplink power limits) and appending cell-specific settings. These include RA occasion offsets derived from their unique Cell IDs using modular arithmetic: Offset=(Cell ID % N)×K, where N represents the total RA resources and K is a scaling factor defined in the common configurations. For example, a Cell ID of 189 yields an offset of 61 ms when N=64 and K=1 ms. Secondary nodes broadcast these minimized SIB1 parameters via narrow beams and participate in hop-limited ISL flooding, forwarding the primary node's declaration to adjacent satellites until a maximum hop count (e.g., three hops) is reached.

Finally, WTRUs detect the primary node's MIB, decoding the embedded presence indication to determine whether common SIB1/RRC configurations are available. If the version identifier matches a cached entry, the WTRU skips redundant decoding, conserving energy. During handovers to secondary nodes, the WTRU retains the stored common configurations and merges them with cell-specific SIB1 information, resolving conflicts by prioritizing parameters flagged as mandatory (e.g., beam-specific Doppler compensation values). The unified RA occasion is computed by summing the reference RA slot from the common configurations with the Cell ID-derived offset, modulo the total RA resources (N). For instance, a reference RA slot at frame 1024 and an offset of 61 ms results in a final RA occasion of 1085 ms modulo 64=21. The WTRU monitors a validity timer synchronized to orbital cycles, purging expired configurations and reacquiring updates from the primary node when necessary.

A method implemented by a Non-Terrestrial Network (NTN) Radio Access Network (RAN) node operating in a Low Earth Orbit (LEO) satellite constellation, the method comprising: Negotiating, via Inter-Satellite Links (ISLs), a primary NTN RAN node selection among neighboring LEO NTN RAN nodes, and exchanging available on-board battery capacity level indications; Compiling, at the primary NTN RAN node, common system information blocks (SIB1) and Radio Resource Control (RRC) configurations shared across all LEO NTN RAN nodes in the constellation; Embedding, at the primary NTN RAN node, a common SIB/RRC presence indication within a Master Information Block (MIB) broadcasted to NTN-capable Wireless Transmit/Receive Units (WTRUs); Broadcasting the compiled common SIB1/RRC configurations from the primary NTN RAN node to idle and active mode WTRUs nodes via downlink broadcast channel and to secondary NTN RAN nodes over ISLs; Secondary NTN RAN nodes broadcasting differential, cell-specific SIB1 and RRC information by omitting parameters already defined in the common SIB1/RRC configurations received from the primary NTN RAN node.

The exchanging of available on-board battery capacity level indications is performed periodically at predefined intervals synchronized with orbital positioning updates or triggered by a detected drop in battery capacity below a threshold level at any neighboring LEO NTN RAN node.

The primary node declaration transmitted via ISLs includes a timestamped validity period for the primary node role, cryptographic authentication data to prevent spoofing, and orbital trajectory information of the declaring primary NTN RAN node for synchronization with neighboring nodes.

Re-initiating the negotiation of the primary NTN RAN node selection may occur when the battery capacity level of the current primary NTN RAN node drops below a predefined threshold relative to neighboring nodes or when a new LEO NTN RAN node joins the constellation network with a higher battery capacity level.

The primary node declaration is propagated across the constellation network via a hop-limited flooding protocol over ISLs, wherein each LEO NTN RAN node forwards the declaration to adjacent nodes until a maximum hop count is reached.

The common SIB1/RRC configurations include: NTN RAN node-group maximum uplink transmission power, system information block periodicity and control channel detection parameters, handover trigger configurations comprising hysteresis time and offset values, reference random access resource information per beam, common transmission power control parameters, resource scheduling information including scheduler type indication, periodicity, and code-block size configurations, Channel Quality Indicator (CQI) and Precoding Matrix Indicator (PMI) band configurations, and a validity configuration for the common SIB1/RRC configurations defined by a timing period or number of LEO satellite rotations.

The reference random access resource occasion for the secondary NTN RAN node is derived by applying a predefined offset to the reference timing and frequency resource set of the primary NTN RAN node, wherein the offset is computed as a function of the Cell ID of the secondary NTN RAN node.

The predefined offset is calculated using modular arithmetic on the Cell ID, such that the offset in time or frequency domains is proportional to the remainder of the Cell ID divided by a predefined integer value corresponding to the total number of available random access resource occasions.

The common SIB/RRC presence indication is updated dynamically by the primary NTN RAN node based on a validity period of the common SIB1/RRC configurations, and wherein the MIB is rebroadcast with the updated presence indication upon expiration of the validity period or changes to the common configurations.

The broadcasting of the compiled common SIB1/RRC configurations to secondary NTN RAN nodes over Inter-Satellite Links (ISLs) includes appending cryptographic authentication tags to the configurations, enabling secondary nodes to verify integrity and origin of the common configurations prior to adoption.

The secondary NTN RAN nodes may determine parameters to omit from the cell-specific SIB1/RRC information by comparing a predefined parameter list provided by the primary NTN RAN node with a hash of the common SIB1/RRC configurations, ensuring exclusion of redundant parameters.

The primary NTN RAN node maintains a Configuration Change Count (CCC) for the compiled common SIB1 and RRC configurations, and includes the CCC as part of the common SIB/RRC presence indication within the Master Information Block (MIB) to facilitate version control among WTRUs and secondary NTN RAN nodes.

A method implemented by a Wireless Transmit/Receive Unit (WTRU) for operating in a Non-Terrestrial Network (NTN) comprising Low Earth Orbit (LEO) satellite RAN nodes, the method comprising: detecting, via a Master Information Block (MIB) received from a primary NTN RAN node, a common SIB/RRC presence indication; Decoding and storing common SIB1 and RRC configurations broadcasted by the primary NTN RAN node; Retaining the stored common SIB1/RRC configurations during handover or cell reselection to a secondary NTN RAN node; Receiving, from the secondary NTN RAN node, cell-specific SIB1 information comprising light cell-specific signaling parameters; Determining a cell-specific random access occasion for the secondary NTN RAN node by applying a predefined offset to the reference random access resource occasion, wherein the offset is derived from a Cell ID of the secondary NTN RAN node; Aggregating the stored common SIB1/RRC configurations with the cell-specific SIB1 information to derive combined connection parameters for session establishment or handover operations; Deactivating the common SIB1/RRC configurations upon expiration of the validity timing or after exceeding a predefined number of LEO satellite rotations, wherein deactivation triggers acquisition of updated configurations from a subsequent primary NTN RAN node.

Detecting the common SIB/RRC presence indication includes decoding a reserved bitfield in the MIB, wherein the bitfield is mapped to a predefined value in a WTRU-stored lookup table to determine whether the primary NTN RAN node supports common SIB1/RRC configurations.

The common SIB/RRC presence indication in the MIB includes a version identifier, and wherein the WTRU skips decoding and storing the common configurations if the version identifier matches a previously stored version.

The predefined offset applied to the reference random access resource occasion is calculated using modular arithmetic on the Cell ID, such that the offset in time or frequency domains equals (Cell ID % N) xK, where N is a total number of resource occasions and K is a scaling factor defined in the common SIB1/RRC configurations.

Aggregating the stored common SIB1/RRC configurations with the cell-specific SIB1 information includes resolving parameter conflicts by overriding common parameters with cell-specific values only when the cell-specific parameters are flagged as mandatory in the secondary NTN RAN node's SIB1 information.

The aggregation further includes cross-referencing a version identifier in the cell-specific SIB1 information with the stored common SIB1/RRC configurations to ensure compatibility, discarding mismatched parameters and retaining only validated combinations for session establishment.

The aggregating the configurations includes generating a unified random-access occasion by summing the reference random access resource occasion from the common configurations with the Cell ID-derived offset, modulo a total number of resource occasions defined in the common SIB1/RRC configurations.

The present disclosure: Introduces a mechanism for negotiating and selecting a primary NTN RAN node among LEO satellite nodes based on battery capacity levels and orbital positioning updates.

The present disclosure: Introduces a predefined offset mechanism for determining random access occasions based on the Cell ID of the secondary NTN RAN node, ensuring synchronized handover and access. Random access resource configurations are the overhead-largest within any SIB signaling, e.g., if an NTN RAN node has 1028 beams, this configuration includes 1028 resource set information each associated with each available beam. Here, the resource set information received by the WTRU from a primary NTN RAN node, it can on its own without further explicit signaling, determine resource set information of the secondary/slave NTN RAN node, by executing an offsetting scheme, depending on the cell ID of each secondary ID, which may be unique.

The present disclosure: Provides a hierarchical SIB1/RRC management structure, where a primary NTN RAN node compiles and broadcasts common SIB1/RRC configurations to both WTRUs and secondary NTN RAN nodes. This step (1) sharing it with devices over device makes sense to allow devices to move between cells without needing this SIB large overhead, and (2) sharing it with neighbouring secondary NTN LEOs is for the latter to possibly transmit differential SIB if they do not support any of the formerly common parameters anymore. Example, an NTN RAN node group first utilizes a certain per beam transmit power level common to all. However, a secondary RAN node decided at a time instant to reduce it due to available power crunch and so it transmitted a light SIB configuration including only those differences from the formerly indicated common SIBs. Herein, devices will combine and update existing common SIB with changed parameters.

### Pt016

Non-Terrestrial Networks (NTNs) leverage satellites—whether in Geostationary Orbit (GEO), Medium Earth Orbit (MEO), or Low Earth Orbit (LEO)—to extend wireless coverage beyond the reach of traditional terrestrial Radio Access Networks (RANs). By embedding RAN functionality aboard satellites or relay platforms, NTNs can provide connectivity over vast areas, enable service in remote regions, and support global Internet-of-Things (IoT) deployments. As the industry moves toward widespread NTN adoption, robust timing and synchronization between the satellite and ground-based Wireless Transmit/Receive Units (WTRUs) become critical to maintaining link quality and meeting stringent latency and reliability targets.

A key element in achieving and sustaining synchronization in NTNs is the periodic broadcast of satellite ephemeris data-typically carried in System Information Blocks (SIBs) such as SIB19—to all WTRUs in a cell. Ephemeris data describes the satellite's precise position and velocity vectors, which WTRUs use to align their internal clocks, predict Doppler shifts, and calculate propagation delays. Without up-to-date ephemeris information, a WTRU's timing reference may drift, leading to degraded decoding performance, increased retransmissions, and, in severe cases, complete loss of connectivity. However, many NTN WTRUs operate in half-duplex mode, meaning they cannot transmit and receive simultaneously. When a scheduled SIB broadcast occasion coincides with a pending uplink transmission-such as user data, channel sounding, or control signaling—the WTRU should choose between momentarily losing the opportunity to update its ephemeris data or deferring its uplink transmission. Skipping the SIB detection risks gradual timing drift; deferring the uplink transmission can violate quality-of-service requirements. This inherent conflict between maintaining synchronization and preserving uplink performance poses a significant design challenge in half-duplex NTN deployments.

US 2023/0350078 to Carmela Cozzo is reproduced by reference herein in its entirety. Cozzo presents a single-timer approach, wherein a UE with GNSS capability is prevented from transmitting once its ephemeris or timing-advance information becomes outdated and must re-acquire broadcast parameters or revert to idle mode.

In one exemplary embodiment, the NTN RAN node computes a set of validity durations for satellite ephemeris data by analyzing the rate of orbital parameter change and maps each duration to a distinct timing-error threshold before encoding this information—along with a global timestamp—into SIB19. Upon detecting this SIB, the WTRU records the ephemeris parameters, the lookup table of validity durations and thresholds, and the reception timestamp, then monitors upcoming uplink opportunities. When an uplink transmission overlaps a scheduled SIB occasion, a WTRU may compare its service-driven maximum tolerable timing asynchronization against the stored thresholds to select the closest matching validity duration. If the elapsed time since the last SIB detection is less than that duration, the WTRU defers SIB monitoring and proceeds with uplink data transmission; otherwise, it pauses the uplink, listens for the SIB, refreshes its ephemeris data, and then resumes normal uplink operations.

In another exemplary embodiment, the NTN RAN node refines its error thresholds by applying a polynomial regression model to extrapolate satellite positions from one SIB occasion to the next and calculates residual timing errors for multiple extrapolation orders, packaging these error thresholds and corresponding validity durations into a compressed lookup table within each SIB. At the WTRU, following SIB reception, the device stores the regression-based error thresholds alongside its own service-level timing requirements. When a conflict arises between an uplink grant and a SIB occasion, the WTRU determines which regression-order threshold aligns with its currently active hardware-capability classification (e.g., a high-capability receiver), computes the elapsed interval since SIB acquisition, and decides to skip SIB reception when the predicted residual error remains within tolerance, or to capture the next SIB broadcast if it exceeds the preselected threshold.

In a further exemplary embodiment, the NTN RAN node continues to broadcast the same validity-duration/error-threshold table in SIB broadcasts but also supports on-demand SIB delivery triggered by WTRU-embedded MAC Control Element (CE) requests. The WTRU, upon skipping SIB reception and detecting decoding failures or observing that its elapsed time has surpassed the selected validity duration, composes a high-priority MAC CE requesting a targeted SIB retransmission and multiplexes it with ongoing uplink data. The NTN RAN node, upon receiving the MAC CE, schedules a dedicated SIB occasion for that WTRU or directly transmits updated ephemeris via downlink control information, after which the WTRU re-synchronizes its internal clock and clears any pending SIB request state.

In yet another exemplary embodiment, The WTRU implements a maximum-skip mechanism by initializing a skip counter each time it forgoes a SIB detection; if the counter reaches a predefined threshold or if the accumulated elapsed time since the last SIB exceeds a hard maximum, the WTRU preemptively schedules SIB reception at the next possible occasion—optionally adding a guard-band window to account for peak satellite velocity—to guarantee that its timing drift remains below acceptable limits even under aggressive uplink prioritization.

Non-Terrestrial Networks rely critically on the accurate and timely dissemination of satellite ephemeris data to maintain precise time and frequency synchronization between orbiting RAN nodes and ground-based WTRUs. This ephemeris information typically includes the satellite's three-dimensional position and velocity vectors, clock bias parameters, orbital element sets, Doppler correction coefficients, and a precise UTC timestamp indicating the generation time of the data. By ingesting these parameters, a WTRU can predict signal propagation delays, compensate for Doppler shifts induced by high orbital velocity, and align its uplink and downlink frames within the stringent timing budgets required for reliable decoding. Without regularly refreshed ephemeris, timing drift accumulates, leading to increased bit-error rates and potential loss of link budget.

In Release 17 of 3GPP's 38.331 specification (version 17.12.0 uploaded Mar. 22, 2025 is incorporated by reference herein in its entirety), System Information Block 19 (SIB19) carries a structured EphemerisInfo Information Element that includes the satellite's Keplerian orbital elements (e.g., semi-major axis, eccentricity, inclination, argument of perigee, and mean anomaly), three-dimensional position and velocity vectors, clock bias parameters, Doppler correction coefficients, and a precise UTC timestamp marking the generation instant of the data. This payload also accommodates uplink-synchronization metadata such as common Timing Advance, k-offset values, and validity durations for each ephemeris update, defining the time window over which a WTRU's prediction of satellite state remains within acceptable timing-error bounds. See the following references including: WO2022091030 to Helka-Liina Määttanen et al, U.S. 2024/0022984 to Magnus Åström et al. and U.S. 2023/0102334 to Abhishek ROY, the contents of each of which are incorporated by reference herein in their entirety.

In many NTN deployments, WTRUs operate in half-duplex mode, meaning they cannot concurrently receive system information blocks and transmit uplink data. When a scheduled ephemeris broadcast—such as SIB19—coincides with an active uplink transmission opportunity, the device faces a choice: skip reception of the latest ephemeris update at the cost of accumulating timing error, or postpone the uplink transmission and risk service disruption or missed grants. Skipping the SIB prolongs ephemeris validity but may allow timing misalignment to exceed the receiver's tolerance if orbital dynamics have shifted significantly. Conversely, deferring the uplink preserves synchronization accuracy yet can violate latency or throughput requirements, especially for delay-sensitive services.

The content of each ephemeris broadcast may be augmented with metadata indicating the expected validity duration of the data for different timing-error thresholds. By mapping specific error bounds—such as 1 μs, 5 μs, or 10 μs of timing inaccuracy—to corresponding time intervals since the last ephemeris update, the NTN RAN node enables WTRUs to autonomously decide when it is safe to defer reception without exceeding their error budget. This lookup table can be transmitted as a compressed sequence of validity durations paired with their error thresholds, embedding the ephemeris generation timestamp in Coordinated Universal Time to ensure both the RAN node and WTRU share a common time reference for elapsed-time calculations.

Different WTRUs exhibit varying tolerance to timing misalignment based on their hardware receiver capabilities and the service types they support. High-capability receivers with advanced signal processing and higher capture windows may tolerate larger timing offsets—permitting them to skip ephemeris receptions for longer periods—while low-capability or power-constrained devices require more frequent updates to maintain link quality. Similarly, a URLLC-class service, which demands sub-millisecond latency and ultra-high reliability, imposes tighter timing thresholds than an mMTC sensor application that can accept higher synchronization error in exchange for lower power consumption. By selecting the appropriate validity duration that aligns with their individual timing tolerance, WTRUs can optimize the trade-off between uplink performance and synchronization accuracy in half-duplex NTN scenarios.

Specifically, the NTN RAN node begins by acquiring the latest orbital parameters of each satellite, including its Keplerian elements and clock bias coefficients, and applies a dynamic orbital propagation model to estimate the rate of change in its ephemeris data over time. By simulating the propagation of the satellite's position and velocity vectors for successive SIB broadcast intervals, the RAN node computes multiple validity durations that correspond to the time intervals over which the predicted ephemeris remains within predefined timing-error bounds. For each validity duration, the RAN node determines a distinct error threshold expressed in microseconds of potential synchronization drift, thereby enabling WTRUs to assess whether their stored ephemeris data continues to satisfy their individual timing tolerances without requiring a fresh SIB reception.

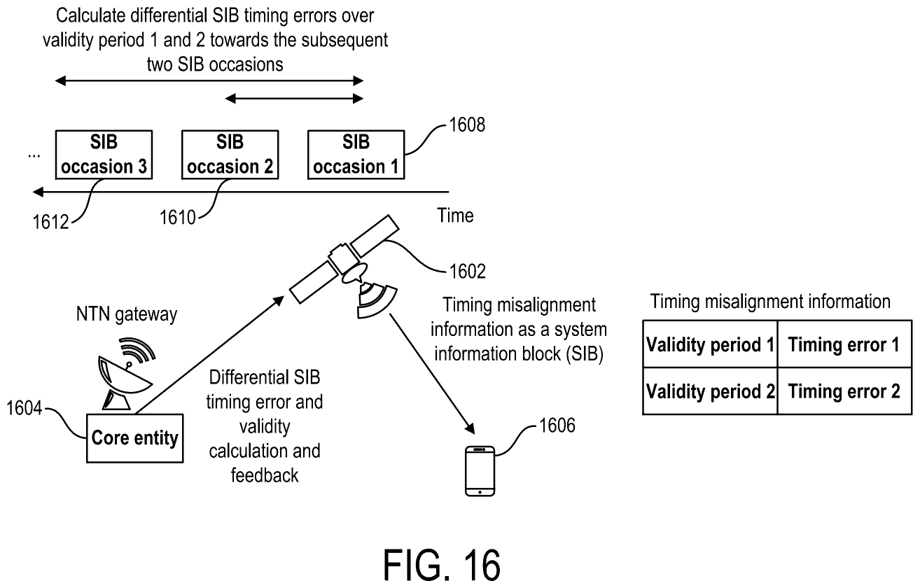

For instance, as shown by FIG. 16, and in one embodiment, the NTN RAN node 1602 retrieves ephemeris data at a first SIB occasion 1606 and again at the next scheduled SIB occasion 1608, each providing the satellite's position and velocity vectors along with clock bias parameters. By computing the difference between the two position vectors over the known time interval, the node quantifies how far the predicted orbit has diverged from reality. This spatial deviation is then translated into a timing inaccuracy-accounting for the signal's propagation speed-yielding an error threshold that represents the maximum synchronization drift a WTRU 1606 would experience if it relied on the older ephemeris for the entire interval. The RAN node may continue for a third SIB occasion 1610 etc. The RAN node 1602 may provide timing misalignment information to a WTRU 1606 via a SIB. A core entity 1604 may provide differential SIB timing error validity calculation and feedback.

In an embodiment, the RAN node refines its error threshold calculation by first determining a standard Euclidean distance between the predicted position (from the earlier SIB) and the corrected position (from the later SIB), then converting that distance to a time error by dividing by the speed of light and incorporating Doppler-related adjustments based on the satellite's orbital velocity. This approach captures both geometric delay and frequency-shift effects, producing a composite timing-error bound that serves as the error threshold for the validity duration associated with that SIB interval.

In a further embodiment, the RAN node enhances its threshold computation by analyzing the rate of change in ephemeris parameters—such as semi-major axis, inclination, and argument of perigee—over the two consecutive SIB occasions. By projecting these parameter deltas through a simple linear model, the node estimates the worst-case timing error accumulation and selects the highest resulting value as the error threshold. Embedding this threshold in the SIB allows WTRUs to directly gauge whether their last ephemeris update remains sufficiently accurate for uplink synchronization.

In another implementation, the NTN RAN node gathers successive sets of satellite ephemeris parameters at two consecutive SIB occasions and fits a polynomial regression model—such as a second- or third-order polynomial—to the first set of orbital elements. The node then uses this regression model to predict the satellite's state at the time of the second SIB occasion, generating extrapolated position and velocity vectors. By comparing these predicted vectors against the actual measurements received in the second SIB, the RAN node computes the residual error for each orbital parameter. The largest residual, when translated into signal propagation delay, defines the error threshold associated with the extrapolation interval, ensuring that WTRUs can bound their timing drift when relying on the regression-based prediction instead of a fresh ephemeris update.

In another embodiment, the NTN RAN node evaluates multiple polynomial regression orders in parallel—ranging from linear to higher-degree fits—and calculates corresponding residual errors for each model by contrasting the extrapolated ephemeris with the ground-truth parameters observed at the subsequent broadcast. The node then assigns each residual error to its matching validity duration, where simpler models yield shorter durations tied to tighter error thresholds and more complex models permit longer reuse at slightly higher error bounds. By encoding this hierarchy of regression-order thresholds and durations into a compressed lookup table within the SIB payload, the RAN node empowers WTRUs to select the optimal balance of computational complexity and synchronization accuracy based on their processing capabilities.

In a further embodiment, the NTN RAN node continuously refines its polynomial regression coefficients and associated error thresholds by incorporating real-time telemetry on orbital perturbations-such as solar pressure and atmospheric drag-into its fitting process. When environmental factors accelerate orbital drift, the node recalculates the regression residuals over the last two SIB intervals and tightens the error thresholds accordingly, shortening the validity durations for all regression orders. Conversely, under stable orbital conditions, the node relaxes these thresholds to extend ephemeris reuse and reduce signaling overhead. Embedding both the dynamic regression-based thresholds and their generation timestamps into each SIB allows WTRUs to accurately compute elapsed time since the model fit and confidently skip SIB detection when their predicted timing error remains below the selected regression-derived threshold.

The NTN RAN node assembles a System Information Block that embeds the complete satellite ephemeris dataset-including position and velocity vectors, clock bias coefficients, and Doppler correction parameters-alongside the previously calculated plurality of validity durations and their associated timing-error thresholds. The node serializes these elements into the SIB payload in a manner compliant with 3GPP signaling formats, ensuring that each duration-threshold pair is clearly delineated. By collating all requisite synchronization metadata within a single broadcast message, the RAN node provides WTRUs with both the orbital state and the decision criteria needed to autonomously manage their half-duplex receive/transmit scheduling.

Once the SIB has been generated, the NTN RAN node transmits it over the downlink control channel at pre-configured SIB occasions, which recur at periodic intervals tailored to the satellite's orbital period and the expected rate of ephemeris degradation. Each scheduled SIB occasion is announced in higher-layer signaling, allowing WTRUs to power up their half-duplex receivers at the precise time offsets required to capture the broadcast. By synchronizing SIB broadcasts to these recurring occasions, the network ensures that all active WTRUs, regardless of their transmission state, have a predictable opportunity to refresh their ephemeris database before any subsequent uplink grant conflicts arise.

In a further embodiment, the NTN RAN node optimizes SIB payload size and parsing efficiency by encoding the plurality of validity durations and corresponding error thresholds as a compressed lookup table. Each table entry maps a discreet time interval to its maximal allowable synchronization error and incorporates a Coordinated Universal Time (UTC) timestamp that marks the ephemeris generation instant. This timestamp enables WTRUs to calculate elapsed time since data acquisition unambiguously, aligning the validity-duration semantics with real-world clock references. The compressed table format minimizes control-plane overhead while providing WTRUs with a self-contained decision matrix for determining whether to defer ephemeris reception or prioritize uplink transmissions without risking unacceptable timing drift.

In an embodiment, the NTN RAN node organizes scheduled SIB occasions into logical “SIB groups,” each comprising a fixed number of consecutive broadcast opportunities. By treating these grouped occasions as a collective unit, the node can analyze ephemeris progression over the entire group rather than on an individual-occasion basis. Specifically, the RAN node derives a set of validity durations and corresponding error thresholds by comparing the satellite's predicted state at the first occasion of the group to its measured state at the last occasion, thereby capturing the maximum timing drift that would accrue if a WTRU were to skip all intermediate SIB receptions within the group. This group-level calculation produces error thresholds that reflect worst-case ephemeris deviation across multiple intervals, enabling a more conservative yet efficient determination of how long a device can safely defer synchronization.

The NTN RAN node dynamically adjusts the size and timing of SIB groups in response to orbital dynamics and traffic patterns, merging or splitting groups to balance signaling overhead and synchronization accuracy. When satellite trajectory perturbations increase, the node may shrink SIB groups—reducing the number of occasions per group—to tighten the group-based validity durations and lower the associated error thresholds. Conversely, during periods of orbital stability, the node can enlarge SIB groups to extend validity periods, allowing WTRUs to skip more broadcasts without exceeding their timing error budgets. The group definitions, along with the group-level validity durations, error thresholds, and the generation timestamp, are encoded into each SIB payload so that WTRUs receive a unified decision matrix covering both individual occasions and their broader group context.

From the WTRU perspective, group-based SIB signaling simplifies skip/defer decisions when uplink transmissions collide with multiple back-to-back SIB occasions. Upon initial reception of any SIB within a group, the device records the group identifier, the full set of group-level validity durations, and the highest error threshold corresponding to its chosen timing tolerance. When an uplink grant overlaps one or more subsequent occasions in the same group, the WTRU computes the elapsed time from its first group reception and compares it to the selected group validity duration. If the elapsed time remains below that threshold, the WTRU defers all remaining receptions in the group and proceeds with uplink transmission, knowing that the group-based error bound will not be violated. Otherwise, the device interrupts its uplink, re-enters receive mode to capture the next SIB in the group (or begins the next group), and refreshes its ephemeris data before resuming transmission.

In a further embodiment, the NTN RAN node may define overlapping SIB groups—where each group shares one or more occasions with its predecessor—to provide sliding-window validity estimates. By calculating error thresholds across these overlapping windows, the node offers WTRUs a continuously updated view of ephemeris accuracy that accounts for both short-term and longer-term drift. WTRUs can then choose to skip broadcasts within the current sliding window as long as the elapsed time since the earliest reception in that window does not exceed the corresponding validity duration, thereby granting devices with higher timing tolerance the flexibility to remain in uplink mode for extended periods while still guaranteeing synchronization integrity upon exiting the window.

In another alternative embodiment, the core network entity may periodically predict and estimate the satellite ephemeris degradation based on orbital dynamics models or regression-based extrapolation techniques, generating differential timing error estimates between consecutive SIB groups. Upon computation, the core network entity signals a backhaul message to the NTN RAN node that contains updated validity periods, differential error thresholds, SIB grouping structures, and an associated Coordinated Universal Time (UTC) timestamp. The NTN RAN node subsequently incorporates these parameters into the SIB messages broadcasted to the Wireless Transmit/Receive Units (WTRUs).

In yet another embodiment, the core network entity, such as a data center function supporting NTN operations, dynamically adapts the validity durations based on predicted changes in satellite trajectories, beam drift characteristics, or predicted Doppler profiles. The core entity may calculate customized sets of timing thresholds for different geographic service regions or different classes of WTRU devices, and signal corresponding validity profiles to regional NTN RAN nodes over standardized backhaul protocols such as NG-C or custom NTN-specific interfaces.

In a further embodiment, the NTN gateway monitors ephemeris accuracy metrics and forecasts when timing synchronization risks exceed configured thresholds. Upon detecting critical timing degradation, the gateway proactively sends backhaul signaling to the associated NTN RAN nodes, triggering an expedited SIB update or a targeted unicast SIB transmission towards WTRUs identified as vulnerable based on their operational state or mobility profile. The NTN RAN node, upon receiving the notification, schedules the updated SIB delivery to ensure continuous synchronization at the WTRU side.

In an additional embodiment, the core network entity not only computes and distributes differential timing errors but also maintains a historical database of timing drift rates across various satellite constellations or service beams. This database is periodically queried by NTN RAN nodes, which retrieve the most recent validity mapping profiles optimized for their coverage area. Such database interaction may be implemented over secure backhaul sessions with periodic refresh timers to ensure low-latency access to updated ephemeris accuracy profiles.

On the WTRU side, it awakens its half-duplex receiver in anticipation of a scheduled SIB occasion based on higher-layer signaling that defines the periodicity and time offset of SIB broadcasts. As the downlink control channel becomes available, the WTRU switches from transmit to receive mode and demodulates the physical SIB channel using its latest synchronization reference. Upon detecting the SIB, the device verifies the message integrity through the embedded CRC and confirms that it has obtained the correct System Information Block instance (for example, SIB19) before proceeding to parse its contents.

After successfully demodulating the SIB, the WTRU decodes the payload to extract the full satellite ephemeris dataset—including position, velocity and clock bias parameters—alongside the accompanying series of validity durations and associated error thresholds. Each validity duration and timing-error bound pair is read from the compressed lookup table format within the SIB payload, and the WTRU also captures the Coordinated Universal Time timestamp that marks the generation instant of the ephemeris data. By parsing these metadata fields in one atomic operation, the WTRU ensures that it holds all necessary information to evaluate future uplink conflicts without requiring additional signaling exchanges.

Upon completion of the decoding process, the WTRU stores the newly acquired ephemeris parameters, validity durations, error thresholds, and the reception timestamp in local memory. The device synchronizes its internal clock to the timestamp provided in the SIB—leveraging the NTN timing reference—to establish a common time base for elapsed-time measurements. With this data securely stored, the WTRU is then equipped to autonomously determine, during subsequent uplink grants, whether its ephemeris information remains valid or should be refreshed in order to maintain the stringent synchronization required for reliable NTN communications

Specifically, in a first step, upon receiving and decoding the SIB payload, the WTRU locates and extracts the embedded Coordinated Universal Time (UTC) timestamp that marks the exact generation instant of the satellite ephemeris data. This timestamp is obtained from a designated field within the SIB structure, and the WTRU immediately compares it against its own internal clock—previously synchronized to the NTN RAN node via timing advance commands or downlink control information—to compute the precise elapsed time since the ephemeris was produced. By deriving this delta, the device can gauge exactly how “fresh” its ephemeris data remains and determine whether the timing error has approached its selected tolerance threshold.

In another embodiment, the WTRU maintains a continuous synchronization loop with the NTN RAN node's timing reference, periodically adjusting its internal clock using the UTC timestamps from successive SIB receptions. After storing the latest timestamp, the WTRU measures the real-time interval until the next uplink opportunity by subtracting the stored UTC from its monotonic clock reading. This approach compensates for any drift in the WTRU's oscillator and ensures that all elapsed-time calculations accurately reflect the true age of the ephemeris data, thereby letting the device decide whether to skip or prioritize the next SIB occasion based on a reliable time base.

In a further embodiment, the WTRU implements a validation step in which it cross-references the extracted generation timestamp against the timestamp recorded during its most recent SIB detection. If the newly extracted timestamp is not strictly greater, indicating a potential reception error or replay, the WTRU discards the SIB and triggers a fallback reception attempt. Otherwise, the device updates its stored timestamp and proceeds to use the difference between the new and previous timestamps as a sanity check on its internal clock drift. By continuously monitoring and validating successive SIB timestamps, the WTRU maintains high confidence in both its timing alignment and its error-threshold skip logic.

In yet another embodiment, the WTRU leverages the timestamp comparison not only for ephemeris validity assessment but also to refine its internal power-saving schedule. By knowing the exact time remaining until its stored ephemeris approaches the selected validity duration, the device can delay power-intensive receiver wake-ups until just before that threshold. This fine-grained control of receiver duty-cycling—driven by elapsed-time calculations anchored in SIB timestamps—allows half-duplex WTRUs to maximize uplink throughput and battery life without compromising the synchronization accuracy required for robust NTN communications.

Thus, upon decoding the SIB payload, the WTRU stores the satellite ephemeris dataset—comprising three-dimensional position and velocity vectors, clock bias parameters, and Doppler correction coefficients—together with the array of validity durations and their associated timing-error thresholds. Alongside this synchronization metadata, the device records a precise timestamp marking the instant of SIB detection, as extracted from the embedded Coordinated Universal Time field. By persisting these elements in local memory, the WTRU maintains a complete ephemeris reference and decision framework that it can consult when future uplink opportunities conflict with scheduled SIB occasions.

Prior to executing any uplink transmission, the WTRU determines its maximum tolerable timing asynchronization by evaluating the current service requirements it supports. The device identifies whether it is operating in ultra-reliable low-latency communication (URLLC) mode—where sub-millisecond latency and near-zero decoding errors are paramount—massive machine-type communication (mMTC) mode—where infrequent, low-rate data reporting is acceptable—or enhanced mobile broadband (eMBB) mode—where high throughput and moderate latency are the focus. Each service type corresponds to a predefined timing-error budget, enabling the WTRU to quantify the largest permissible synchronization drift for its upcoming uplink transmission.

Thus, in a further embodiment, the WTRU selects the appropriate error threshold by comparing its determined maximum timing misalignment against the stored list of error thresholds derived from the SIB's lookup table. By identifying the threshold whose bound most closely matches or slightly exceeds its service-driven tolerance, the device gains a validity duration that specifies how long it may defer a fresh ephemeris reception without violating its synchronization constraints. This mapping ensures that the WTRU's half-duplex scheduling logic can safely skip SIB detection when the expected drift remains within the allowable envelope, thereby maximizing uplink performance.

In yet another embodiment, the WTRU retrieves its maximum tolerable timing asynchronization from a predefined lookup table held in non-volatile memory, which maps service types, hardware receiver configurations, and operational modes—such as power-saving or high-mobility states—to corresponding synchronization thresholds. Upon each uplink grant, the device dynamically selects the table entry that reflects its current operational state, whether running on a high-capability receiver with expansive capture windows or a low-capability, energy-constrained module. By tailoring the chosen error threshold to both the active service type and the WTRU's hardware and mode, the device achieves an optimal balance of synchronization accuracy and uplink efficiency in half-duplex NTN scenarios.

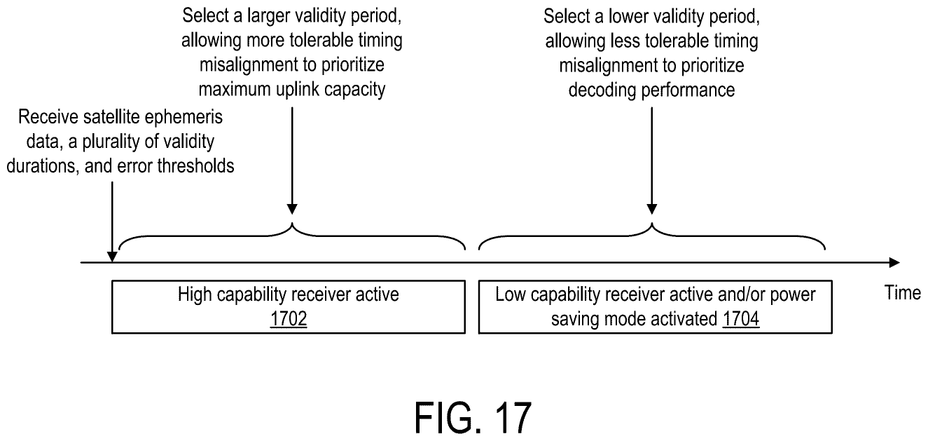

Moreover, as depicted by FIG. 17, the WTRU's internal lookup table differentiates between high-capability 1702 and low-capability receiver 1704 configurations by associating each with a distinct timing-asynchronization threshold. A high-capability receiver, equipped with advanced signal processing and wider capture windows, is mapped to a more relaxed threshold that permits greater timing misalignment without compromising data decoding, thereby allowing longer intervals between ephemeris updates. Conversely, a low-capability receiver—constrained by simpler hardware or reduced processing resources—uses a tighter threshold to ensure that any drift remains within its limited decoding tolerance. By dynamically selecting the threshold that corresponds to its current receiver class, the WTRU can balance uplink throughput against the necessity of timely ephemeris refreshes to maintain link reliability.

In another embodiment, the WTRU enhances its operational-state table to include additional modes such as power-saving and high-mobility, each mapped to specific timing-asynchronization limits. In power-saving mode, where battery life is prioritized over peak performance, the device adopts a lower threshold to trigger more frequent ephemeris receptions and avoid the cost of retransmissions due to misalignment. In high-mobility mode, which faces rapidly changing Doppler profiles and propagation delays, the WTRU similarly selects a tighter threshold to prevent decoding errors under dynamic conditions. By evaluating its service requirements, battery status, and motion state, the WTRU dynamically transitions between these operational modes, updating its chosen timing threshold to ensure that ephemeris updates and uplink transmissions remain aligned with both its performance objectives and hardware constraints.

The WTRU incorporates a fallback mechanism that monitors decoding success after deferring SIB receptions. Should the number of consecutive decoding failures-caused by unanticipated timing drift-exceed a preset limit, the device automatically switches to the next lower timing-asynchronization threshold in its lookup table. This action immediately triggers a preemptive SIB detection, forcing the WTRU to interrupt any ongoing uplink activity to refresh its ephemeris data before further transmission. By falling back to a stricter threshold only when errors actually occur, the WTRU maximizes uplink efficiency while safeguarding against synchronization loss, ensuring that timing drift remains within bounds tolerable by its receiver capabilities.

Accordingly, the WTRU selects an appropriate error threshold by evaluating the stored range of each threshold against its determined maximum tolerable timing asynchronization. For each entry in the validity-duration lookup table, the WTRU inspects the associated lower and upper bounds of timing error and identifies those ranges that encompass, either fully or partially, its service-driven synchronization budget. By choosing the error threshold whose interval overlaps the maximum permissible drift, the device ensures that any skipped ephemeris receptions will not violate the latency or reliability requirements of its active service.

The WTRU further computes the elapsed time since its last SIB detection by first aligning its internal clock to the NTN RAN node's timing reference, which it periodically receives via downlink control signals or timing-advance commands. When an uplink grant coincides with a scheduled SIB occasion, the device calculates the interval between that occasion's timestamp and the stored timestamp of the last successful SIB reception. This precise delta measurement, anchored in a common time base, serves as the basis for comparing against the previously selected validity duration and deciding whether to defer or capture the upcoming broadcast.

In a further embodiment, the WTRU's skip logic is gated by its service priorities: the device may only forgo SIB detection if the measured elapsed time remains strictly less than the chosen validity duration associated with its selected error threshold. Under these conditions, the WTRU seamlessly transitions into uplink transmission mode, confident that its ephemeris data remains sufficiently accurate. If the elapsed time equals or exceeds the validity duration, or if high-priority service constraints dictate, the device interrupts the uplink, re-enters receive mode to update its ephemeris, and then resumes its transmission, thus balancing synchronization integrity against uplink performance.

In an additional embodiment, when the WTRU detects that its elapsed time since the last SIB reception has reached the selected validity duration and decoding failures indicate loss of ephemeris synchronization, the device constructs a Medium Access Control-Control Element (MAC-CE) that encapsulates a SIB delivery request. This MAC CE is then multiplexed alongside the payload of the ongoing uplink transmission, allowing the request to be carried within the existing uplink grant without requiring additional signaling overhead. Upon receipt at the NTN RAN node, the SIB delivery request signals the need for a targeted retransmission of the most recent ephemeris-bearing SIB, thereby enabling the WTRU to restore synchronization without waiting for the next scheduled broadcast.

The WTRU marks the MAC CE containing the SIB delivery request with a high-priority logical channel identifier (LCID), ensuring that the NTN RAN node's scheduler processes the request ahead of other uplink data. By leveraging the QoS framework's prioritization mechanisms, the device minimizes service interruption caused by synchronization loss, triggering an expedited network response to provide the necessary ephemeris update. This high-priority treatment guarantees that the RAN node allocates resources to the SIB retransmission with minimal delay, thereby reducing the risk of prolonged timing drift.

In a further embodiment, after transmitting the SIB delivery request, the WTRU monitors the downlink for an acknowledgment from the NTN RAN node. Upon receipt of this acknowledgment—either via a dedicated uplink feedback channel or embedded within downlink control information (DCI)—the WTRU interprets the network's response which may include the scheduling of a dedicated SIB occasion specifically for that device or the direct delivery of updated ephemeris parameters through the DCI payload. Once the updated ephemeris is obtained, the WTRU re-synchronizes its internal timing reference and clears any pending SIB request state, thus resuming normal uplink transmissions with restored synchronization integrity.

When a WTRU generates and transmits a MAC Control Element containing a SIB delivery request but does not receive a corresponding acknowledgment from the NTN RAN node within an expected response window, the device automatically includes the same SIB request in subsequent uplink transmissions. Each retransmission is delayed by an incrementally increasing backoff interval, calculated according to a contention-aware algorithm that factors in both the number of previous requests and the current network load indicators. By spacing out the retransmissions, the WTRU avoids exacerbating uplink congestion while persistently signaling its need for updated ephemeris data, thereby balancing the urgency of re-synchronization against the shared medium's capacity.

The WTRU enforces a maximum skip duration by initializing a dedicated timer immediately after it elects to skip a scheduled SIB detection. The timer value is set equal to a predefined interval corresponding to the device's chosen validity duration error threshold. Regardless of whether the elapsed time since the last SIB detection remains below the originally selected validity duration, the expiration of this timer compels the WTRU to interrupt any ongoing uplink transmission at the next scheduled SIB occasion and switch into receive mode. This mechanism ensures that cumulative timing drift cannot exceed the hard limit defined by the timer, safeguarding synchronization integrity even under extended uplink prioritization.

In a further embodiment, the WTRU maintains an internal counter that increments each time the device elects to skip a SIB detection in favor of uplink activity. The counter is compared against a skip-threshold value derived from the predefined maximum skip duration interval and the periodicity of scheduled SIB occasions. Once the count of consecutive skipped occasions reaches this threshold, the WTRU overrides its usual validity-duration logic and mandates an immediate SIB detection at the next available opportunity. By tracking skipped occasions in this way, the device guarantees periodic re-synchronization even if individual validity durations would otherwise permit further deferrals.

Finally, the WTRU may implement a preemptive synchronization strategy by scheduling SIB reception one occasion prior to the calculated expiration of its maximum skip duration. Upon reaching a guard-band offset—determined as a fraction of the remaining validity duration to account for peak orbital-velocity phases—the device transitions into receive mode just before the timer would normally expire. This preemptive detection reduces the risk of timing asynchronization that might occur if the actual SIB occasion is delayed or if processing jitter affects the receiver's wake-up timing. By incorporating this guard-band approach, the WTRU maintains tight synchronization margins without substantially increasing the frequency of SIB receptions.

In certain emergency or recovery scenarios, the WTRU may be permitted to transmit a random-access preamble even if its ephemeris validity period has elapsed, overriding the usual skip-defer logic. For example, if a beam failure or link interruption is detected, the device can issue a PRACH preamble to initiate a rapid connection re-establishment procedure; this transmission inherently tolerates larger timing misalignments because the network uses coarse-grain timing recovery during random access, and the urgency of restoring the link outweighs the risk of drift-induced decoding errors. By prioritizing preamble transmission in such failure-recovery contexts, the WTRU minimizes service interruption and avoids the extended delays that would result from waiting for the next SIB opportunity, even though its stored ephemeris data may have exceeded its designated validity duration.

Conversely, for standard uplink payloads—such as PUSCH user data or scheduled control signaling—the WTRU is prevented from overriding the validity check when its timing skew exceeds the selected threshold. Normal data transmissions rely on tight alignment of uplink frames and precise Doppler compensation to maintain low bit-error rates and efficient use of radio resources; any substantial timing misalignment would render the data effectively undecodable at the NTN RAN node. As a result, when ephemeris validity has expired, the WTRU defers all non-random-access uplink transmissions until a fresh SIB reception can restore synchronization, ensuring that network capacity is not wasted on transmissions doomed to fail due to excessive timing drift.

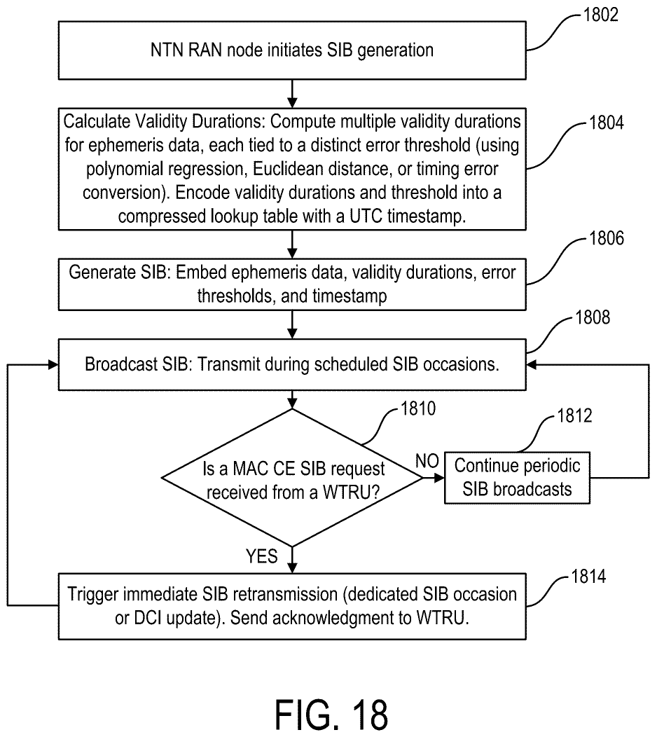

FIG. 18 illustrates a flow chart of the NTN RAN node's sequential operations, beginning 1802 with the acquisition of up-to-date orbital parameters from satellite telemetry. The process initiates with the RAN node retrieving the Keplerian elements, clock bias coefficients, and Doppler correction factors for each satellite, then feeding these inputs into an orbital propagation model. By simulating the satellite's trajectory across the upcoming SIB broadcast interval, the node determines the rate of ephemeris change and proceeds to calculate a series of validity durations. Each duration is paired with a corresponding error threshold, derived from the worst-case timing drift predicted over that interval, thereby establishing the core decision metrics for downstream WTRU use.

Once the validity durations and error thresholds have been computed 1804, the flow chart shows the node optionally refining its thresholds by extrapolating orbital parameters using a polynomial regression model. In this branch, the RAN node fits regression curves to historical ephemeris data and predicts the satellite state at the next SIB occasion. By comparing the predicted values to the actual measurements when they become available, the node computes residual errors for each regression order. These residuals inform additional duration-threshold pairs, enabling a hierarchy of prediction-based validity intervals that devices with varying processing capabilities may select.

The next stage in the flow chart covers SIB assembly 1806. Here, the RAN node serializes the complete ephemeris dataset—position and velocity vectors, clock bias, and Doppler coefficients—alongside the full lookup table of validity durations and their error thresholds into the SIB payload. To optimize control-plane efficiency, the node compresses this table and embeds a Coordinated Universal Time timestamp that marks the generation instant of the ephemeris data. This timestamp is critical for WTRUs to calculate elapsed-time metrics against their synchronized internal clocks and make autonomous skip-defer decisions during half-duplex operation.

Finally, the flow chart depicts the scheduled broadcast 1808 of the generated SIB to all WTRUs in the cell. The RAN node transmits the SIB at predetermined occasions, which may be grouped into logical blocks or dynamically adjusted based on real-time orbital perturbations. After each broadcast, the node enters a wait state until the next scheduled occasion, during which it continues to monitor satellite behavior and, if enabled, recalculates validity durations to adapt to changing orbital dynamics. This cyclical process ensures that WTRUs always receive the necessary metadata to balance synchronization accuracy against uplink performance in half-duplex NTN deployments.

If a MAC CE SIB request is received from a WTRU 1810, a SIB retransmission is made 1814. If not, periodic SIB broadcasts are made 1812.

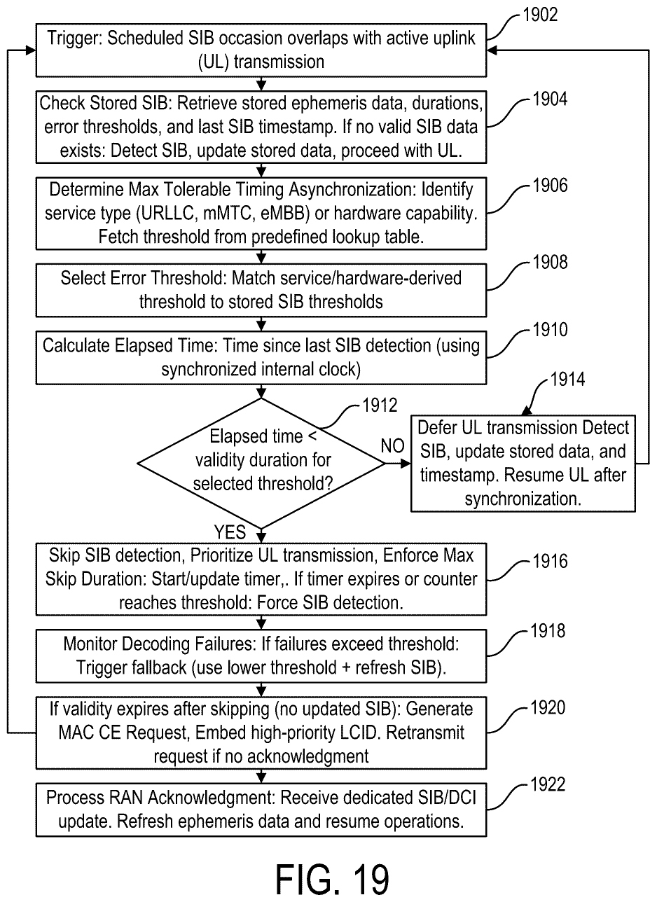

FIG. 19 depicts the WTRU's action flow chart, which begins when the device awakens for a scheduled SIB occasion 1902. The WTRU switches its half-duplex radio from transmit to receive mode and attempts to detect the incoming SIB broadcast 1904. Upon successful detection, the device verifies the CRC, decodes the payload to extract the satellite ephemeris data, the array of validity durations, their corresponding error thresholds, and the embedded UTC generation timestamp. It then synchronizes its internal clock to the received timestamp and stores all decoded parameters—including the timestamp and lookup table—in local memory for future reference.

Following SIB acquisition, the WTRU enters normal operation until the next uplink grant or pending transmission is received. At that point, the device identifies its current service profile 1906—such as URLLC, eMBB, or mMTC—and assesses its hardware receiver class (high-capability or low-capability) along with any active operational mode (power-saving or high-mobility). By consulting its predefined lookup table, the WTRU determines the maximum tolerable timing asynchronization and selects the stored error threshold 1908 whose range overlaps this value. The chosen threshold yields a specific validity duration that bounds how long the WTRU may defer a fresh ephemeris update without breaching its synchronization budget.

When an uplink transmission overlaps a scheduled SIB occasion, the WTRU computes the elapsed time 1910 since its last SIB detection by subtracting the stored UTC timestamp from its synchronized internal clock. It then compares 1912 this elapsed interval to the selected validity duration: if the elapsed time remains below the threshold, the device skips 1916 the SIB reception, switches to transmit mode, and proceeds with the uplink; if the elapsed time meets or exceeds the validity duration, the WTRU defers 1914 the transmission, re-enters receive mode to capture the SIB, refreshes its ephemeris data, and only then resumes the uplink, thereby ensuring that timing drift never surpasses acceptable limits.

Should skip-based decisions lead to decoding failures 1918 or the validity duration expires 1920 without a scheduled SIB refresh, the WTRU initiates its fallback and re-synchronization procedures. A dedicated timer and skip counter—both initialized upon each skipped occasion—track cumulative deferrals, forcing mandatory reception when preconfigured thresholds are reached. Concurrently, the device may generate a high-priority MAC Control Element containing a SIB delivery request, multiplexed with uplink data and marked with an elevated LCID. If no acknowledgment arrives within a backoff-controlled interval, the WTRU retransmits the request in subsequent uplink grants, spacing repeated requests according to a contention-aware backoff algorithm. In advanced embodiments, the WTRU even schedules a preemptive SIB detection one occasion before its maximum skip duration expires, employing a guard-band offset to mitigate risks during periods of rapid satellite movement. RAN Acknowledgement may be processed 1922.

A method may be performed by a Non-Terrestrial Network (NTN) Radio Access Network (RAN) node. The method may comprise calculating a plurality of validity durations for satellite ephemeris data, wherein each validity duration is associated with a distinct error threshold; generating a system information block (SIB) containing the satellite ephemeris data, the plurality of validity durations, and their corresponding error thresholds; and broadcasting the generated SIB to one or more Wireless Transmit/Receive Units (WTRUs) during scheduled SIB occasions.

The distinct error thresholds are calculated by comparing a satellite position derived from ephemeris data of the first System Information Block occasion with an updated satellite position derived from ephemeris data of a subsequent System Information Block occasion, wherein the comparison determines a difference in satellite ephemeris parameters, and the error threshold corresponds to a maximum timing inaccuracy accumulated over the time interval between the two consecutive System Information Block occasions.

The distinct error thresholds are computed by extrapolating satellite orbital parameters from a first SIB occasion to a subsequent SIB occasion using a polynomial regression model, and wherein the error threshold represents a residual error between the extrapolated parameters and actual parameters measured at the subsequent SIB occasion.

The distinct error thresholds are computed by calculating a position error as the Euclidean distance between the predicted and corrected position coordinates, and converting this position error to a timing error that accounts for signal propagation delay and Doppler-induced shifts based on the satellite's orbital velocity, defining multiple error thresholds corresponding to multiple validity durations.

Generating the System Information Block includes encoding the plurality of validity durations and corresponding error thresholds as a compressed lookup table, wherein each entry maps a validity duration to an error threshold embedding a timestamp in Coordinated Universal Time indicating the generation time of the satellite ephemeris data to align validity durations with predicted ephemeris data accuracy degradation.

A method performed by a Wireless Transmit/Receive Unit (WTRU) operating in a Non-Terrestrial Network (NTN), the method comprising: detecting a system information block (SIB) broadcast by an NTN Radio Access Network (RAN) node, wherein the SIB includes satellite ephemeris data, a plurality of validity durations, and error thresholds corresponding to each validity duration; storing the satellite ephemeris data, the plurality of validity durations, the error thresholds, and a timestamp indicating a time of SIB detection; determining a maximum tolerable timing asynchronization for uplink transmissions based on at least one of service requirements or hardware capabilities of the WTRU; selecting an error threshold from the stored error thresholds that matches the maximum tolerable timing asynchronization; calculating an elapsed time between a scheduled SIB occasion overlapping with an active uplink resource, and the timestamp of the stored SIB detection; skipping detection of the SIB information during the scheduled SIB occasion and prioritizing active uplink transmission on condition of the elapsed time less than the validity duration associated with the selected error threshold, and deferring the active uplink transmission and detecting the SIB during the scheduled SIB occasion on condition of the elapsed time equals or exceeds the validity duration associated with the selected error threshold.

The method may comprise extracting a timestamp from the SIB indicating a generation time of the satellite ephemeris data, and wherein the WTRU calculates the elapsed time since the last SIB detection by comparing the timestamp with an internal clock synchronized to the NTN RAN node.

Determining the maximum tolerable timing asynchronization comprises identifying a service type currently active on the WTRU, wherein the service type is one of ultra-reliable low-latency communication (URLLC), massive machine-type communication (mMTC), or enhanced mobile broadband (eMBB), and wherein the maximum tolerable timing asynchronization is predefined based on latency or reliability requirements associated with the identified service type.

The WTRU retrieves the maximum tolerable timing asynchronization from a predefined lookup table stored in memory, wherein the lookup table maps service types, hardware configurations, or operational modes to corresponding timing asynchronization thresholds, and wherein the WTRU dynamically selects an entry from the table based on its current operational state.

The operational state of the WTRU includes a high-capability receiver or a low-capability receiver, mapped to specific timing asynchronization thresholds, wherein the high-capability receiver corresponds to a greater ability to decode data with higher timing misalignment and the low-capability receiver corresponds to a limited ability to decode data under such conditions, and wherein the lookup table associates the high-capability receiver with a higher timing threshold and the low-capability receiver with a lower timing threshold to ensure reliable data decoding.

Enhancing the lookup table to include additional operational states, such as a power-saving mode or a high-mobility mode, wherein the power-saving mode or a high-mobility mode is associated with lower timing asynchronization thresholds, wherein the WTRU selects the appropriate operational state based on its current service requirements and device conditions.

The WTRU implements a fallback mechanism when the selected timing asynchronization threshold results in a number of subsequent decoding failures exceeding a preset threshold, wherein the fallback mechanism switches the WTRU to the next lower timing threshold associated, triggering early System Information Block detection to refresh ephemeris data.

The method of claim 6, wherein selecting the error threshold comprises identifying a stored error threshold that overlaps with the maximum tolerable timing asynchronization by comparing the determined maximum tolerable timing asynchronization to a range defined by upper and lower bounds of each stored error threshold, and wherein the WTRU selects the error threshold whose range fully or partially overlaps with the maximum tolerable timing asynchronization to ensure compliance with service requirements.

Calculating the SIB refresh elapsed time comprises synchronizing an internal clock of the WTRU with a timing reference signal broadcast by the NTN RAN node, and wherein the elapsed time is computed as a difference between a scheduled SIB occasion overlapping with an active uplink resource and the timestamp of the last stored SIB detection.

Skipping detection of the SIB further comprises prioritizing uplink transmissions for a service type, wherein the WTRU skips SIB detection only if the elapsed time is less than the validity duration.

Upon expiration of the validity duration and loss of SIB synchronization after skipping SIB detection, generating a Medium Access Control (MAC) Control Element (CE) containing a SIB delivery request, wherein the MAC CE is multiplexed with uplink data from the prioritized uplink transmission and transmitted to the NTN RAN node to trigger a targeted SIB retransmission.

The WTRU embeds the SIB delivery request within a MAC CE configured with a high-priority logical channel identifier (LCID), and wherein the NTN RAN node processes the request ahead of other uplink data to minimize service interruption caused by SIB synchronization loss.

Receiving an acknowledgment from the NTN RAN node in response to the SIB delivery request, wherein the acknowledgment schedules a dedicated SIB occasion for the WTRU or provides updated ephemeris data via downlink control information (DCI) to restore synchronization.

The WTRU retransmits the SIB delivery request within subsequent uplink transmissions if no response is received from the NTN RAN node, and wherein retransmissions are spaced at intervals determined by a backoff algorithm to avoid network congestion.

Enforcing the maximum skip duration comprises initializing a timer upon skipping a prior SIB detection, wherein the timer is set to the predefined interval, and wherein the WTRU detects the SIB during the scheduled SIB occasion upon expiration of the timer irrespective of whether the elapsed time is less than the validity duration associated with the selected error threshold, thereby preventing cumulative timing drift from exceeding the predefined interval.

The WTRU enforces the maximum skip duration by maintaining a counter that tracks consecutive skipped SIB occasions, and wherein the counter triggers a mandatory SIB detection when the number of skipped occasions reaches a threshold defined by the predefined interval, ensuring periodic synchronization despite validity duration conditions.

The WTRU enforces the maximum skip duration by preemptively detecting the SIB one occasion prior to expiration of the predefined interval, and wherein the preemptive detection incorporates a guard band to mitigate timing asynchronization risks during high satellite velocity phases.

An example embodiments embeds a compressed lookup table of multiple validity durations and corresponding error thresholds directly within one or more SIB broadcasts. By providing a spectrum of timing-error bounds paired with distinct time intervals calculated from orbital dynamics or regression-based residuals, the NTN RAN node equips half-duplex WTRUs to autonomously select the longest deferral they may tolerate-based on their service profile and hardware receiver class-rather than or in addition to relying on one or more expiration timers. This multi-threshold framework enables granular control over skip-or-receive decisions, maximizing uplink capacity for high-tolerance devices while ensuring strict synchronization for low-capability or URLLC services.

Furthermore, this application introduces active recovery and enforcement mechanisms absent in the art. When validity durations expire without SIB reception, the WTRU may generate a high-priority MAC Control Element to request targeted ephemeris updates, retransmitting this request with a contention-aware backoff if no acknowledgment arrives-thus avoiding unnecessary uplink collisions and network congestion. In addition, the WTRU enforces a configurable maximum skip duration via timers, counters, or preemptive guard-band receptions to guarantee periodic re-synchronization even under prolonged uplink prioritization. These features, together with dynamic grouping of SIB occasions and sliding-window validity estimates, provide a robust, service- and capability-aware synchronization architecture that extends well beyond the static timer-based scheme covered by US 2023/0350078 A1.

1. A method performed by a user equipment (UE), the method comprising:
detecting a first synchronization signal block (SSB);
transmitting identification information, based on detecting the first SSB;
receiving another SSB, subsequent to transmitting the identification information;
receiving a system information block (SIB) subsequent to the another SSB; and
decoding the SIB and determining satellite ephemeris information from the SIB.

2. The method of claim 1, wherein the UE is configured to receive the first SSB from a first non-terrestrial network node which has limited traffic.

3. The method of claim 2, wherein the UE is configured to receive the first SSB from a second non-terrestrial network node which has more heavy traffic than the first non-terrestrial network node.

4. The method of claim 1, wherein the transmitted identification information is transmitted in accordance with a propagation delay.

5. A method for aligning a UE discontinuous reception (DRX) profile with a satellite propagation delay, the method comprising:
evaluating one or more available DRX profiles based on the satellite propagation delay, wherein each one of the one or more DRX profiles is associated with one or more of a wake-up duration, sleep interval or cycle periodicity;
applying one of the available DRX profiles.

6. The method of claim 5, wherein the UE identifies an orbit type in determining the adjusted signal arrival time.

7. A plurality of non-terrestrial (NTN) nodes that form a group of nodes, the plurality of NTN nodes configured to:
negotiate over an inter-satellite link (ISL), a group leader device,
wherein the group leader device transmits system information signaling information on behalf of the group of nodes;
wherein the group leader device is determined by way of a power constraint.

8. The plurality of NTN nodes of claim 1, wherein the group leader device transmits group common System Information Block 1 (SIB1) and Radio Resource Control (RRC) configurations on behalf of the group.

9. The method of claim 7, further comprising:
performing, by a first RAN node and a second RAN node, connected by way of an inter-satellite link a method comprising:
transmitting, by the first RAN node to the second RAN node, device-group context information comprising one or more of device identifiers, security parameters, and session data, wherein the transmitting is performed ahead of a handover event.

10. The method of claim 9, wherein the transmitting is in response to reception of a reported cell list provided by connected devices of the first RAN node.
